(19) United States
(12) Patent Application Publication
(10) Pub. No.: US 2008/0270234 A1
(43) Pub. Date: Oct. 30, 2008

(54) Rewarding influencers

(75) Inventors: Gary W. Flake, Bellevue, WA (US); William H. Gates, Redmond, WA (US); Alexander G. Gounares, Kirkland, WA (US); W. Daniel Hillis, Encino, CA (US); Royce A. Levien, Lexington, MA (US); Mark A. Malamud, Seattle, WA (US); Craig J. Mundie, Seattle, WA (US); Christopher D. Payne, Seattle, WA (US); Richard F. Rashid, Redmond, WA (US); Clarence T. Tegreene, Bellevue, WA (US); Charles Whitmer, North Bend, WA (US); Lowell L. Wood, Bellevue, WA (US); Robert W. Lord, Seattle, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a Limited liability corporation of the State of Delaware.

(21) Appl. No.: 11/811,349

(22) Filed: Jun. 7, 2007

Related U.S. Application Data
(63) Continuation-in-part of application No. 11/799,460, filed on Apr. 30, 2007.

(51) Int. Cl. G06Q 30/00

(52) U.S. Cl. 705/14

(57) ABSTRACT

Embodiments include a system, a device an apparatus, a method, and a computer program product. An embodiment provides an influence evaluation method. The method includes receiving data indicative of a person accessing at least one of a first network-available electronic content having a first-electronic-content portion or a second network-available electronic content having a second-electronic-content portion. The method also includes receiving data indicative of an involvement between the person and a third party. The method further includes facilitating delivered of a benefit to an owner of the first-electronic content or an owner of the second electronic content in response to an assessed influence bad the first-electronic-content portion and/or the second-electronic-content portion on the involvement between the person and the third-party.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### RELATED APPLICATIONS

For purposes of the USPTO extra-statutory requirements the present application constitutes a continuation-in-part of U.S. patent application Ser. No. ______, entitled DETERMINING INFLUENCERS naming Gary W. Flake; Williams H. Gates, III; Alexander G. Gounares; W. Daniel Hillis; Royce A. Levien; Mark A. Malamud; Craig J. Mundie; Christopher D. Payne; Richard F. Rashid; Charles Whitmer; Lowell L. Wood, Jr. as inventors, filed Apr. 30, 2007, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited big statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

An embodiment provides an influence evaluation method. The method includes receiving data indicative of a person accessing at least one of a first network-available electronic content having a first-electronic-content portion or a second network-available electronic content having a second-electronic-content portion. The method also includes receiving data indicative of an involvement between the person and a third party. The method further includes facilitating delivery of a benefit to an owner of the first-electronic content or an owner of the second electronic content in response to an assessed influence by the first-electronic-content portion and/or the second-electronic-content portion on the involvement between the person and the third-party. The method may include receiving data indicative of an affinity of the person. The method may include receiving data indicative of at least one of an express, and/or an inferred affinity of the person. The method may include receiving data indicative of at least one of an affinity characteristic, and/or an affiliation of the person. In addition to the foregoing, other method embodiments are described in the claims, drawings, and text that form a part of the present application.

Another embodiment provides a computer program product. The computer program product includes a computer-readable signal-bearing medium bearing program instructions. The program instructions include program instructions operable to perform an influence evaluation process in a computing device. The process includes receiving data indicative of a person accessing at least one of a first network-available electronic content having a first-electronic-content portion or a second network-available electronic content having a second-electronic-content portion. The process also includes receiving data indicative of an involvement between the person and the third party. The process further includes assessing an influence by the first-electronic-content portion and/or the second-electronic-content portion on the involvement between the person and the third party. The process mail include outputting the assessed influence in a form usable by a process facilitating delivery of a benefit to an owner of the first electronic content or an owner of the second electronic content. The process may include maintaining informational data corresponding to the assessed influence. The process may include receiving data indicative of an affinity of the person. The process may include providing access to maintained informational data corresponding to the assessed influence. In addition to the foregoing, other computer program product embodiments are described in the claims, drawings, and text that form a part of the present application.

A further embodiment provides a system. The system includes a computing device operable to communicate with a network. The system also includes an activity monitoring module operable to receive data indicative of a person accessing at least one of a first network-available electronic content or a second network-available electronic content. The system further includes an interaction monitoring module operable to receive data indicative of an involvement between the person and the third-party. The system also includes an evaluation module operable to assess an influence by the first-electronic-content and/or the second-electronic-content on the involvement between the person and the third-party. The system may further include a retention module operable to maintain informational data corresponding to the assessed influence. The system may include providing access to informational data corresponding to the assessed influence. In addition to the foregoing, other system embodiments are described in the claims, drawings, and text that form a part of the present application.

An embodiment provides a device. The device includes means for receiving data indicative of a person accessing at least one of a first network-available electronic content having a first-electronic-content portion or a second network-available electronic content having a second-electronic-content portion. The device also includes means for receiving data indicative of an involvement between the person and the third party. The device further includes means for facilitating delivery of a benefit to an owner of the first-electronic content or an owner of the second electronic content in response to an assessed influence by the first-electronic-content portion and/or the second-electronic-content portion on the involvement between the person and the third party. The device may include means for receiving data indicative of an affinity of the person. The device may include means for saving informational data corresponding to the assessed influence. The device may include means for providing access to informational data corresponding to the assessed influence. In addition to the foregoing, other device embodiments are described in the claims, drawings, and text that form a part of the present application.

Another embodiment provides an apparatus. The apparatus includes one or more physical media configured to bear a device-detectable implementation of a method. The method including at least receiving data indicative of a person accessing at least one of a first network-available electronic content having a first-electronic-content portion or a second network-available electronic content having a second-electronic-content portion. The method also includes receiving data indicative of an involvement between the person and a third partly. The method further includes facilitating delivery of a benefit to an owner of the first-electronic content or an owner of the second electronic content in response to an assessed influence by the first-electronic-content portion and/or the second-electronic-content portion on the involvement between the person and the third party. The apparatus may include at least one of a satellite dish or other signal-reflective element, a transducer, an antenna, or a receiver operated for receiving the device-detectable implementation. In addition to the foregoing, other apparatus embodiments are described in the claims, drawings, and text that form a part of the present application.

A further embodiment provides an apparatus. The apparatus includes one or more physical media bearing a device-detectable output indicating an occurrence of receiving data indicative of a person accessing at least one of a first network-available electronic content having a first-electronic-content portion or a second network-available electronic content having a second-electronic-content portion. The physical media also bearing a device-detectable output indicating an occurrence of receiving data indicative of an involvement between the person and a third party. The physical media further bearing a device-detectable output indicative of facilitating delivery of a benefit to an owner of the first-electronic content or an owner of the second electronic content in response to an assessed influence by the first-electronic-content portion and/or the second-electronic-content portion on the involvement between the person and the third party. In addition to the foregoing, other apparatus embodiments are described in the claims, drawings, and text that form a part of the present application.

An embodiment provides an influencer discovery method. The method includes receiving at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content provider site, content site, a search engine site, and/or a beneficiary site. The search engine site data gathered through a process running on a platform of the search engine site, and indicative of communication between the search engine site and the computing device responsive to a human user input. The beneficiary site data gathered through a process running on a platform of the beneficiary site, and indicative of communication between the computing device responsive to a human user input and the beneficiary site. The method also includes determining a correlation between (a) the communication between the content site and the computing device responsive to a human user input; and (b) the communication between the computing device responsive to a human user input and the beneficiary site. The method may include assisting delivered of a compensation to the holder of the content provider site, content site in response to the determined degree of correlation. The method may include maintaining informational data corresponding to the determined correlation. The method may include providing access to informational data corresponding to the determined correlation. In addition to the foregoing, other method embodiments are described in the claims, drawings, and text that form a part of the present application.

Another embodiment provides a computing device operable to communicate over a network. The computing device including a communications monitoring module operable to receive at least one of content site data, computing device data, search engine site data, or beneficiary site data. The content site data gathered through a process running on a platform of a content site, and indicative of communication between the content site and a computing device responsive to a human user input. The computing device data gathered through a process ruining on a platform of the computing device, and indicative of communication between the computing device responsive to a human user input and at least one of the content provider site, content site, a search engine site, and/or a beneficiary site. The search engine site data gathered through a process running on a platform of the search engine site, and indicative of communication between the search engine site and the computing device responsive to a human user input. The beneficiary site data gathered through a process running on a platform of the beneficiary site, and indicative of communication between the computing device responsive to a human input and the beneficiary site. The computing device also includes an evaluation module operable to determine a correlation of (a) the communication between the content site and a computing device responsive to a human input; and (b) the communication between the computing device responsive to a human user input and the beneficiary site. The computing device may include a computer-readable media computer-readable signal-bearing medium configurable by data outputted by at least one of the communications monitoring module and/or the evaluation module. The computing device may include a retention module storage media operable to maintain informational data corresponding to the determined correlation. In addition to the foregoing, other computing device embodiments are described in the claims, drawings, and text that form a pail of the present application.

A further embodiment provides a computer program product. The computer program product includes a computer-readable signal-bearing medium bearing program instructions. The program instructions operable to perform an influence evaluation process in a computing device, the process including receiving at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content provider site, content site, a search engine site, and/or a beneficiary site. The search engine site data gathered through a process running on a platform of the search engine site, and indicative of communication between the search engine site and the computing device responsive to a human user input. The beneficiary site data gathered through a process running on a platform of the beneficiary site, and indicative of communication between the computing device responsive to a human input and the beneficiary site. The process also includes assessing an influence of the content site on an involvement between the computing device responsive to a human user input and the beneficiary site. The process may include receiving data indicative of an affinity of a human user of the computing device. The process may include outputting the influence assessment in a form usable by a process facilitating delivery of a benefit to an owner of the content site. The process may include maintaining informational data corresponding to the assessment of influence. The process may include providing access to maintained informational data corresponding to the assessment of influence. In addition to the foregoing, other computer program product embodiments are described in the claims, drawings, and text that form a part of the present application.

An embodiment provides a device. The device includes means for receiving at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content provider site, content site, a search engine site, and/or a beneficiary site. The search engine site data gathered through a process running on a platform of the search engine site, and indicative of communication between the search engine site and the computing device responsive to a human user input. The beneficiary site data gathered through a process running on a platform of the beneficiary site, and indicative of communication between the computing device responsive to a human input and the beneficiary site. The device also includes means for assessing an influence of the content site on an involvement between the computing device responsive to a human user input and the beneficiary site. The device may include means for receiving data indicative of an affinity of a human user of the computing device. The device may include means for outputting the influence assessment in a form usable by a process facilitating delivery of a benefit to an owner of the content site. In addition to the foregoing, other device embodiments are described in the claims, drawings, and text that form a part of the present application.

Another embodiment provides an apparatus. The apparatus includes one or more physical media configured to bear a device-detectable implementation of a method including at least receiving at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content site, a search engine site, and/or a beneficiary site. The search engine site data gathered through a process running on a platform of the search engine site, and indicative of communication between the search engine site and the computing device responsive to a human user input. The beneficiary site data gathered through a process running on a platform of the beneficiary site, and indicative of communication between the computing device responsive to a human user input and the beneficiary site. The device-detectable implementation of a method also including determining a correlation between (a) the communication between the content site and the computing device responsive to a human user input; and (b) the communication between the computing device responsive to a human user input and the beneficiary site. In addition to the foregoing, other apparatus embodiments are described in the claims, drawings, and text that form a part of the present application.

A further embodiment provides an apparatus. The apparatus includes one or more physical media bearing a device-detectable output indicating an occurrence of receiving at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content site, a search engine site, and/or a beneficiary site. The search engine site data gathered through a process running on a platform of the search engine site, and indicative of communication between the search engine site and the computing device responsive to a human user input. The beneficiary site data gathered through a process running on a platform of the beneficiary site, and indicative of communication between the computing device responsive to a human user input and the beneficiary site, physical media bearing a device-detectable output indicating an occurrence of determining a correlation between (a) the communication between the content site and the computing device responsive to a human user input; and (b) the communication between the computing device responsive to a human user input and the beneficiary site. In addition to the foregoing, other apparatus embodiments are described in the claims, drawings, and text that form a part of the present application.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an exemplary embodiment of a thin computing device in which embodiments may be implemented;

FIG. 2 illustrates an exemplar), embodiment of a general-purpose computing system in which embodiments may be implemented;

FIG. 3 illustrates an exemplary system in which embodiments may be implemented;

FIG. 4 illustrates an exemplary network environment in which embodiments may be implemented;

FIG. 5 illustrates an exemplary operational flow;

FIG. 6 illustrates an embodiment of the exemplary operational flow of FIG. 5;

FIG. 7 illustrates another embodiment of the exemplary operational floral of FIG. 5;

FIG. 8 illustrates a further embodiment of the exemplary operational flow, of FIG. 5;

FIG. 9 illustrates an embodiment of the exemplary operational flow of FIG. 5;

FIG. 10 illustrates another embodiment of the exemplary operational flow of FIG. 5;

FIG. 11 illustrates an embodiment of the exemplary operational flow of FIG. 5;

FIG. 12 illustrates another embodiment of the exemplary operational flow of FIG. 5;

FIG. 13 illustrates a further embodiment of the exemplary operational flow of FIG. 5;

FIG. 14 illustrates an embodiment of the exemplary operational flows of FIG. 5;

FIG. 15 illustrates another embodiment of the exemplary operational flow of FIG. 5;

FIG. 16 illustrates a further embodiment of the exemplary operational flow of FIG. 5;

FIG. 17 illustrates a further embodiment of the exemplary, operational flow of FIG. 5;

FIG. 18 illustrates a further embodiment of the exemplary operational flow, of FIG. 5;

FIG. 19 illustrates an embodiment of the exemplary operational flow of FIG. 5;

FIG. 20 illustrates an embodiment of the exemplary operational flow of FIG. 5;

FIG. 21 illustrates another embodiment of the exemplary operational flow of FIG. 5;

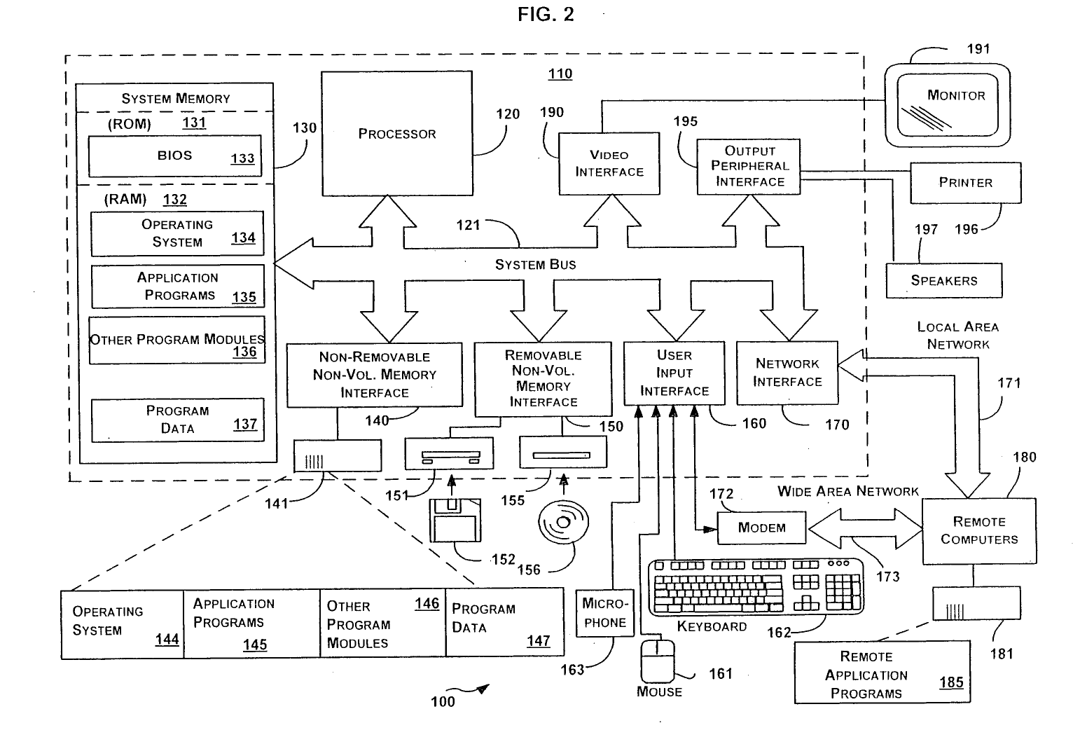

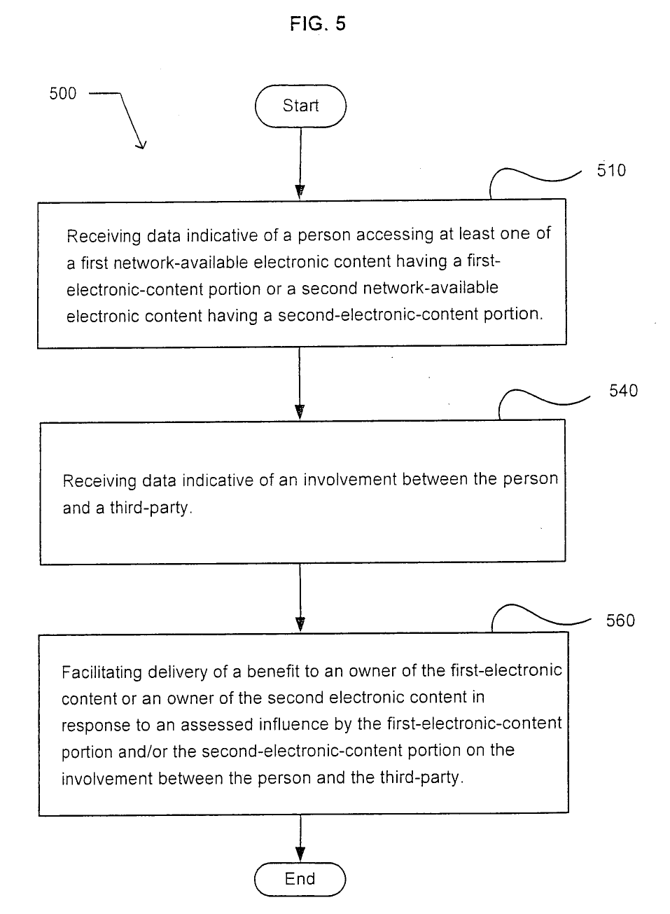

FIG. 2 illustrates a further embodiment of the exemplary operational floss of FIG. 5;

FIG. 23 illustrates an exemplary computer program product;

FIG. 24 illustrates an exemplary system;

FIG. 25 illustrates a device;

FIG. 26 illustrates an example of a system that may serve as a context for introducing one or more processes, systems or other articles;

FIG. 27 illustrates an exemplary operational flow;

FIG. 28 illustrates an alternative embodiment of the exemplary operational floors of FIG. 27;

FIG. 29 illustrates another alternative embodiment of the exemplary operational flow of FIG. 27;

FIG. 30 illustrates a further alternative embodiment of the exemplary operational flow of FIG. 27;

FIG. 31 illustrates a further alternative embodiment of the exemplary operational flow of FIG. 27;

FIG. 32 illustrates an alternative embodiment of the exemplary operational flow of FIG. 27;

FIG. 33 illustrates another alternative embodiment of the exemplary operational flow of FIG. 27;

FIG. 34 illustrates an alternative embodiment of the exemplary operational flow of FIG. 27;

FIG. 35 illustrates another alternative embodiment of the exemplary operational flow of FIG. 27;

FIG. 36 illustrates a further alternative embodiment of the exemplary operational flow of FIG. 27;

FIG. 37 illustrates an alternative embodiment of the exemplary operational flow of FIG. 27;

FIG. 38 illustrates another alternative embodiment of the exemplary operational floss of FIG. 27;

FIG. 39 illustrates a further alternative embodiment of the exemplary operational flow of FIG. 27;

FIG. 40 illustrates an exemplary computing device operable to communicate over a network;

FIG. 41 illustrates an exemplary computer program product;

FIG. 42 illustrates an exemplary device; and

FIG. 43 illustrates another system that may serve as a context for introducing one or more processes, systems or other articles described herein.

### DETAILED DESCRIPTION

In the following detailed description, reference is made to the accompanying drawings, which form a part hereof. In the drawings, similar symbols typically identify similar components, unless context dictates otherwise. The illustrated embodiments described in the detailed description, drawings, and claims are not meant to be limiting. Other embodiments may be utilized, and other changes may be made, without departing from the spirit or scope of the subject matter presented here.

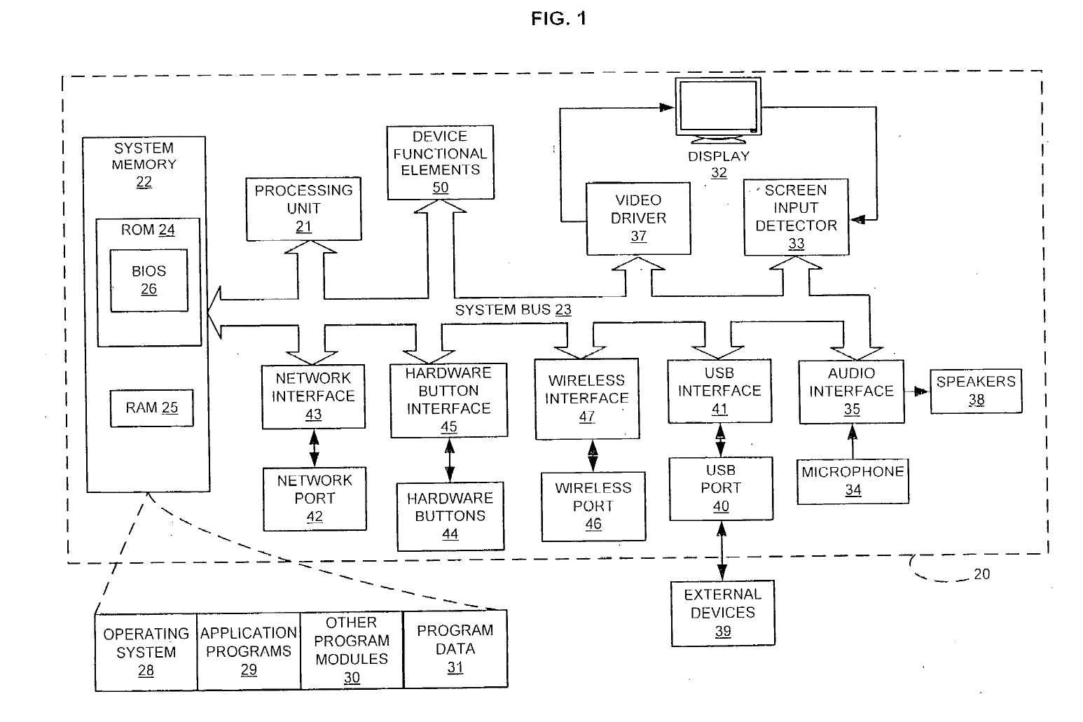

FIG. 1 and the following discussion are intended to provide a brief, general description of an environment in which embodiments may be implemented. FIG. 1 illustrates an exemplary system that includes a thin computing device 20, which may be included in an electronic device that also includes a device functional element 50. For example, the electronic device may include any item having electrical and/or electronic components playing a role in a functionality of the item, such as a limited resource computing device, an electronic pen, a handheld electronic writing device, a digital camera, a scanner, an ultrasound device, an x-ray machine, a non-invasive imaging device, a cell phone, a printer, a refrigerator, a car, and an airplane. The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer, information between sub-components within the thin computing device 20, such as during start-up, is stored in the ROM 24. A number of program modules may be stored in the ROM 24 and/or RAM 25, including an operating system 28, one or more application programs 29, other program modules 30 and program data 31.

A user may enter commands and information into the computing device 20 through input devices, such as a number of switches and buttons, illustrated as hardware buttons 44, connected to the system via a suitable interface 45. Input devices may further include a touch-sensitive display screen 32 with suitable input detection circuitry 33. The output circuitry of the touch-sensitive display 32 is connected to the system bus 23 via a video driver 37. Other input devices may include a microphone 34 connected through a suitable audio interface 35, and a physical hardware keyboard (not shown). In addition to the display 32, the computing device 20 may include other peripheral output devices, such as at least one speaker 38.

Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are exemplary and other components and means of establishing communications links may be used.

The computing device 20 may be primarily designed to include a user interface. The user interface may include a character, a key-based, and/or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and is coupled with the system bus 23 through an interface (not shown). The functional elements may typically perform a single well-defined task with little or no user configuration or setup, such as a refrigerator keeping food cold, a cell phone connecting with an appropriate tower and transceiving voice or data information, and a camera capturing and saving an image.

FIG. 2 illustrates an exemplary embodiment of a general-purpose computing system in which embodiments may be implemented, shown as a computing system environment 100. Components of the computing system environment 100 may include, but are not limited to, a computing device 110 having a processing unit 120, a system memory 130, and a system bus 121 that couples various system components including the system memory to the processing unit 120. The system bus 121 mail be any of several types of bus structures including a memory bus or memory controller, a peripheral bus, and a local bus using any of a variety of bus architectures. By, way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also shown as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media and communications media. Computer storage media includes volatile and nonvolatile, removable and non-removable media implemented in any method or technology for storage of information such as computer-readable instructions, data structures, program modules, or other data. Computer storage media includes, but is not limited to random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or an other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, and/or atomic quantum memory. Combinations of any of the above may also be included within the scope of computer-readable media.

Communications media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media such as a wired network and a direct-wired connection and wireless media such as acoustic, RF, optical, and infrared media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, and/or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by processing unit 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable nonvolatile memory interface 150 that, for example, is coupled to a magnetic disk drive 151 that reads from and writes to a removable, non-volatile magnetic disk 152, and/or is coupled to an optical disk drive 155 that reads from and writes to a removable, non-volatile optical disk 156, such as a CD ROM. Other removable/nonremovable, volatile/non-volatile computer storage media that can be used in the exemplary operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies. A user may enter commands and information into the computing device 110 through input devices such as a microphone 163, keyboard 162, and pointing device 161, commonly referred to as a mouse, trackball, or touch pad. Other input devices (not shown) may include a joystick, game pad, satellite dish, and scanner. These and other input devices are often connected to the processing unit 120 through a user input interface 160 that is coupled to the system bus, but may be connected by other interface and bus structures, such as a parallel port, game port, or a universal serial bus (USB). A monitor 191 or other type of displays device is also connected to the system bus 121 via an interface such as a video interface 190. In addition to the monitor, computers may also include other peripheral output devices such as speakers 197 and printer 196, which may be connected through an output peripheral interface 195.

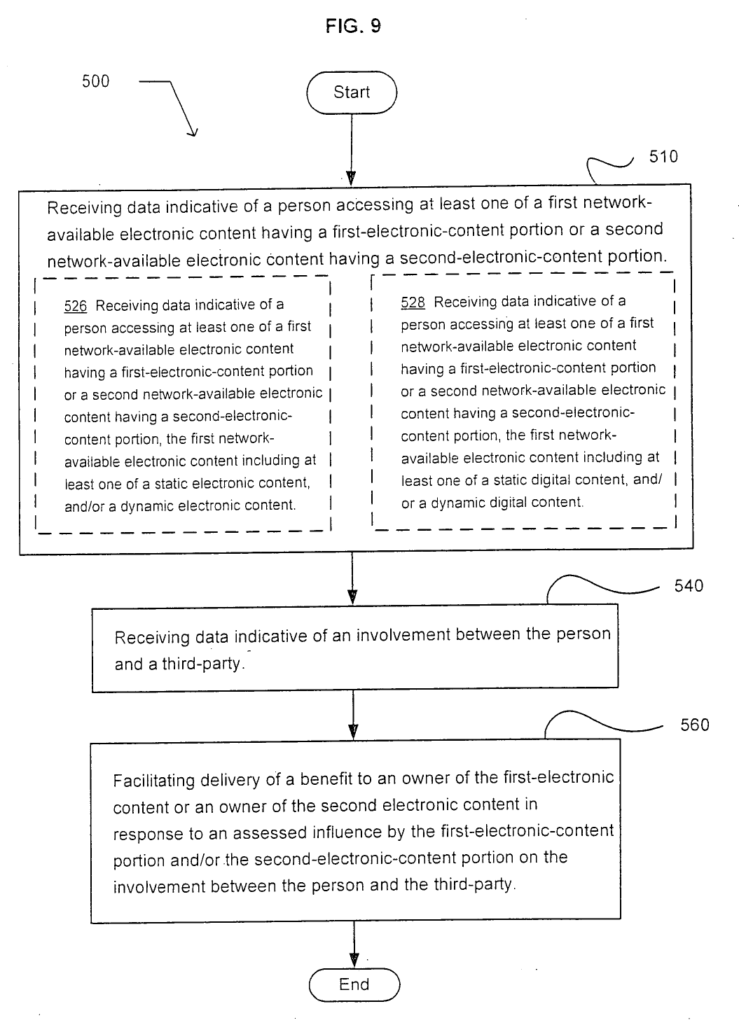

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The logical connections depicted in FIG. 9 include a local area network (LAN) 171 and a wide area network (WAN) 173, but may also include other networks such as a personal area network (PAN) (not shown). Such networking environments are commonplace in offices, enterprise-wide computer networks, intranets, and the Internet.

When used in a LAN networking environment, the computing system environment 100 is connected to the LAN 171 through a network interface or adapter 170. When used in a WAN networking environment, the computing device 110 tropically includes a modem 172 or other means for establishing communications over the WAN 173, such as the Internet. The modem 172, which may be internal or external, may be connected to the system bus 121 via the user input interface 160, or via another appropriate mechanism. In a networked environment, program modules depicted relative to the computing device 110, or portions thereof, may be stored in a remote memory storage device. By way of example, and not limitation, FIG. 2 illustrates remote application programs 185 as residing on computer storage medium 181. It will be appreciated that the network connections shown are exemplary and other means of establishing communications link between the computers may be used.

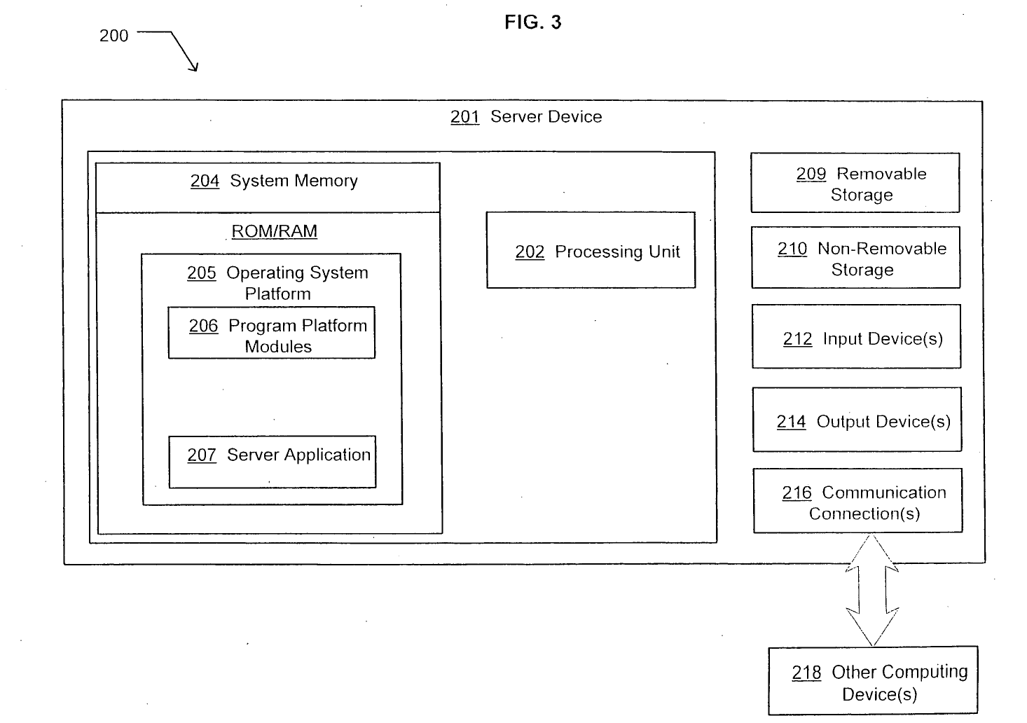

FIG. 3 illustrates an exemplary system 200 in which embodiments may be implemented. The exemplary system includes a computing system couplable to a network and operable to provide electronic content, such as a server 201. In an embodiment, the server may include an application server, audio server, database server, fax server, file server, intranet server, mail server, merchant server, modem server, network access server, network server, print server, proxy server, remote access server, telephony server, terminal server, video server, and/or Web server. In another embodiment, the server man include a network intermediary, a network switch, and/or a router. Server functionality may be implemented in software, hardware, firmware, and/or a combination thereof. Server functionality may be provided by a computing device that also provides other functionality. The network may include an electronic network, an optical network and/or a combination of optical and electronic networks.

In a configuration, the server 201 typically includes at least one processing unit 202 and system memory 204. System memory 204 typically includes operating system platform 205 and one or more program modules 206 running on operating system. In addition to the program modules 206, a server application 207 may also be running on the operating system. The server application 207 may be operable to deliver electronic content and/or files to applications via a protocol, and may include and/or interact with other computing devices, application servers, applications, and application interfaces (APIs) residing in other applications. For example, the server application may include a Web server operable to deliver Web pages and/or electronic content to Web browser applications via HTTP protocols.

The server 201 may have additional features or functionality. For example, server may also include additional data storage devices (removable and/or non-removable), as illustrated in FIG. 3 by removable storage 209 and non-removable storage 210. System memory 204, removable storage 209 and non-removable storage 210 are all examples of computer storage media. The server may include input device(s) 212 and output device(s) 214. The server also contains communication connections 216 that allows the device to communicate with and perform a service associated with a network, including communicating with other servers and/or with other computing device, illustrated as other computing device(s) 218. Communication connections 216 are one example of communication media.

FIGS. 1-3 are intended to provide a brief, general description of an illustrative and/or suitable exemplary environments in which embodiments may be implemented. An exemplary system may include the thin computing device 20 of FIG. 1, the computing system environment 100 of FIG. 2, and/or the server of FIG. 3. FIGS. 1-3 are examples of a suitable environment and is not intended to suggest any limitation as to the structure, scope of use, or functionality of an embodiment. A particular environment should not be interpreted as having any dependency or requirement relating to any one or combination of components illustrated in an exemplary environment. For example, in certain instances, one or more elements of an environment may be deemed not necessary and omitted. In other instances, one or more other elements may be deemed necessary and added. Further it will be appreciated that device(s) and/or environment(s) described herein may include numerous electrical, optical, mechanical, and/or digital components that may necessary to operate the device, but are not needed to illustrate the subject matter described herein. As such, some of these electrical, optical, mechanical, and/or digital components may be omitted from the specification for clarity.

In the description that follows, certain embodiments may be described with reference to acts and symbolic representations of operations that are performed by one or more computing devices, such as the computing device 110 of FIG. 2. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment here tasks are performed by, remote processing devices that are linked through a communications network. In a distributed computing environment program modules may be located in both local and remote computer storage media including memory, storage devices.

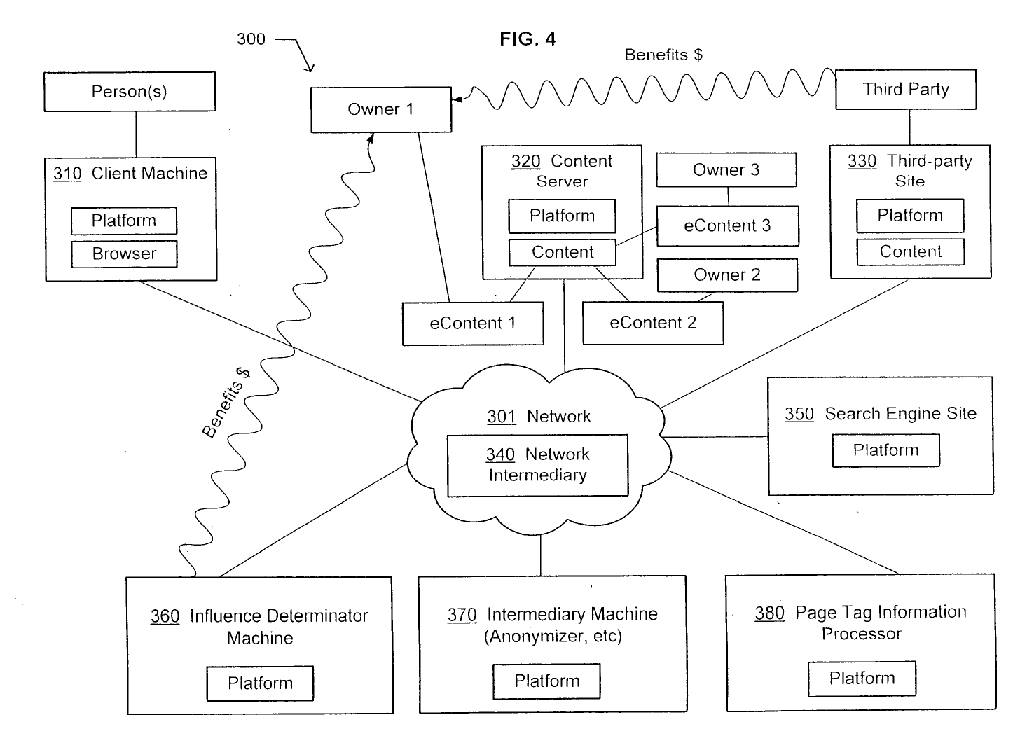

FIG. 4 illustrates an exemplary network environment 300 in which embodiments may be implemented. The exemplary environment includes networks, illustrated as a network 301, and client machines, illustrated as client machine 310. A fabric of the network may include networks intermediaries, illustrated as a network intermediary 340 running on a platform (not shown). In an embodiment, the client machine includes a computing device used by a human user. In another embodiment, the client machine includes a computing device used bad a human user to communicate in a peer-to-peer environment (P2P), and/or to communicate in a cloud-to-cloud environment (C2C). In a further embodiment, the client machine includes a computing device used by a human user to communicate with a server. The client machine may include the thin computing device 20 illustrated in FIG. 1, and/or the computing device 110 illustrated in FIG. 2.

The exemplary environment 300 also includes servers, illustrated as a content server 320. In an embodiment, the content server is operable to provide electronic content (illustrated as eContent 1 and/or eContent 2 to one or more client machines. In another embodiment, the content server includes the server 201 illustrated in FIG. 3. In a further embodiment, the content server(s) includes a node in P2P and/or a C2C network. The node may include the thin computing device 20 illustrated in FIG. 1, and/or the computing device 110 illustrated in FIG. 2. The exemplary environment also includes a third-party sites, illustrated as a third-party site 330. The third-party site may include a merchant site, such as amazon.com for books, a manufacturer site, such as subaru.com for automobiles, a religious institution, such as catholic.org and/or hinduism.com, and/or a political site, such as rnc.org and/or democrats.org. The exemplary environment also includes search engine sites, illustrated as a search engine site 350. The search engine site may include a general search engine site, such as google.com and/or live.com. In another embodiment, the search engine site may include a topical search site, such as HONMedhunt and/or FindLaw.com.

The exemplary environment 300 may also include an influence determinator machine 360, an intermediary machine 370, and/or a page tag information processor 380. Each of these machines may be operable to receive data and/or information gathered by at least one of the client machine 310, the content server 320, the third-party site 330, and/or the network intermediary 340, and to produce an output useable in assessing an influence on a person using the client machine by a content of the content server.

FIG. 5 illustrates an exemplary operational flow 500. After a start operations the operational flow moves to a navigation content operation 510. The navigation content operation receives data indicative of a person accessing at least one of a first network-available electronic content having a first-electronic-content portion or a second network-available electronic content having a second-electronic-content portion. An engagement data operation 540 receives data indicative of an involvement between the person and a third-party. A recognition operation 560 facilitates delivery of a benefit to an owner of the first-electronic content or an owner of the second electronic content in response to an assessed influence bad the first-electronic-content portion and/or the second-electronic-content portion on the involvement between the person and the third-party. The operational flow then moves to an end operation.

In an embodiment, the exemplary operational flow 500 may be performed at a computing device. For example, the exemplary operational flow may be performed by at least one of the client machine 310, the content server 320, the third-party site 330, the search engine site 350, the influence determinator machine 360, the intermediary machine 370, and/or the page tag information processor 380 of FIG. 4. In an embodiment, at least a portion of the data may be received from a platform or an application running on the platform of the device performing the operational flow 500. In an embodiment, the operational flow may be performed by a the content server using data received from the client machine and received from an application running on a platform of the content server. In another embodiment, the operational flow may be performed by the content server using data from both the client machine and the third-party site. In a further embodiment, the operational flow may be performed by the influence determinator machine using data received from at least one of the client machine, the content server, the search engine site, and/or the third-party site. In another embodiment, the operational flow may be performed by the search engine platform using data received from at least one of the client machine, the content server, and/or the third-party site.

FIG. 4 may be used to illustrate a use of an embodiment of the exemplary operational flow 500. For example, a person may use their computing device, illustrated as the client machine 310, to access over the Internet and browse blog pages hosted bad a content server, illustrated as the content server 320 and eContent 1 and eContent 2 respectively created by owner 1 and owner 2. By way of further example, in a situation where the person is looking to buy a new truck, they may access eContent 1 and eContent 2 looking for recommendations and reviews of trucks. The person may spend five minutes accessing eContent 1 because they like the content or find it helpful, and only ten seconds accessing eContent 2 because they do not find the content helpful. The navigation content operation 510 in FIG. 5 may receive data indicative of the person accessing eContent 1 having a first-electronic-content portion pertaining to Ford and GM trucks and eContent 2 having a second-electronic-content portion pertaining to Ford and Toyota trucks. The navigation operation may receive data indicative of respective access times and other aspects of the person's access. The person may use their computing device to become involved over the Internet with a third party, such as a Ford sales site. They may order delivery of printed promotional materials, a quote on a new truck, arrange a test drive, seek an address of a Ford dealer, and/or order a truck. Alternatively, they may become involved by visiting a dealer showroom, taking a test drive, and/or purchasing a truck. The engagement data operation 540 may receive data indicative of an involvement between the person and a third party, such as Ford. The data may be received from any number of sources, for example, such as the client machine 310, the third-party site 330, the network intermediary 340, the search engine site 350, and/or the page tag information processor 380. Alternatively, the data indicative of an involvement between the person and Ford may be manually gathered by a sales person at a dealership visited by the person. The recognition operation 560 facilitates delivery of a benefit to an owner of the first-electronic content or an owner of the second electronic content in response to an assessed influence by the first-electronic-content portion and/or the second-electronic-content portion on the involvement between the person and the third-party. For example, an assessed influence by the first-electronic-content portion and/or the second-electronic-content portion on the involvement between the person and the third-party may indicate that the first-electronic-content portion likely influenced the involvement between the person and the third-party, which in this example, is Ford. The recognition operation may facilitate a benefit to the owner of the first-electronic-content portion in response to the assessed influence.

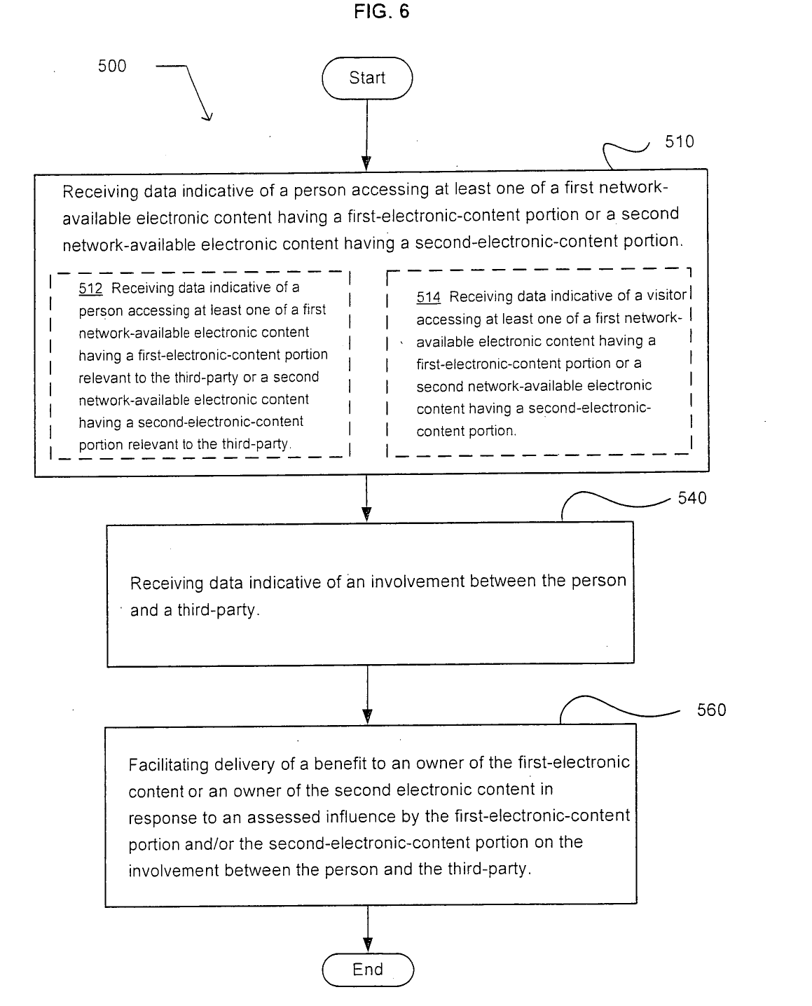

FIG. 6 illustrates an embodiment of the exemplar, operational flow 500 of FIG. 5. The navigation content operation 510 may include at least one additional operation. The at least one additional operation may include an operation 512 and/or an operation 514. The operation 512 receives data indicative of a person accessing al least one of a first network-available electronic content having a first-electronic-content portion relevant to the third-part or a second network-available electronic content having a second-electronic-content portion relevant to the third-party. The operation 514 receives data indicative of a visitor accessing at least one of a first network-available electronic content having a first-electronic-content portion or a second network-available electronic content having a second-electronic-content portion.

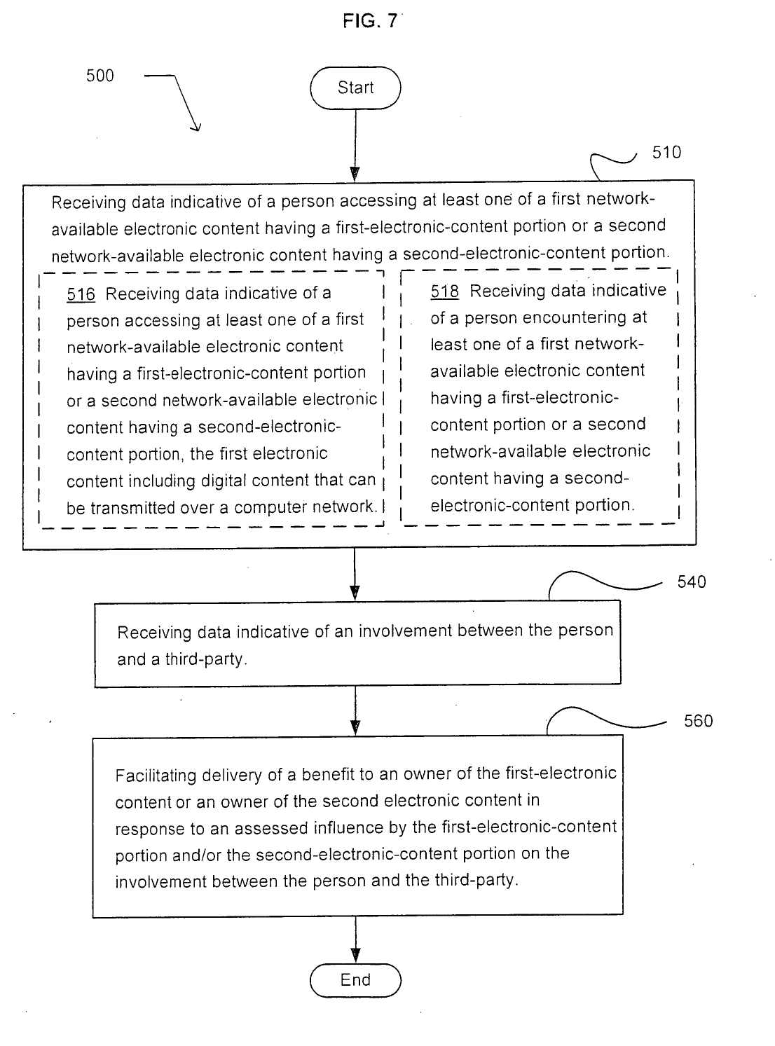

FIG. 7 illustrates another embodiment of the exemplary operational flow 500 of FIG. 5. The navigation content operation 510 may include at least one additional operation. The at least one additional operation may include an operation 516, and/or an operation 518. The operation 516 receives data indicative of a person accessing at least one of a first network-available electronic content having a first-electronic-content portion or a second network-available electronic content having a second-electronic-content portion. The first electronic content including digital content that can be transmitted over a computer network. The operational flow 518 receives data indicative of a person encountering at least one of a first network-available electronic content having a first-electronic-content portion or a second network-available electronic content having a second-electronic-content portion. The encountering may include indirectly accessing at least one of a first network-available electronic content having a first-electronic-content portion or a second network-available electronic content having a second-electronic-content portion. For example, indirectly accessing may include viewing a summary, a precis, and/or an aggregation of content that includes at least one of a first network-available electronic content or a second network-available electronic content.

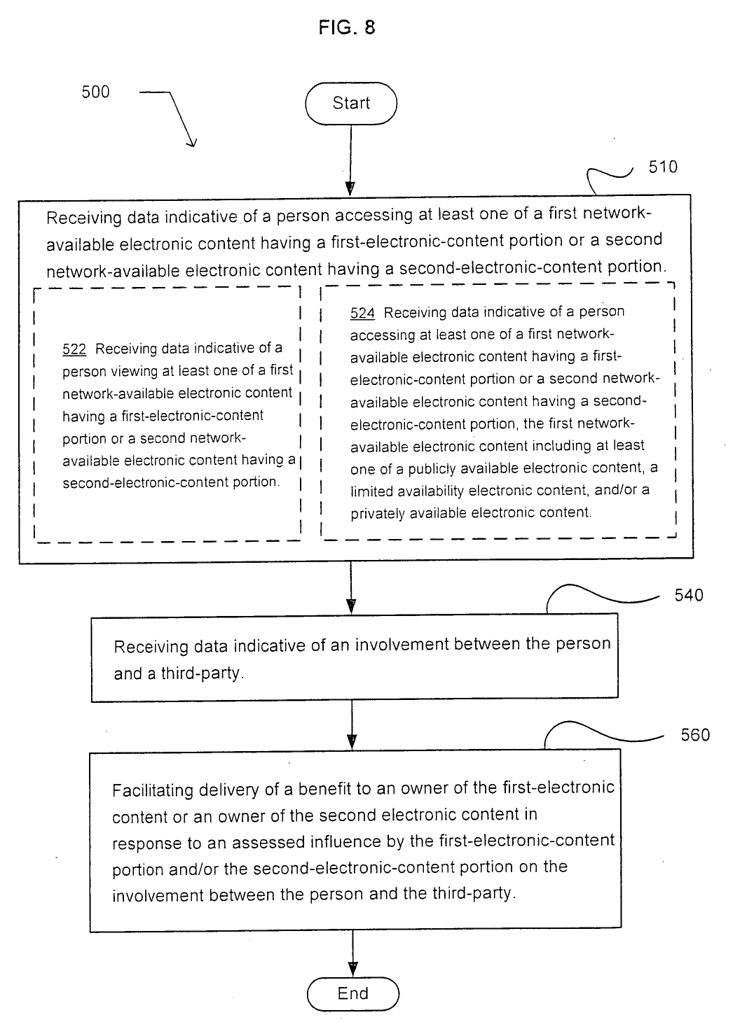

FIG. 8 illustrates a further embodiment of the exemplary operational flow 500 of FIG. 5. The navigation content operation 510 may include at least one additional operation. The at least one additional operation may include an operation 522, and/or an operation 524. The operation 522 receives data indicative of a person viewing at least one of a first network-available electronic content having a first-electronic-content portion or a second network-available electronic content having a second-electronic-content portion. The operation 524 receives data indicative of a person accessing at least one of a first network-available electronic content having a first-electronic-content portion or a second network-available electronic content having a second-electronic-content portion. The first network-available electronic content including at least one of a publicly available electronic content, a limited availability electronic content, and/or a privately available electronic content.

FIG. 9 illustrates an embodiment of the exemplary operational floats 500 of FIG. 5. The navigation content operation 510 mail include at least one additional operation. The at least one additional operation maid include an operation 526, and/or an operation 528. The operation 526 receives data indicative of a person accessing at least one of a first network-available electronic content having a first-electronic-content portion or a second network-available electronic content having a second-electronic-content portion. The first network-available electronic content including at least one of a static electronic content, and/or a dynamic electronic content. The operation 528 receives data indicative of a person accessing at least one of a first network-available electronic content having a first-electronic-content portion or a second network-available electronic content having a second-electronic-content portion. The first network-available electronic content including at least one of a static digital content, and/or a dynamic digital content.

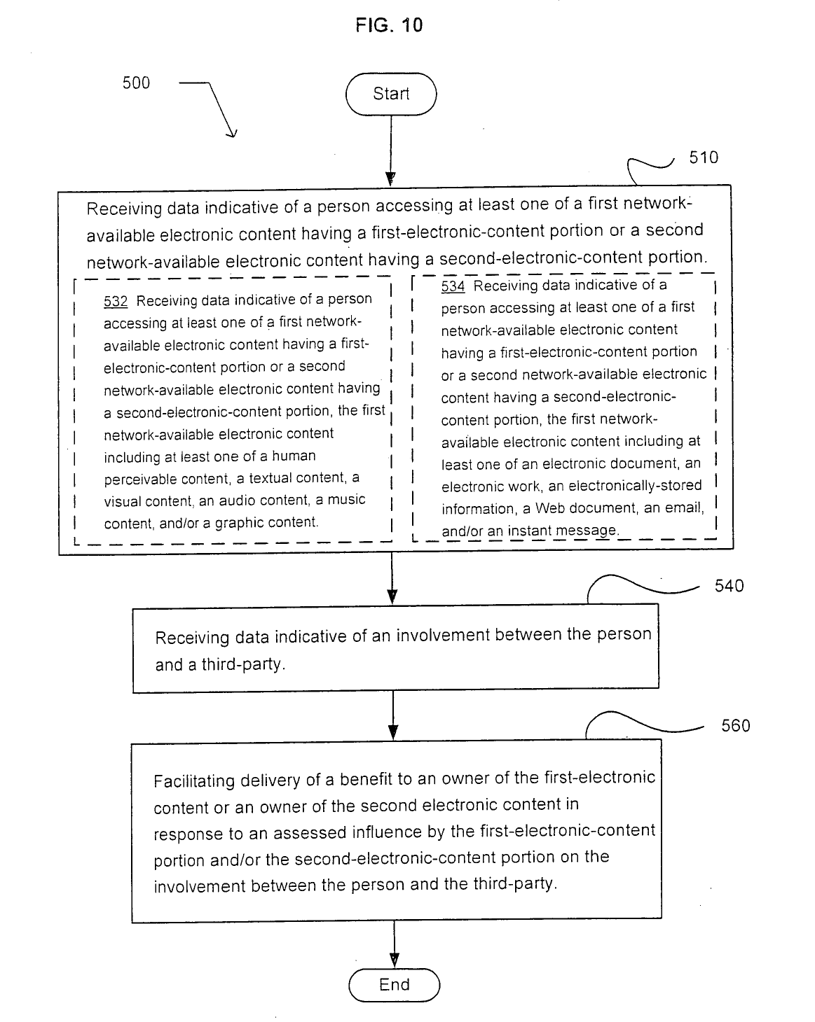

FIG. 10 illustrates another embodiment of the exemplary operational flows 500 of FIG. 5. The navigation content operation 510 may include at least one additional operation. The at least one additional operation may include an operation 532, and/or an operation 534. The operation 532 receives data indicative of a person accessing at least one of a first network-available electronic content having a first-electronic-content portion or a second network-available electronic content having a second-electronic-content portion. The first network-available electronic content including at least one of a human perceivable content, a textual content, a visual content, an audio content, a music content, and/or a graphic content. The operation 534 receives data indicative of a person accessing at least one of a first network-available electronic content having a first-electronic-content portion or a second network-available electronic content having a second-electronic-content portion. The first network-assailable electronic content including at least one of an electronic document, an electronic work, an electronically-stored information, music, video, a Web document, an email, and/or an instant message. In an embodiment, the Web document may include at least one of a Web site, a Web page, a Weblog, a blog, a blog entry, and/or a web element.

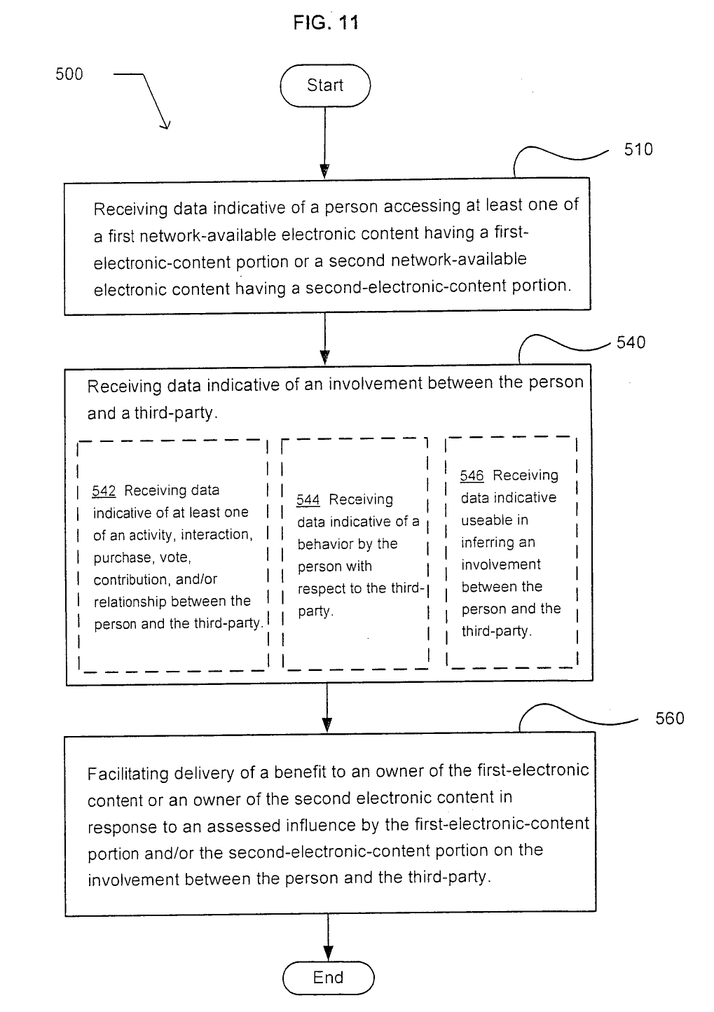

FIG. 11 illustrates an embodiment of the exemplary operational flow 500 of FIG. 5. The engagement data operation 540 may include at least one additional operation. The at least one additional operation may include an operation 542, an operation 544, and/or an operation 546. The operation 542 receives data indicative of at least one of an activity interaction, purchase, vote, contribution performance, and/or relationship between the person and the third-party. The operation 544 receives data indicative of a behavior by the person with respect to the third-party. In another embodiment, data indicative of a behavior by the person wraith respect to the third party includes hits, page views, visits, sessions, generating requests, viewing, time between visits, and/or impressions. The operation 546 receives data indicative useable in inferring an involvement between the person and the third-party.

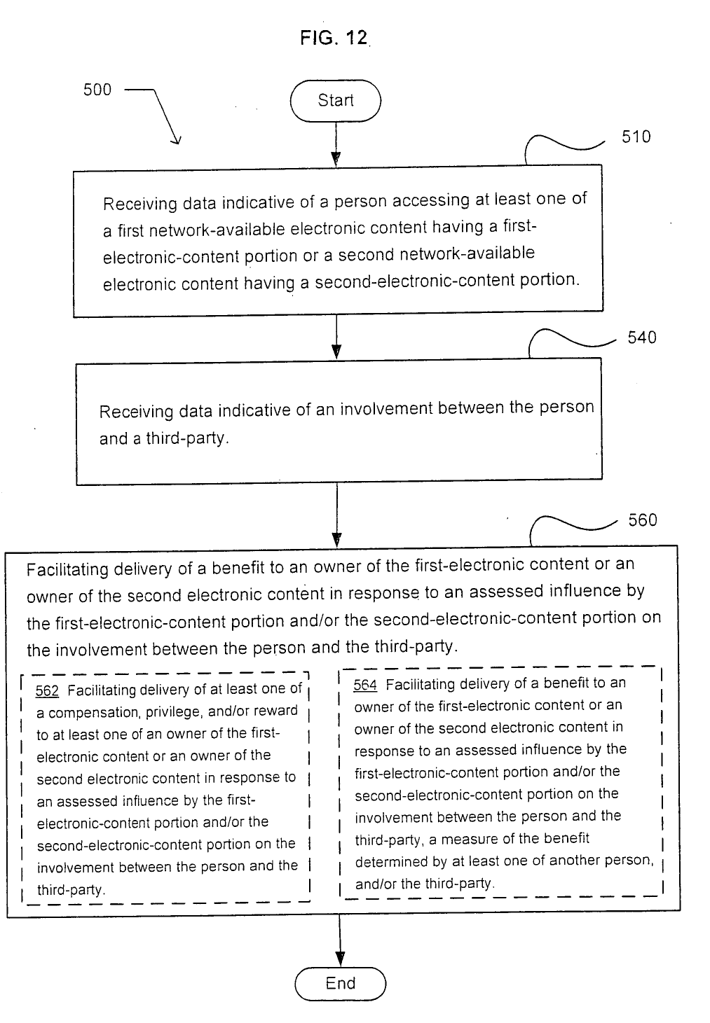

FIG. 12 illustrates another embodiment of the exemplary operational flow 500 of FIG. 5. The recognition operation 560 may include at least one additional operation. The at least one additional operation may include an operation 562, and/or an operation 564. The operation 562 facilitates delivery of at least one of a compensation, privilege, and/or reward to at least one of an owner of the first-electronic content or an owner of the second electronic content in response to an assessed influence bad the first-electronic-content portion and/or the second-electronic-content portion on the involvement between the person and the third-party. The operation 564 facilitates delivery of a benefit to an owner of the first-electronic content or an owner of the second electronic content in response to an assessed influence by the first-electronic-content portion and/or the second-electronic-content portion on the involvement between the person and the third-party. A measure of the benefit is determined by at least one of another person, and/or the third-party. In an embodiment, the measure of a benefit may include at least one of an amount, degree, and/or quantity.

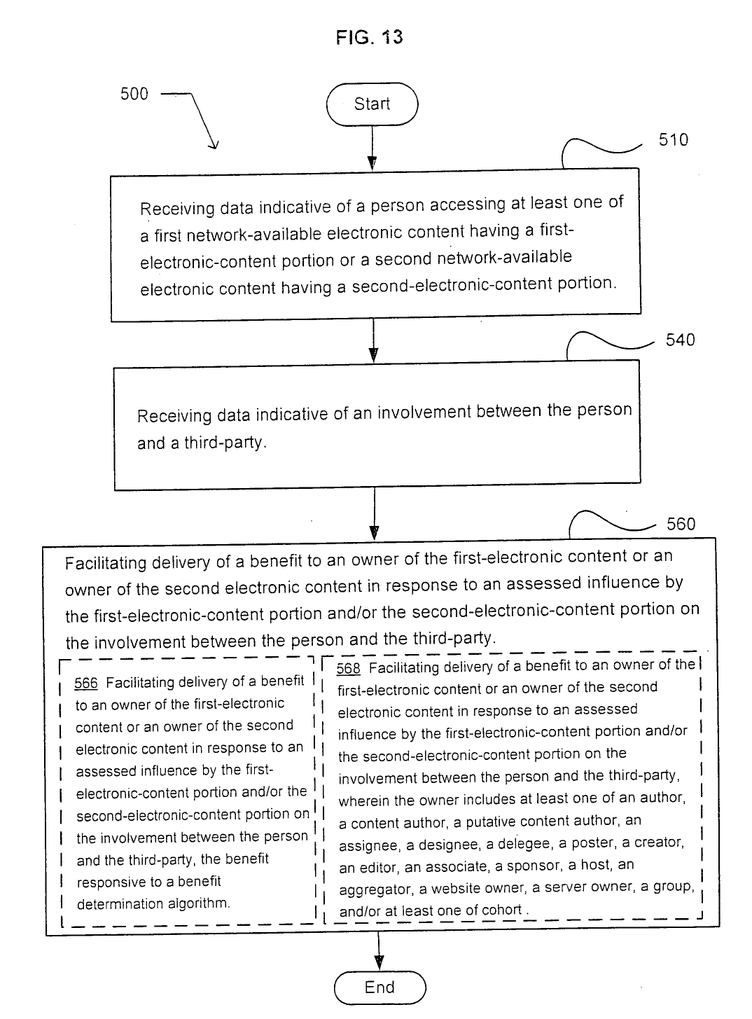

FIG. 13 illustrates a further embodiment of the exemplary operational flow 500 of FIG. 5. The recognition operation 560 may include at least one additional operation. The at least one additional operation may include an operation 566, and/or an operation 568. The operation 566 facilitates delivery of a benefit to an owner of the first-electronic content or an owner of the second electronic content in response to an assessed influence by the first-electronic-content portion and/or the second-electronic-content portion on the involvement between the person and the third-party, the benefit responsive to a benefit determination algorithm. In an alternative embodiment, the benefit determination algorithm includes a benefit contribution determination algorithm. The operation 568 facilitates delivery of a benefit to an owner of the first-electronic content or an owner of the second electronic content in response to an assessed influence by the first-electronic-content portion and/or the second-electronic-content portion on the involvement between the person and the third-party. The owner includes at least one of an author, a content author, a putative content author, an assignee, a designee, a delegee, a poster, a creator, an editor, an associate, a sponsor, a host, an aggregator, a website owner, a server owner, a group, and/or at least one of cohort. In an alternative embodiment, a cohort may include a social networking site, for example Facebook, MySpace, Classmates, YouTube, and/or Friendster.

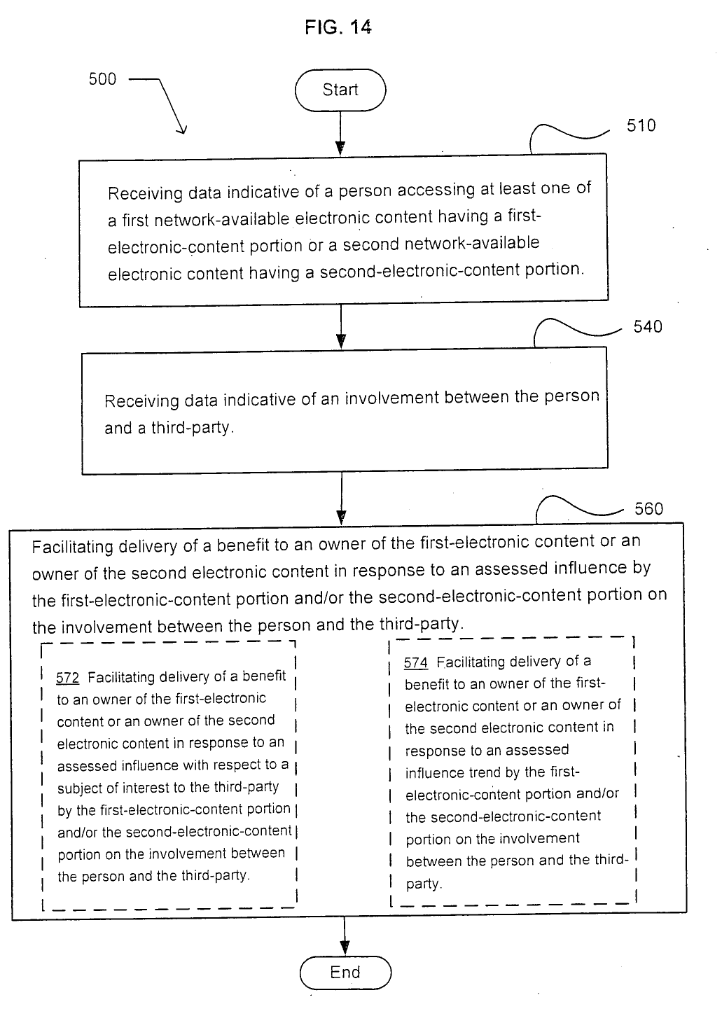

FIG. 14 illustrates an embodiment of the exemplary operational flow 500 of FIG. 5. The recognition operation 560 may include at least one additional operation. The at least one additional operation may include an operation 572, and/or an operation 574. The operation 572 facilitates delivery of a benefit to an owner of the first-electronic content or an owner of the second electronic content in response to an assessed influence with respect to a subject of interest to the third-party by the first-electronic-content portion and/or the second-electronic-content portion on the involvement between the person and the third-party. The operation 574 facilitates delivery of a benefit to an owner of the first-electronic content or an owner of the second electronic content in response to an assessed influence trend by the first-electronic-content portion and/or the second-electronic-content portion on the involvement between the person and the third-party.

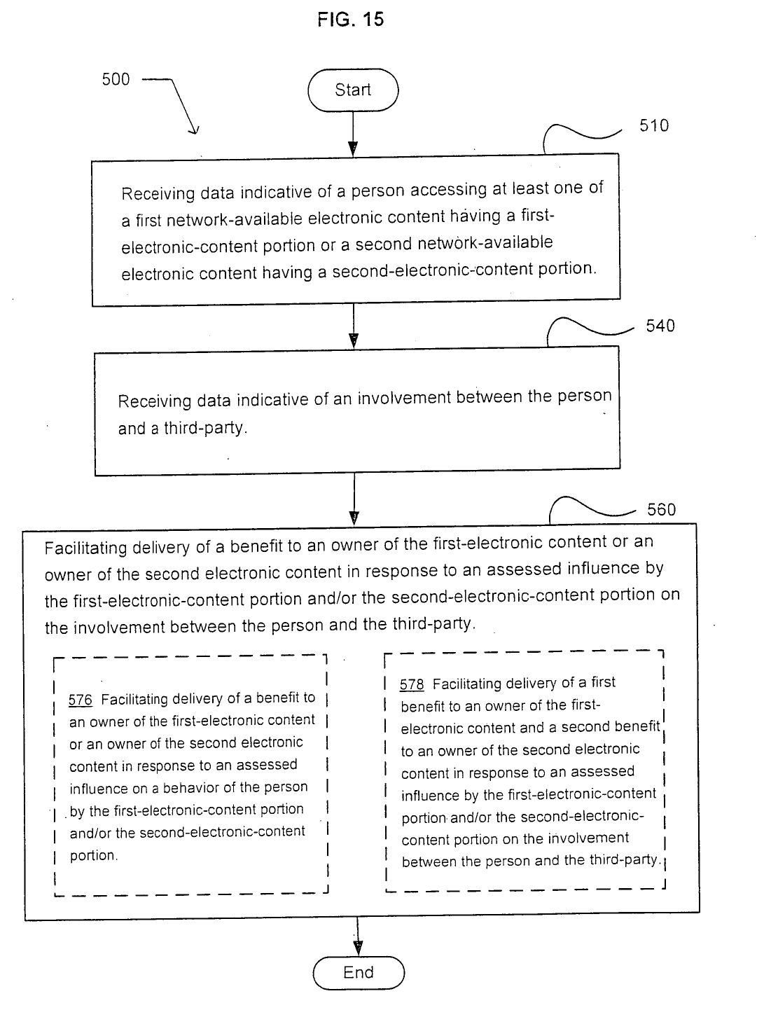

FIG. 15 illustrates another embodiment of the exemplary operational flow 500 of FIG. 5. The recognition operation 560 may include at least one additional operation. The at least one additional operation may include an operation 576, and/or an operation 578. The operation 576 facilitates delivery of a benefit to an owner of the first-electronic content or an owner of the second electronic content in response to an assessed influence on a behavior of the person by the first-electronic-content portion and/or the second-electronic-content portion. In an embodiment, an assessed influence may include generalized sales figures, election quotes, and/or enrollment. In another embodiment, an assessed influence may include sales figures, election votes, and/or enrollment related to the person. The operation 578 facilitates delivery of a first benefit to an owner of the first-electronic content and a second benefit to an owner of the second electronic content in response to an assessed influence by the first-electronic-content portion and/or the second-electronic-content portion on the involvement between the person and the third-party.

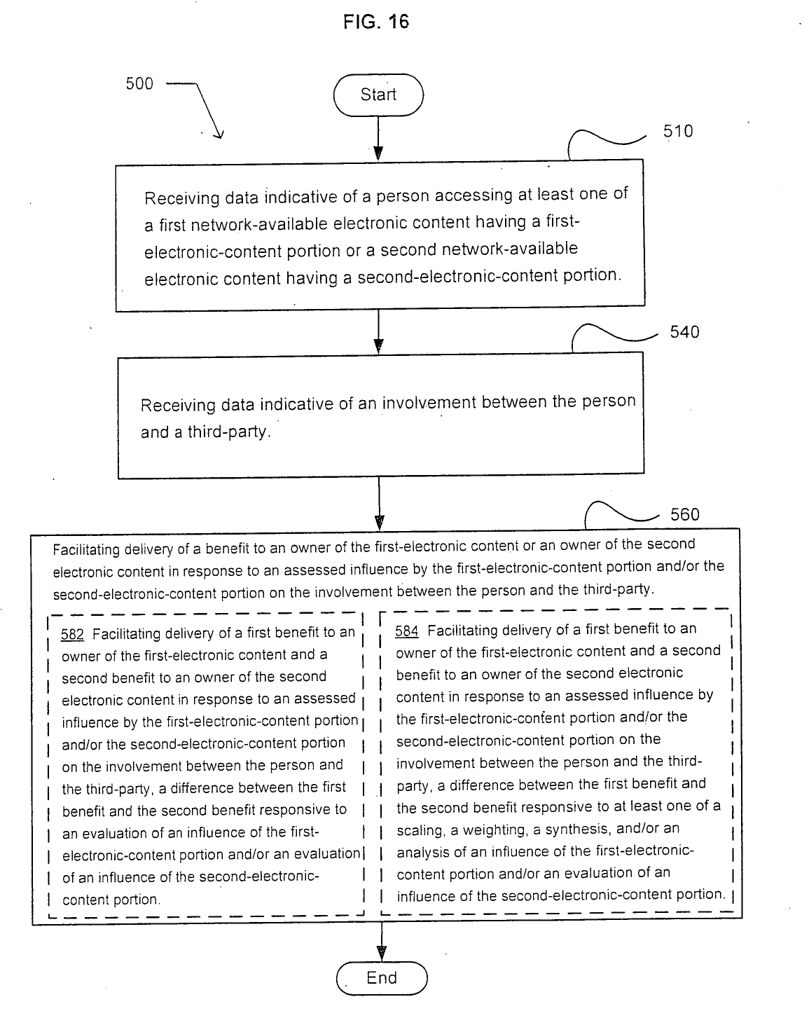

FIG. 16 illustrates a further embodiment of the exemplary operational flow 500 of FIG. 5. The recognition operation 560 may include at least one additional operation. The at least one additional operation may include all operation 582, and/or an operation 584. The operation 582 facilitates delivery of a first benefit to an owner of the first-electronic content and a second benefit to an owner of the second electronic content. The first benefit and the second benefit are in response to an assessed influence by the first-electronic-content portion and/or the second-electronic-content portion on the involvement between the person and the third-party. A difference between the first benefit and the second benefit being responsive to an evaluation of an influence of the first-electronic-content portion and/or an evaluation of an influence of the second-electronic-content portion. In an embodiment, the influence evaluation may include an algorithmically implemented influence evaluation. In another embodiment, the influence evaluation may include an artificial intelligence implemented influence evaluation. The operation 584 facilitates delivery of a first benefit to an owner of the first-electronic content and a second benefit to an owner of the second electronic content. The first benefit and the second benefit are in response to an assessed influence by the first-electronic-content portion and/or the second-electronic-content portion on the involvement between the person and the third-party. A difference between the first benefit and the second benefit is responsive to at least one of a scaling, a weighting, a synthesis, and/or an analysis of an influence of the first-electronic-content portion and/or an evaluation of an influence of the second-electronic-content portion.

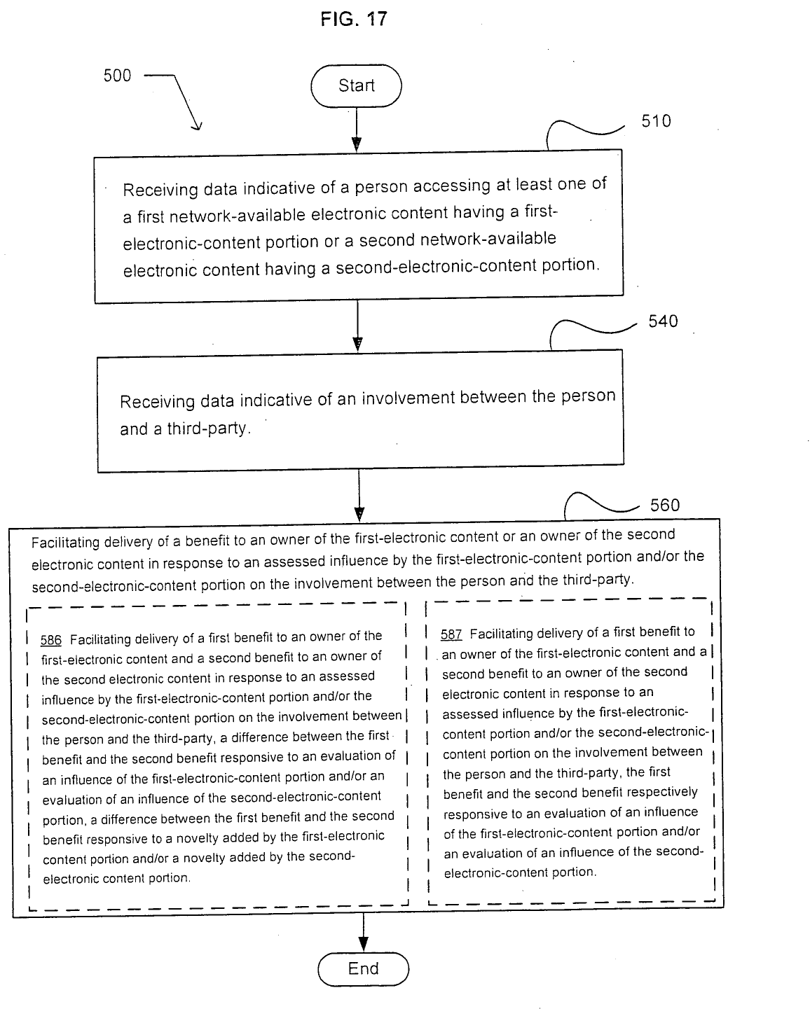

FIG. 17 illustrates a further embodiment of the exemplary operational flow 500 of FIG. 5. The recognition operation 560 may include at least one additional operation. The at least one additional operation may include an operation 586, and/or an operation 587. The operation 586 facilitates delivery of a first benefit to an owner of the first-electronic content and a second benefit to an owner of the second electronic content. The first benefit and the second benefit are in response to an assessed influence by the first-electronic-content portion and/or the second-electronic-content portion on the involvement between the person and the third-party. A difference between the first benefit and the second benefit is responsive to an evaluation of an influence of the first-electronic-content portion and/or an evaluation of an influence of the second-electronic-content portion, a difference between the first benefit and the second benefit responsive to a novelty added by the first-electronic content portion and/or a novelty added by the second-electronic content portion. The operation 587 facilitates delivery of a first benefit to an owner of the first-electronic content and a second benefit to an owner of the second electronic content in response to an assessed influence by the first-electronic-content portion and/or the second-electronic-content portion on the involvement between the person and the third-party. The first benefit and the second benefit respectively are response to an evaluation of an influence of the first-electronic-content portion and/or an evaluation of an influence of the second-electronic-content portion. In an embodiment, the first benefit and the second benefit are respectively responsive to at least one of an algorithm implemented evaluation, and/or an artificial intelligence implemented evaluation. In another embodiment, the first and second benefit are respectively responsive to at least one of at least one of a comparison, a relative allocation, a difference, and/or distribution of an influence of the first-electronic-content portion and/or an evaluation of an influence of the second-electronic-content portion.

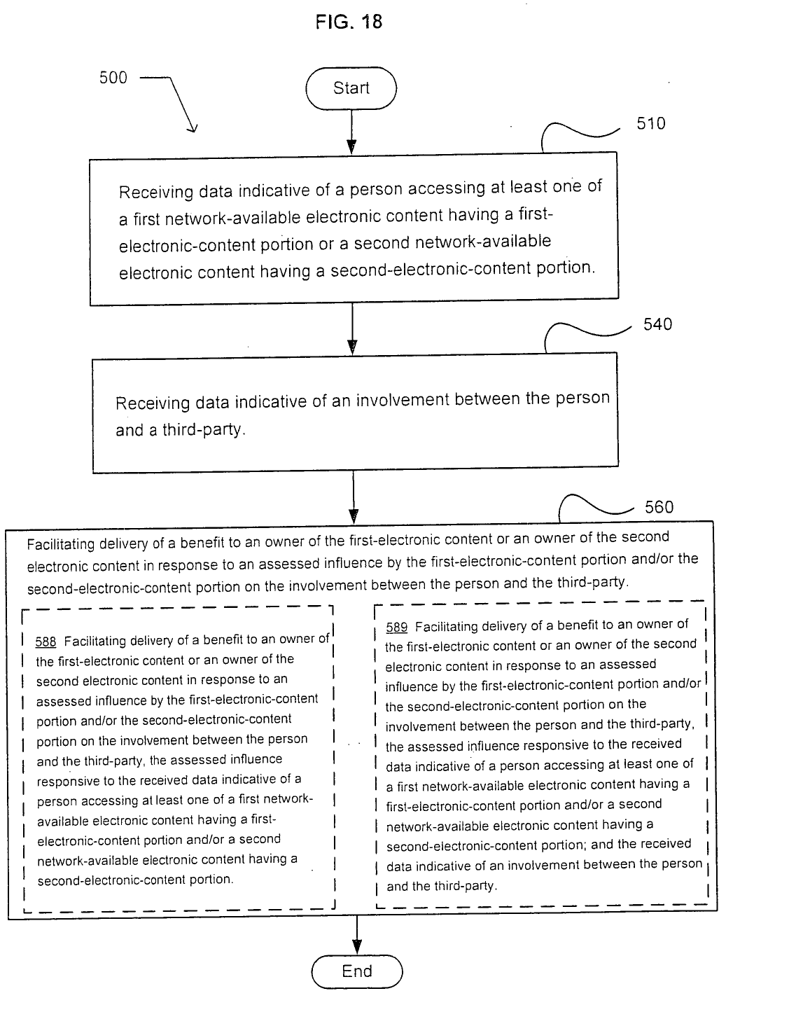

FIG. 18 illustrates a further embodiment of the exemplary operational flow 500 of FIG. 5. The recognition operation 560 may include at least one additional operation. The at least one additional operation may include an operation 588, and/or an operation 589. The operation 588 facilitates delivery of a benefit to an owner of the first-electronic content or an owner of the second electronic content. The benefit is in response to an assessed influence by the first-electronic-content portion and/or the second-electronic-content portion on the involvement between the person and the third-party. The assessed influence is responsive to the received data indicative of a person accessing a first network-available electronic content having a first-electronic-content portion and/or a second network-available electronic content having a second-electronic-content portion. The operation 589 facilitates delivery of a benefit to an owner of the first-electronic content or an owner of the second electronic content in response to an assessed influence by the first-electronic-content portion and/or the second-electronic-content portion on the involvement between the person and the third-party. The assessed influence is responsive to the received data indicative of a person accessing at least one of a first network-available electronic content having a first-electronic-content portion and/or a second network-available electronic content having a second-electronic-content portion; and the received data indicative of an involvement between the person and the third-party. The assessed influence may be responsive to one or more other factors.

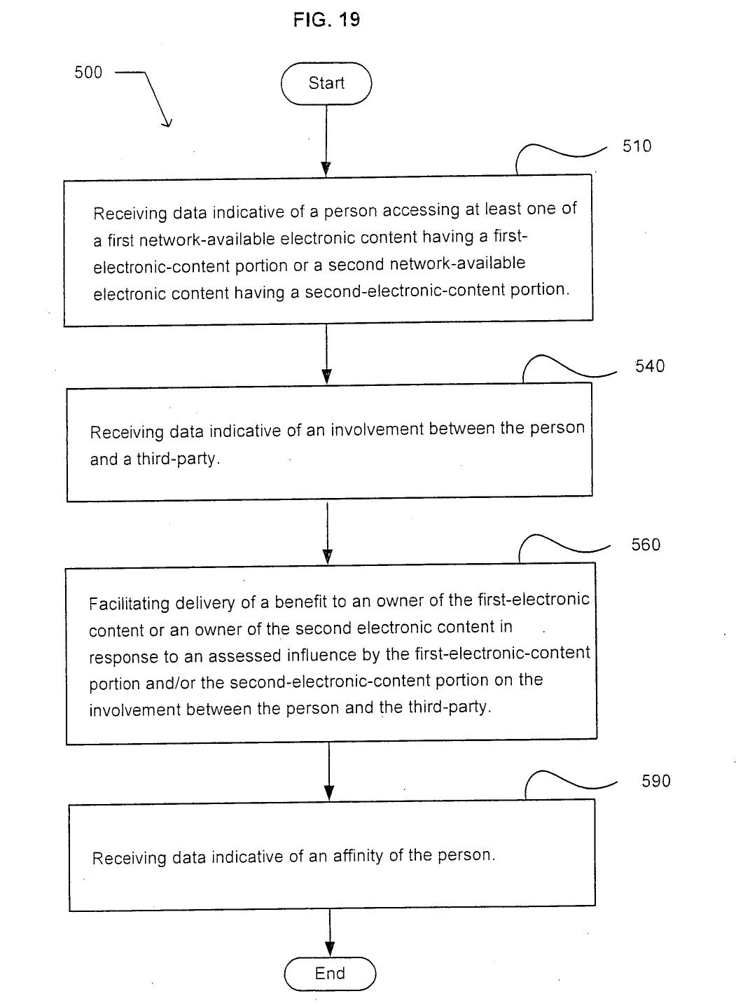

FIG. 19 illustrates an embodiment of the exemplary operational flow 500 of FIG. 5. The operational flow may include at least one additional operation, such as a kinship operation 590. The kinship operation receives data indicative of an affinity of the person. In an alternative embodiment, the data indicative of an affinity of the person is useable at the recognition operation 560 in assessing an influence by the first-electronic-content portion and/or the second-electronic-content portion on the involvement between the person and the third-panty.

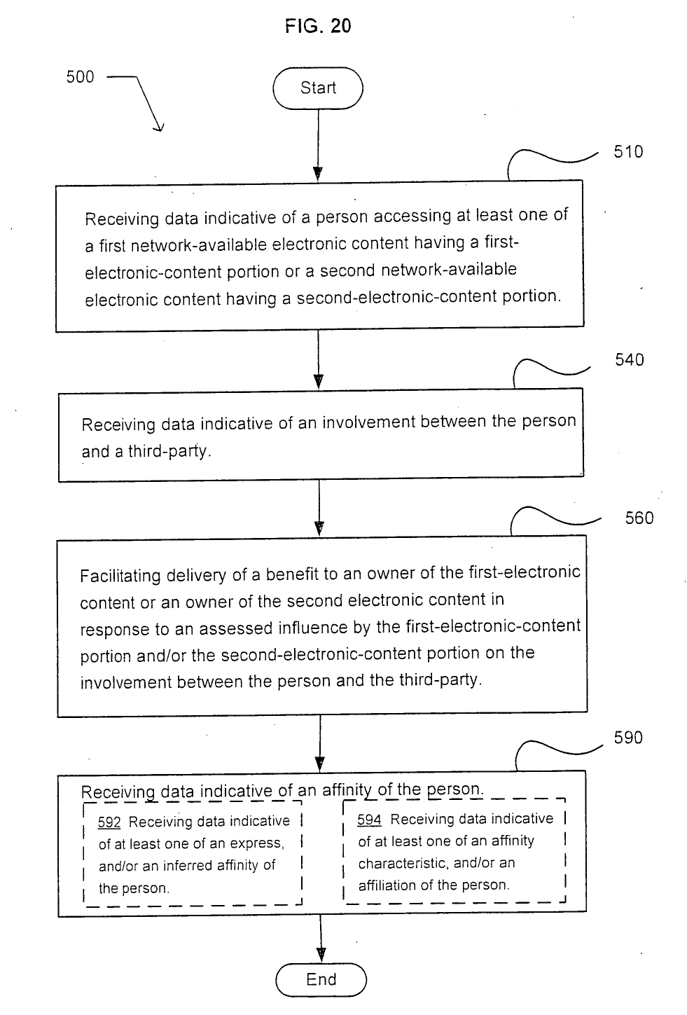

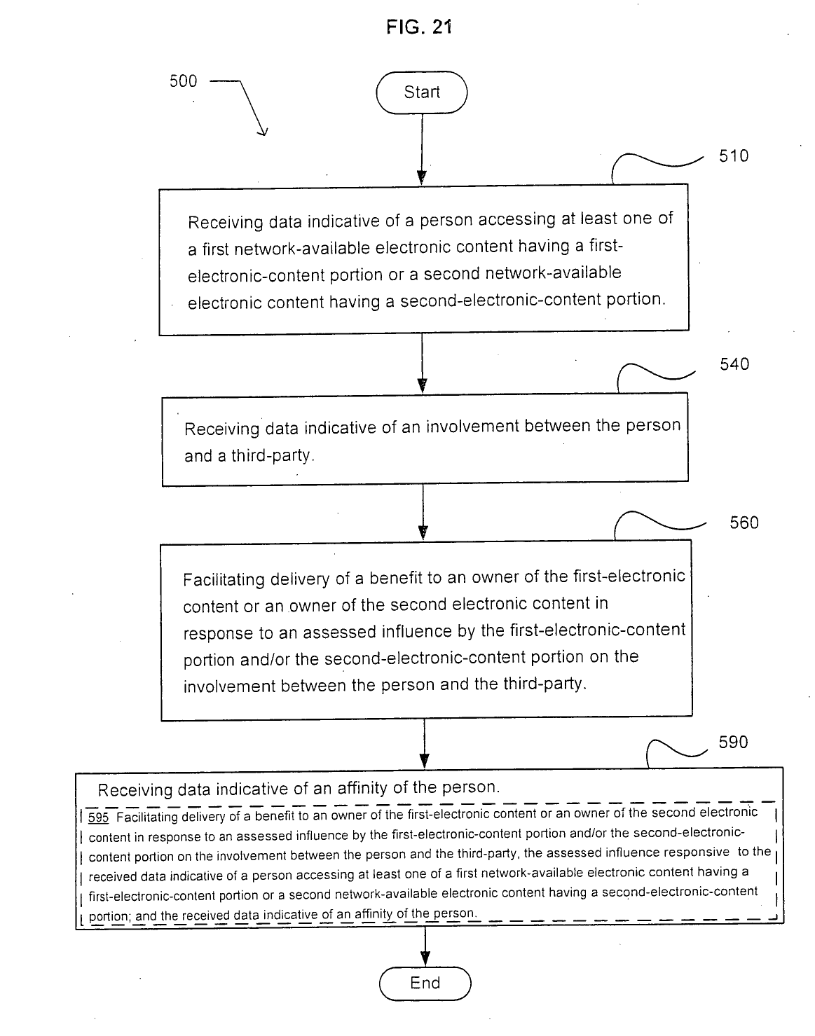

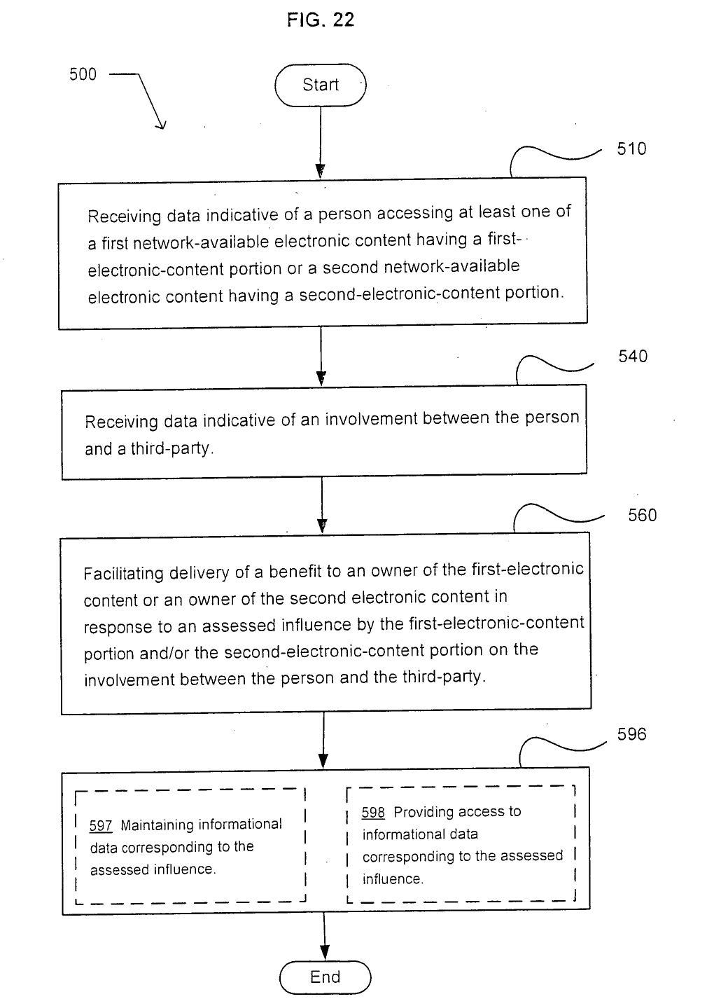

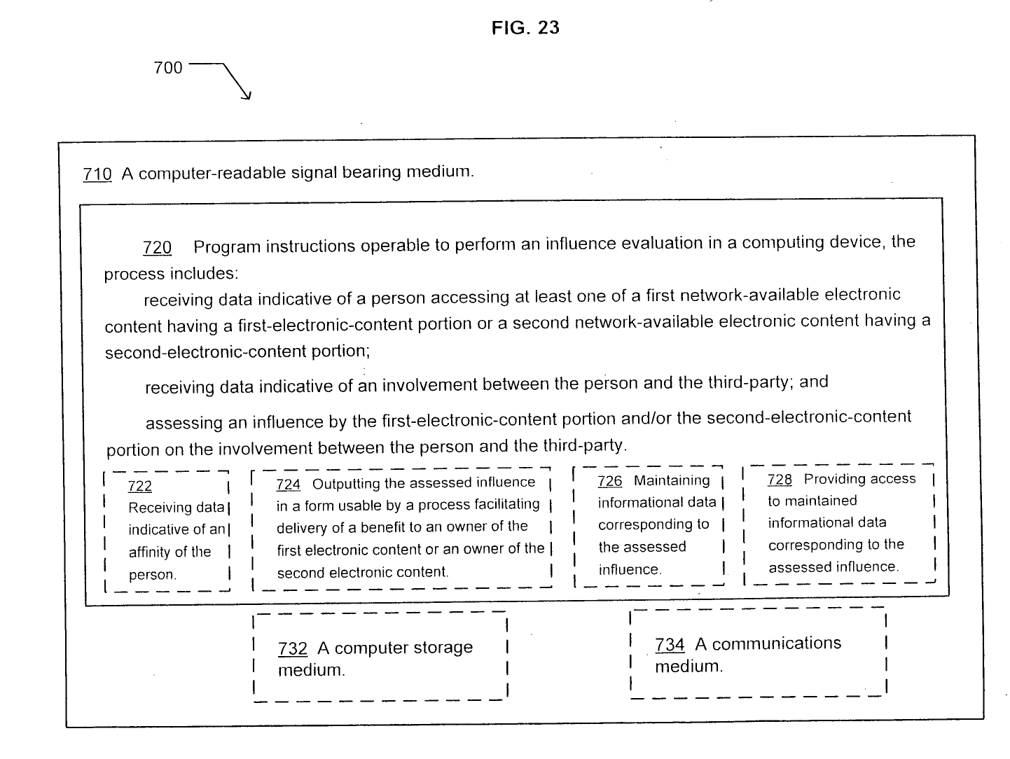

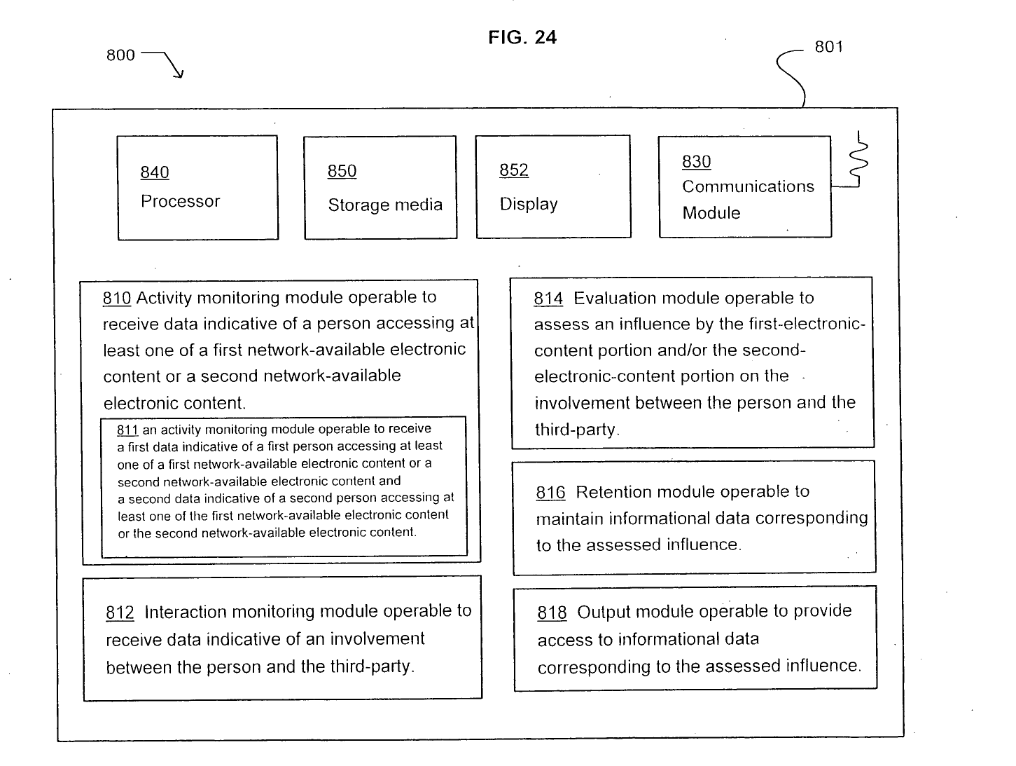

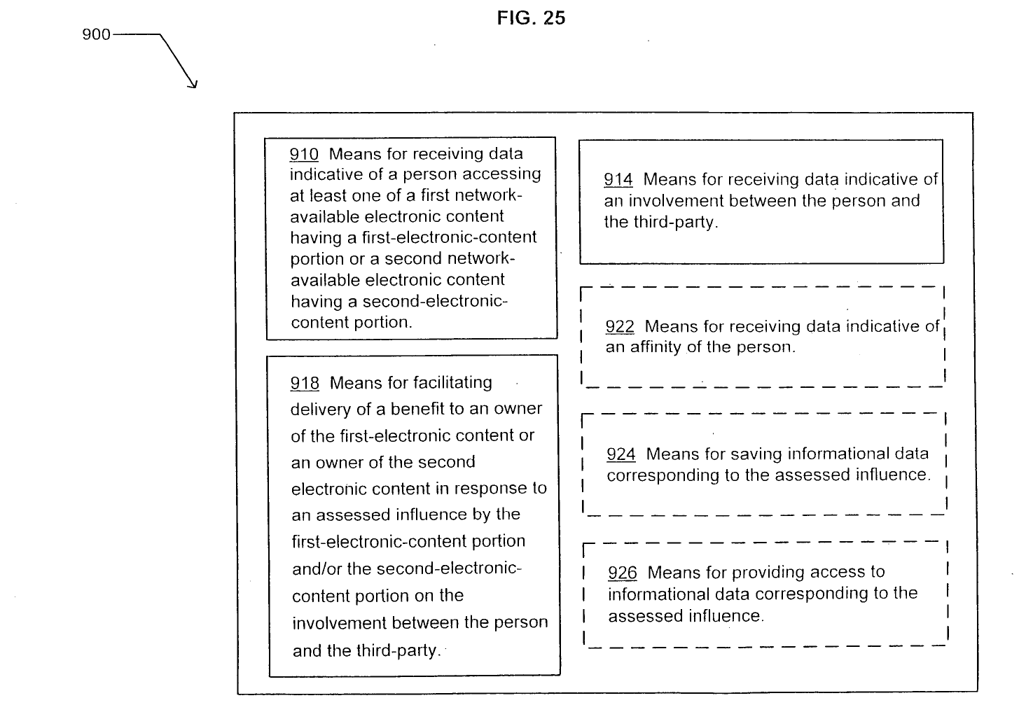

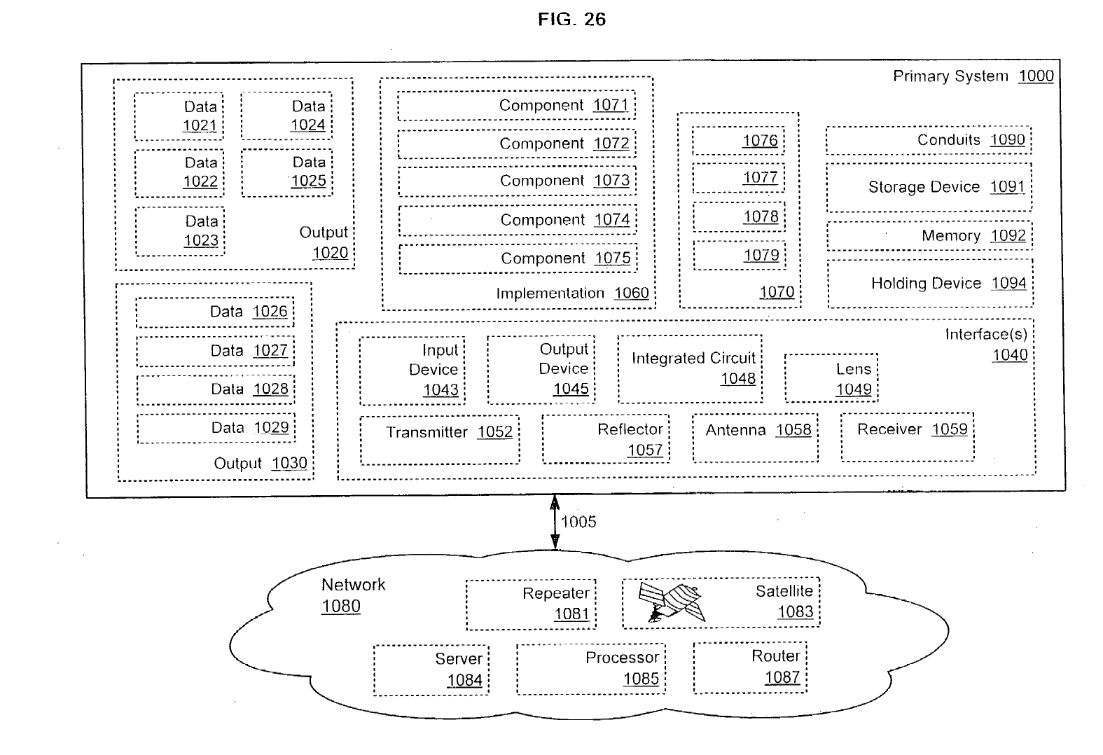

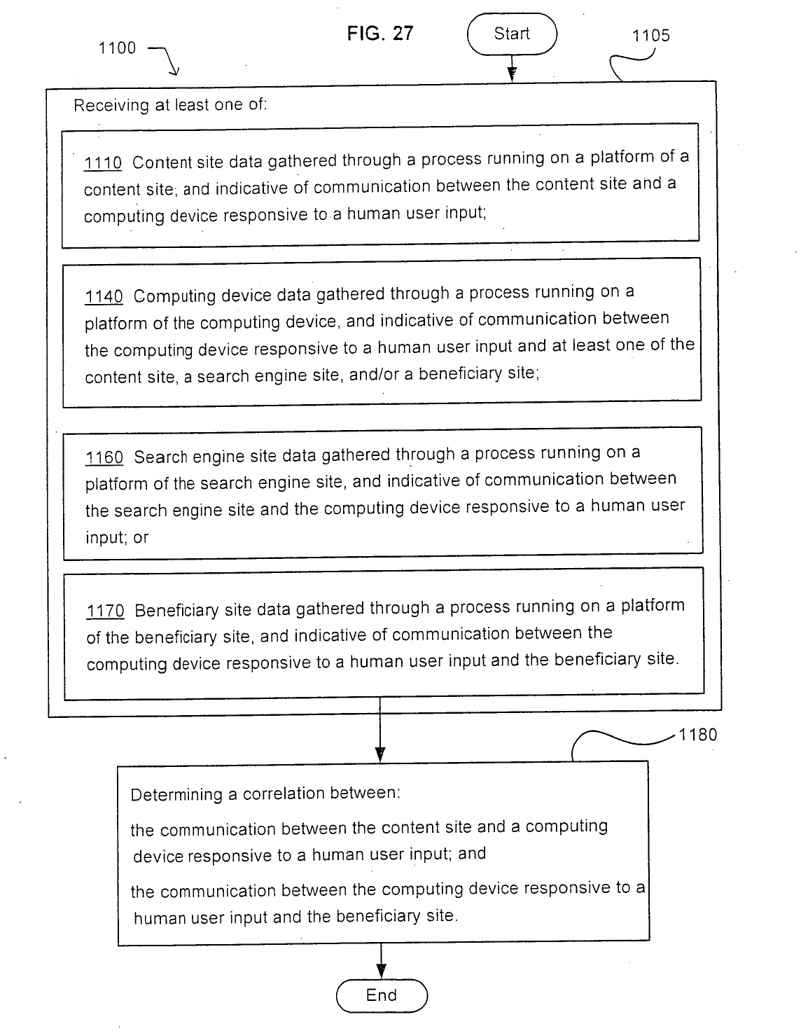

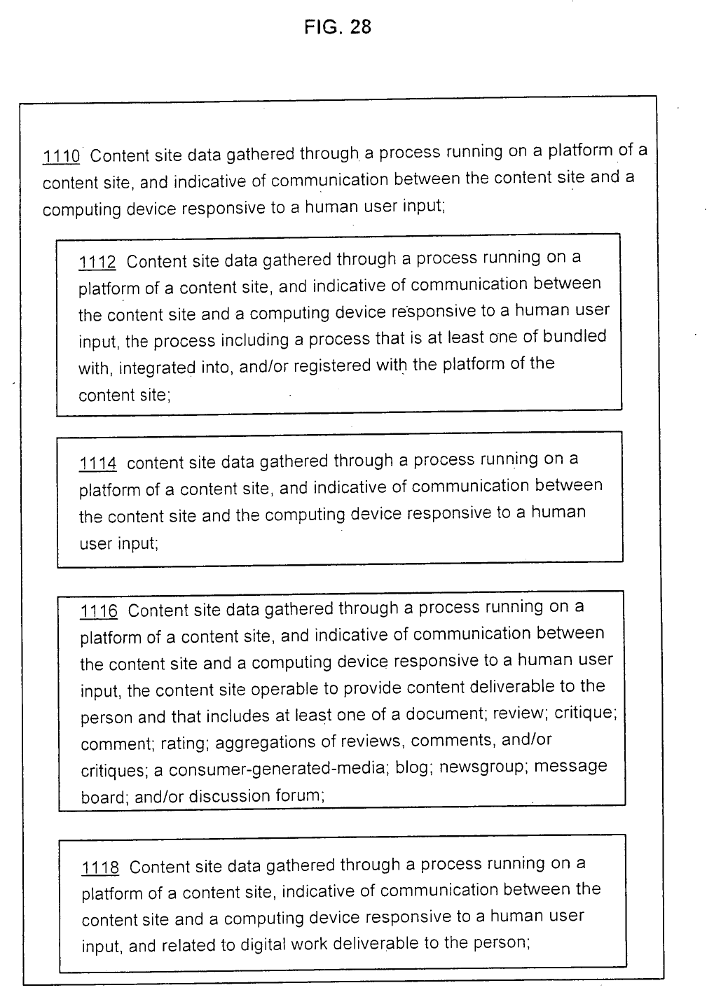

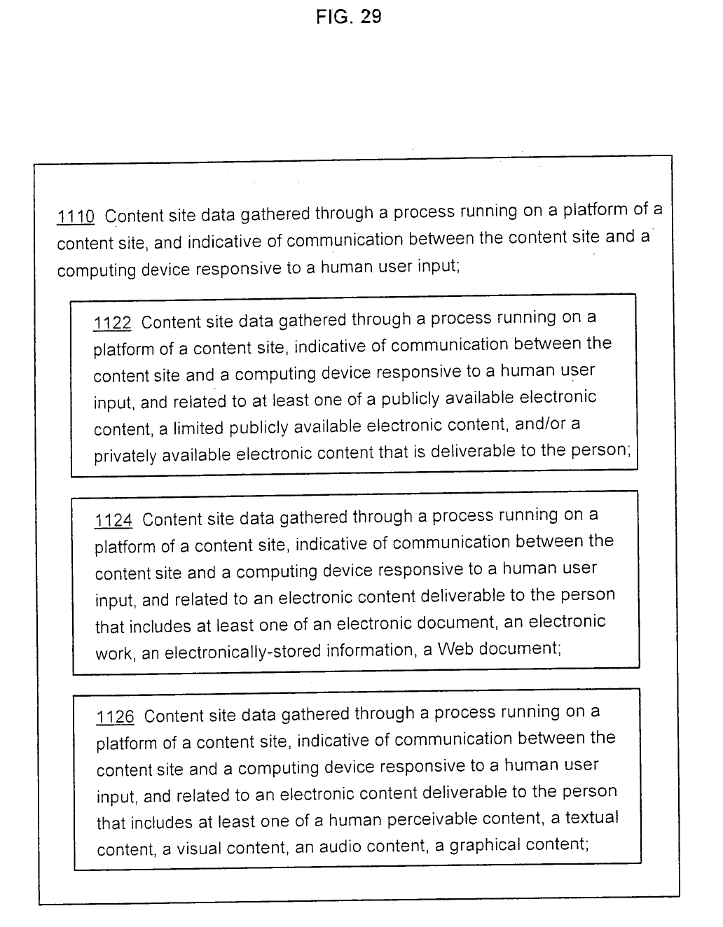

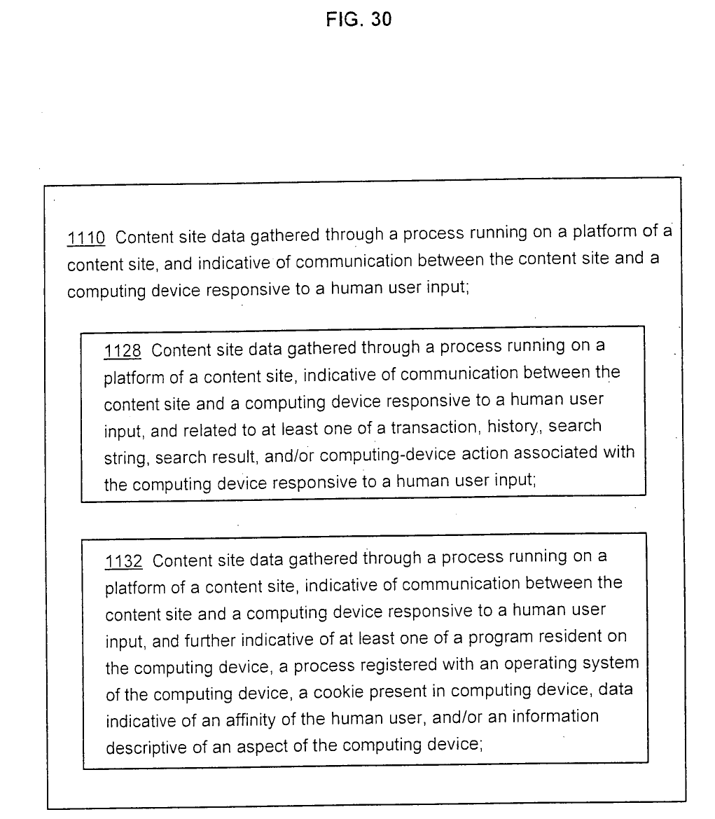

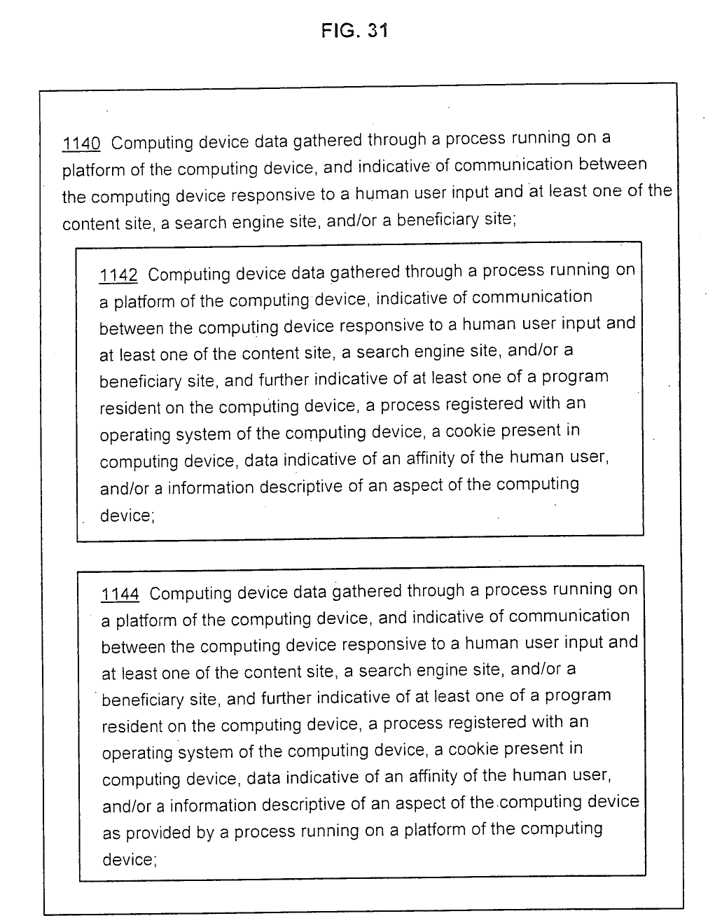

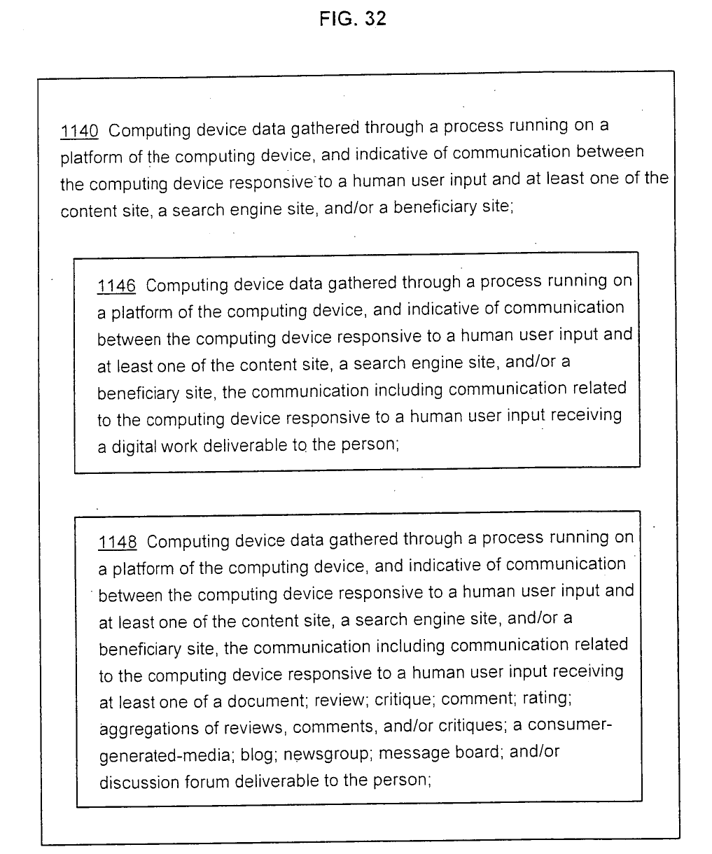

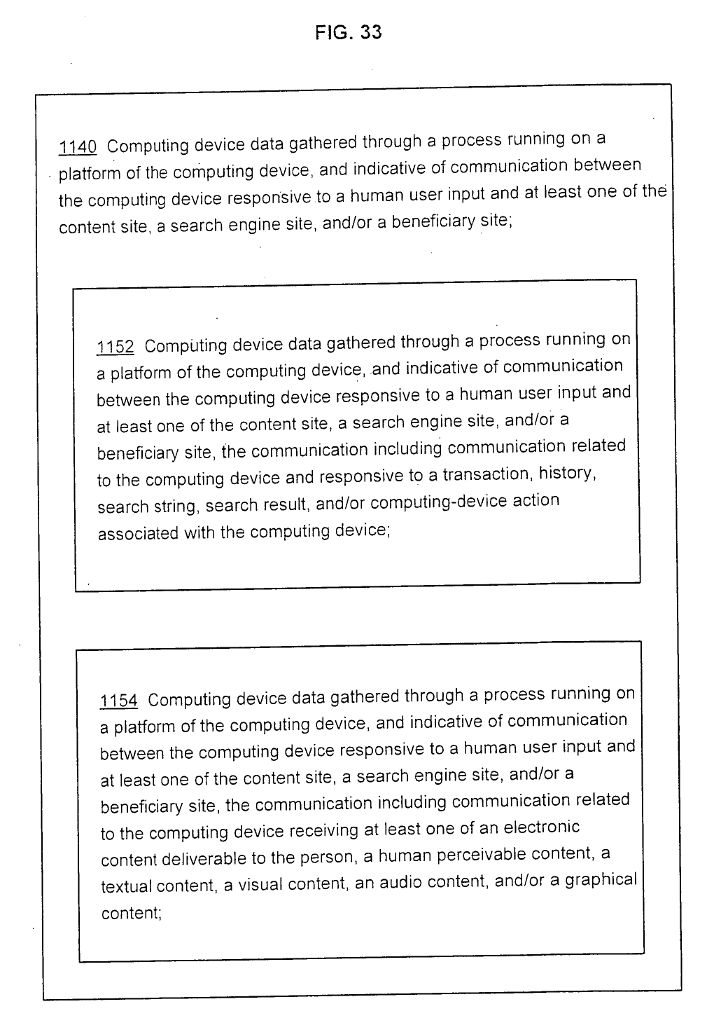

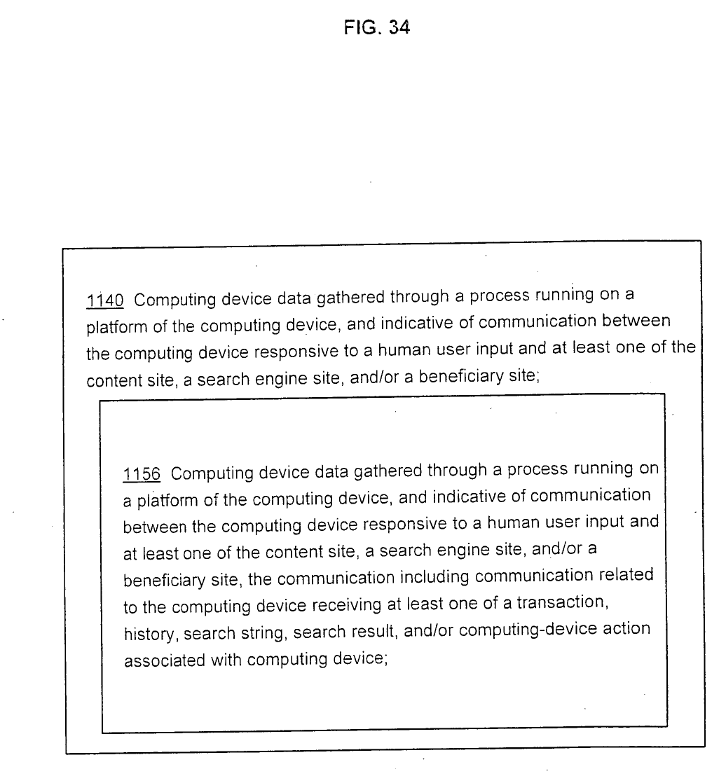

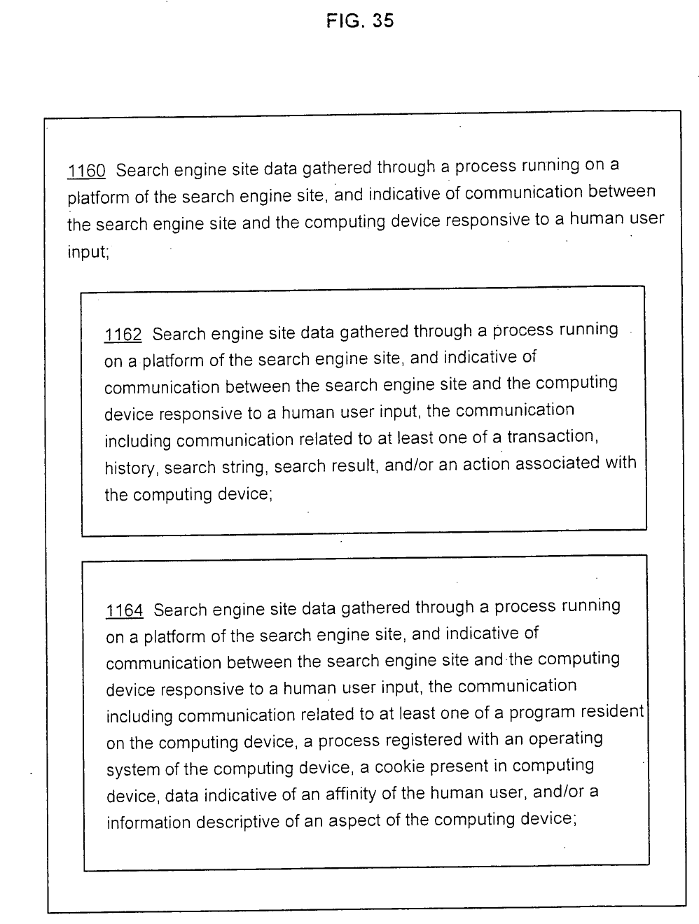

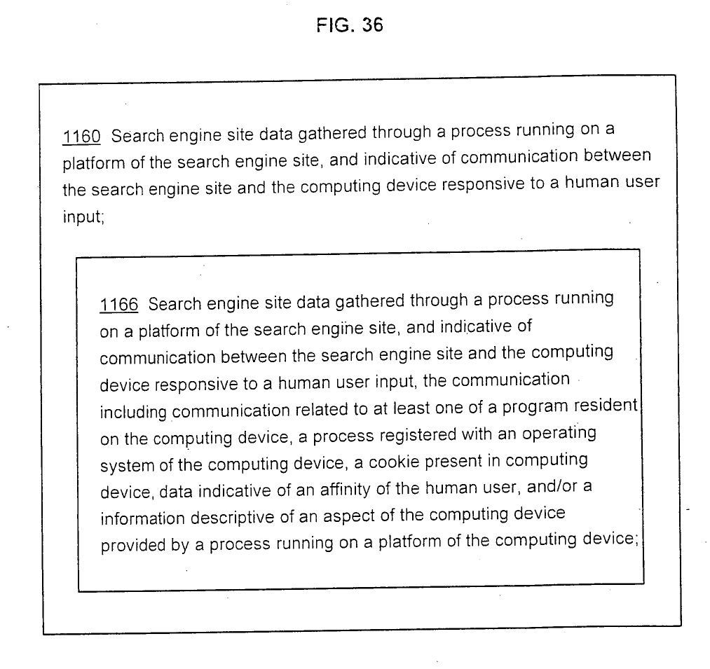

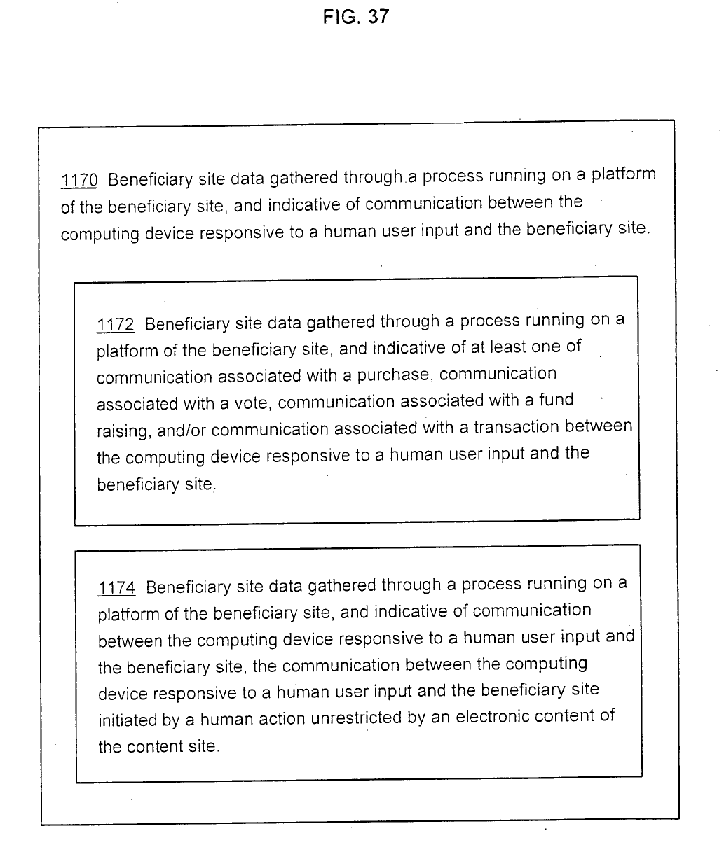

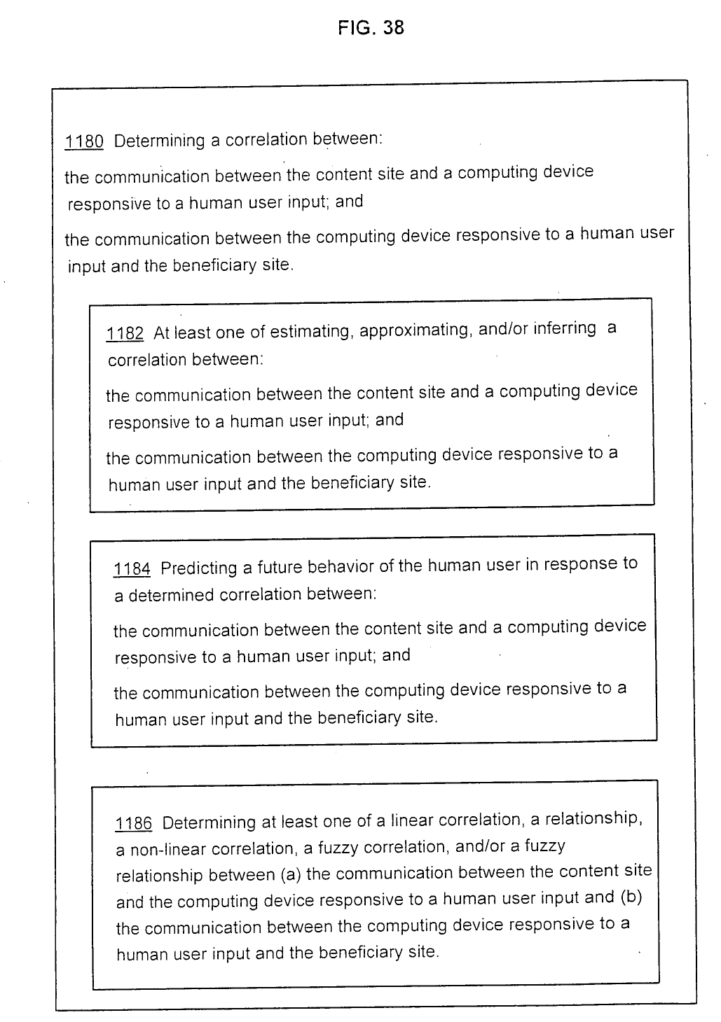

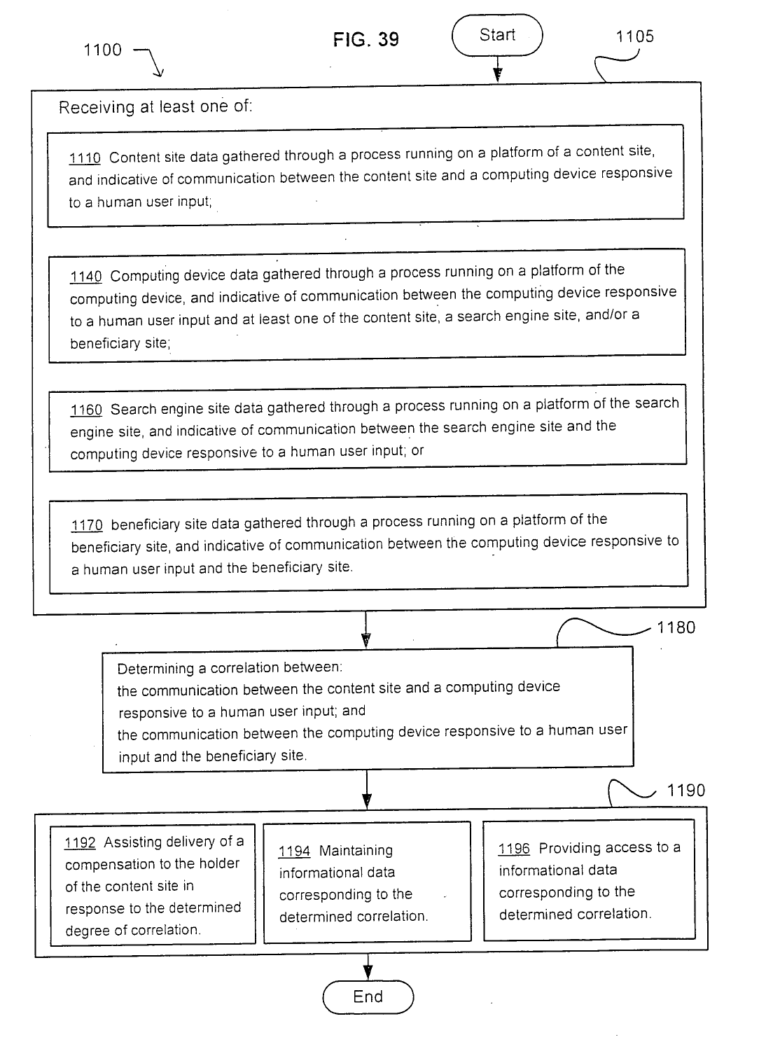

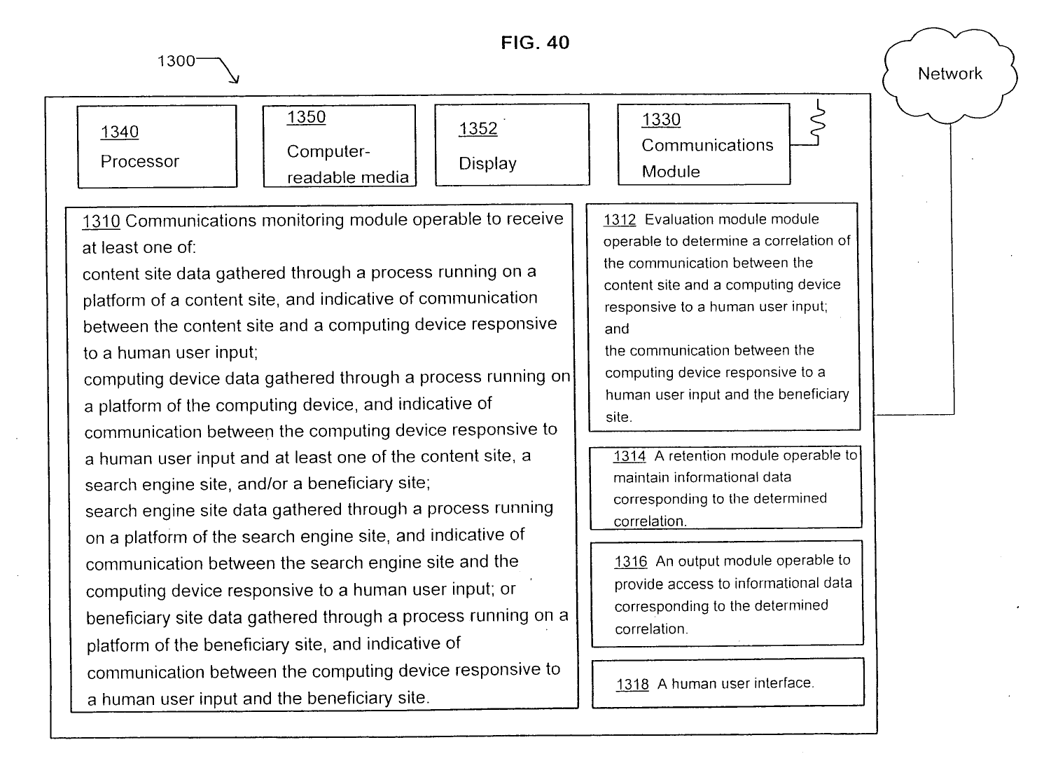

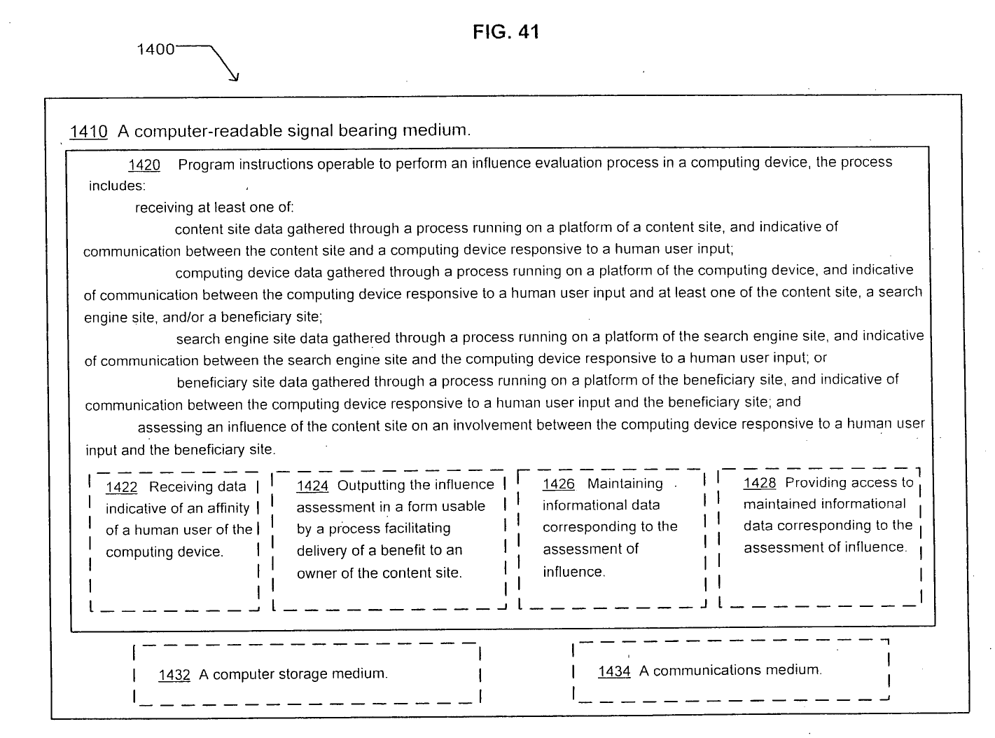

FIG. 20 illustrates an embodiment of the exemplary operational flow; 500 of FIG. 5. The kinship operation 590 may include at least one additional operation. The at least one additional operation may include an operation 592 and/or an operation 594. The operation 599 receives data indicative of at least one of an express, and/or an inferred affinity of the person. The operation 594 receives data indicative of at least one of an affinity characteristic, and/or an affiliation of the person, such as the person's age category (young, middle age, senior), and/or the person's income (low income, median income, high income).

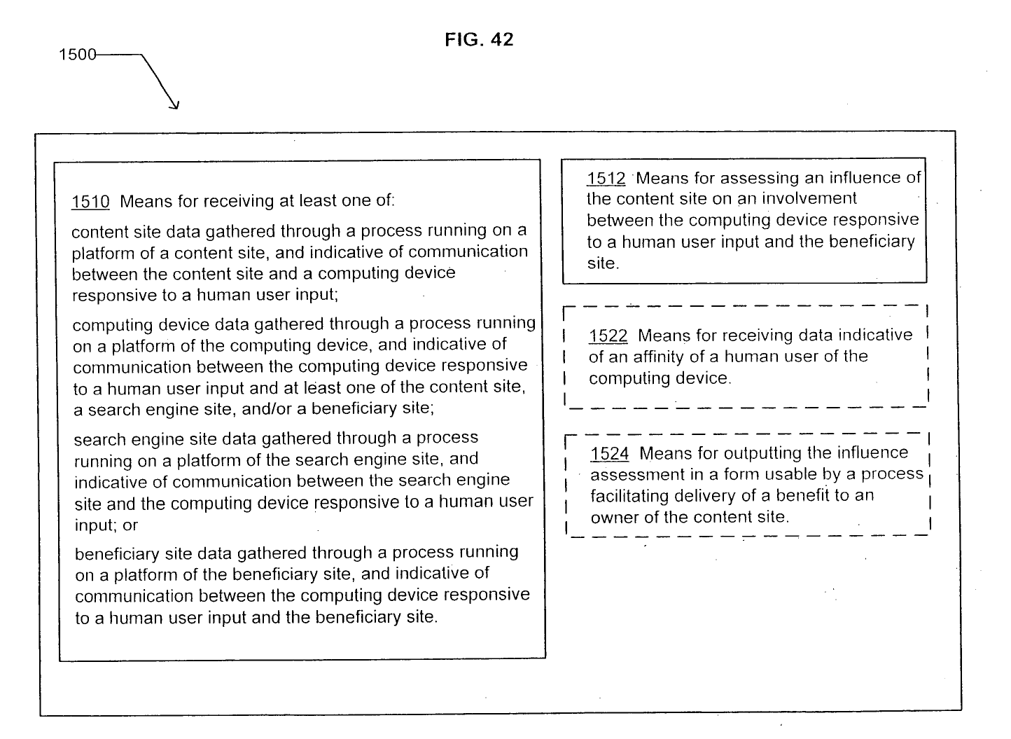

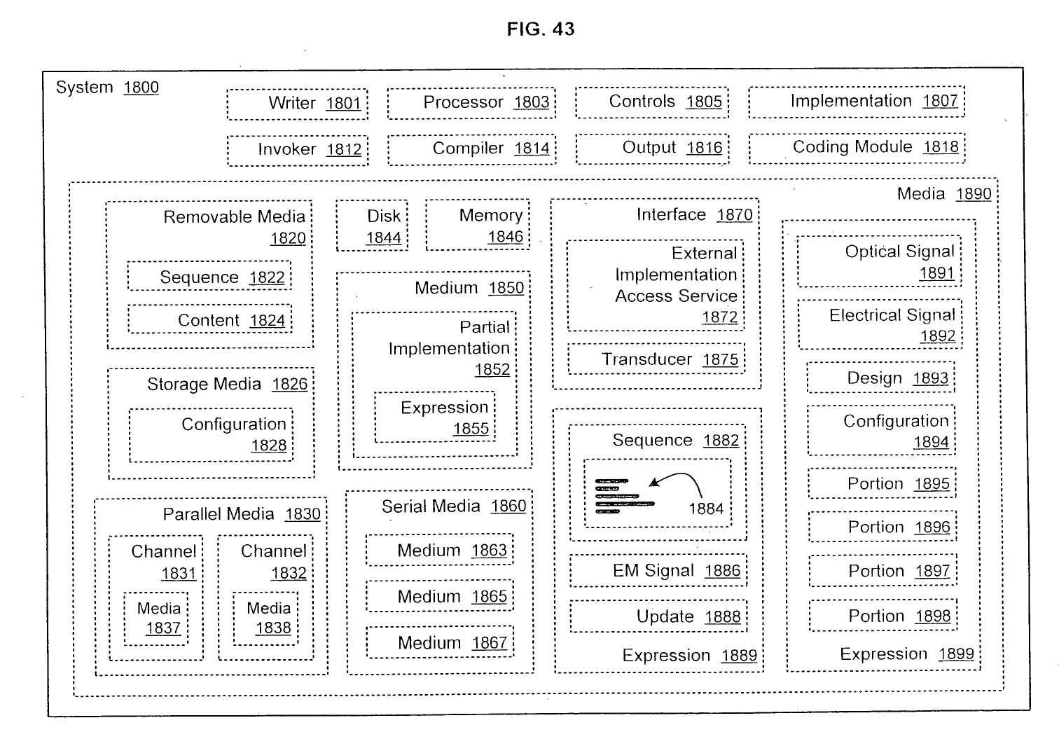

FIG. 21 illustrates another embodiment of the exemplary operational flow 500 of FIG. 5. The kinship operation 590 may include at least one additional operation, such as the operation 595. The operation 595 facilitates delivery of a benefit to an owner of the first-electronic content or an owner of the second electronic content in response to an assessed influence bad the first-electronic-content portion and/or the second-electronic-content portion on the involvement between the person and the third-party. The assessed influence is responsive to the received data indicative of a person accessing at least one of a first network-available electronic content having a first-electronic-content portion or a second network-available electronic content having a second-electronic-content portion. The assessed influence is also responsive to the received data indicative of an affinity of the person.

FIG. 22 illustrates a further embodiment of the exemplary operational flow 500 of FIG. 5. The operational flow 500 may include may include at least one additional operation 596. The at least one additional operation 596 may include an operation 597 and/or an operation 598. The operation 597 maintains informational data corresponding to the assessed influence. The operation 598 provides access to informational data corresponding to the assessed influence.

FIG. 23 illustrates an exemplary computer program product 700. The program product includes a computer-readable signal-bearing medium 710 bearing program instructions 720 operable to perform an influence evaluation process in a computing device. The process includes receiving data indicative of a person accessing at least one of a first network-available electronic content having a first-electronic-content portion or a second network-available electronic content having a second-electronic-content portion. The process also includes receiving data indicative of an involvement between the person and the third-party, and assessing an influence by the first-electronic-content portion and/or the second-electronic-content portion on the involvement between the person and the third-party.

In an alternative embodiment, the process of the program instructions 720 further includes receiving data indicative of an affinity of the person 722. In another embodiment, the process of the program instructions further includes outputting the assessed influence in a form usable by a process facilitating delivery of a benefit to an owner of the first electronic content or an owner of the second electronic content 724. In a further embodiment, the process of the program instructions further includes maintaining informational data corresponding to the assessed influence 726. In another embodiment, the process of the program instructions further includes providing access to maintained informational data corresponding to the assessed influence 728.

In another embodiment, the computer-readable signal-bearing medium includes computer storage medium 732. In a further embodiment, the computer-readable signal-bearing medium includes communication medium 734.

FIG. 24 illustrates an exemplary system 800. The system includes a computing device 801 operable to communicate with a network (not shown). In an embodiment, the computing device may, include the computing device 20 described in conjunction with FIG. 1, and/or the computing device 110 described in conjunction with FIG. 2. Communication big the computing device may a network may be implemented using a communications module 830. The communications module may include a wired, wireless, and/or optical communication capability. The computing device also includes an activity monitoring module 810, an interaction monitoring module 812, and an evaluation module 814. The activity monitoring module is operable to receive data indicative of a person accessing at least one of a first network-available electronic content or a second network-available electronic content. The interaction monitoring module is operable to receive data indicative of an involvement between the person and the third-party. The evaluation module is operable to assess an influence by the first-electronic-content and/or the second-electronic-content on the involvement between the person and the third-party.

In another embodiment, the computing device 801 includes a processor 840, a storage media 850, and/or a display 852. In a further embodiment, the computing device further includes a retention module 816 operable to maintain informational data corresponding to the assessed influence. In another embodiment, the computing device further includes an output module 818 operable to provide access to informational data corresponding to the assessed influence.

In an embodiment the computing device 801 operable to communicate with a network further includes a computing device responsive to human input, and operable to display human perceivable content and communicate with a network. In another embodiment, the computing device operable to communicate with a network includes a computing device operable to provide electronic content to a network. In a further embodiment, the computing device operable to communicate with a network further includes an intermediate computing device operable to communicate with a network.

In an embodiment, the activity monitoring module 810 further includes an activity monitoring module 811 operable to receive a first data indicative of a first person accessing at least one of a first network-available electronic content or a second network-available electronic content. The activity monitoring module is further operable to receive a second data indicative of a second person accessing at least one of the first network-available electronic content or the second network-available electronic content. In another embodiment, the interaction monitoring module 812 further includes an interaction monitoring module (not shown) operable to operable to receive data indicative of an involvement between the first person and the third-party and/or the second person and the third part). In another embodiment, the evaluation module 814 further includes an evaluation module (not shown) operable to assess an influence by the first-electronic-content and/or the second-electronic-content on the involvement between the first person and the third-party, and/or on the involvement between the second person and the third-party.

In an embodiment, the computing device 801 operable to communicate with a network further includes a network intermediary device operable to communicate with a network. In another embodiment, the computing device operable to communicate with a network further includes a computing device under a control of the third-party and operable to communicate with a network.

FIG. 25 illustrates a device 900. The device includes means 910 for receiving data indicative of a person accessing at least one of a first network-available electronic content having a first-electronic-content portion or a second network-available electronic content having a second-electronic-content portion. The device also includes means 914 for receiving data indicative of an involvement between the person and the third-party. The device further includes means 918 for facilitating delivery of a benefit to an owner of the first-electronic content or an owner of the second electronic content in response to an assessed influence by the first-electronic-content portion and/or the second-electronic-content portion on the involvement between the person and the third-party.

In an embodiment, the device 900 further includes means 922 for receiving data indicative of an affinity of the person. In another embodiment, the device further includes means 924 for saving informational data corresponding to the assessed influence. In a further embodiment, the device includes means 926 for providing access to informational data corresponding to the assessed influence.

FIG. 26 illustrates an example of a system that may serve as a context for introducing one or more processes, systems or other articles. Primary system 1000 may include one or more instances of outputs 1020, 1030 or implementations 1060, 1070 that may be held or transmitted by interfaces 1040, conduits 1090, storage devices 1091, memories 1092, holding devices 1094, or the like. In various embodiments as described herein, for example, one or more instances of implementation output data 1021, 1022, 1023, 1024, 1025, 1026, 1027, 1028, 1029 or implementation components 1071, 1072, 1073, 1074, 1075, 1076, 1077, 1078, 1079 may each be expressed in an), aspect or combination of software, firmware, or hardware as signals, data, designs, functional expressions, instructions, or the like. The interface(s) 1040 may include one or more instances of input devices 1043, output devices 1045, integrated circuits 1048, lenses 1049, transmitters 1052, reflectors 1057, antennas 1058, receivers 1059, or the like for handling data or communicating with local users or with network 1080 via linkage 1005, for example. Several variants of primary system 1000 are described below with reference to one or more instances of repeaters 1081, communication satellites 1083, servers 1084, processors 1085, routers 1087, or other elements of network 1080.

Those skilled in the art will recognize that some list items may also function as other list items. In the above-listed types of media, for example, some instances of interface(s) 1040 may include conduits 1090, or may also function as storage devices that are also holding devices 1094. Transmitters 1052 may likewise include input devices or bidirectional user interfaces, in many implementations of interface(s) 1040. Each such listed term should not be narrowed by any implication from other terms in the same list but should instead be understood in its broadest reasonable interpretation as understood by those skilled in the art.

Several variants described herein refer to device-detectable “implementation” such as one or more instances of computer-readable code, transistor or latch connectivity layouts or other geometric expressions of logical elements, firmware or software expressions of transfer functions implementing computational specifications, digital expressions of truth tables, or the like. Such instances can, in some implementations, include source code or other human-readable portions. Alternatively or additionally, functions of implementations described herein may constitute one or more device-detectable “implementation outputs” such as decisions, manifestations, side effects, results, coding or other expressions, displayable images, data files, data associations, statistical correlations, streaming signals, intensity levels, frequencies or other measurable attributes, packets or other encoded expressions, or the like from invoking or monitoring the implementation as described herein.

FIG. 27 illustrates an exemplary operational flow 1100. After a start operation, the operational flow, moves to data gathering operation 1105. In an embodiment, the data gathering operation includes an operational flow that receives data from at least one of a content site data operation 1110, a computing device data operation 1140, a search engine site data operation 1160, or a beneficiary site data operation 1170. The receiving content site data operation includes receiving content site data gathered through a process running on a platform of a content site, and indicative of communication between the content site and a computing device responsive to a human user input. The computing device data operation includes receiving computing device data gathered through a process running on a platform of the computing device, and indicative of communication between the computing device responsive to a human user input and at least one of the content site, a search engine site, and/or a beneficiary site. In an embodiment, the beneficiary site and the content site are independent of each other. The search engine site data operation includes receiving search engine site data gathered through a process running on a platform of the search engine site, and indicative of communication between the search engine site and the computing device responsive to a human user input. The beneficiary site data operation includes receiving beneficiary site data gathered through a process running on a platform of the beneficiary site, and indicative of communication between the computing device responsive to a human user input and the beneficiary site.

In an embodiment, the data gathering operation 1105 described above includes receiving a least one class of data. This text describes the data gathering operation by using the word “or” in accord with a convention analogous to when “at least one of A, B, or C, etc.” is used. In general, such a convention is intended in the sense one having skill in the art would understand the convention—(e.g., “an operational flow, receiving at least one of A, B, or C” would include but not be limited to an operational flow receiving A alone; receiving B alone; receiving C alone; receiving both A and B; receiving both A and C; receiving both B and C; receiving A, B, and C; and so on). For example, in another embodiment, the data gathering operation receives a single instance of content site data. In a further embodiment, the data gathering operation receives content site data and beneficiary site data. In another operation, the data gathering operation receives two instances of computing device data and one instance of search engine site data.

The operational flow 1100 includes an influence evaluation operation 1180. The influence evaluation operation determines a con-elation between (a) the communication between the content site and a computing device responsive to a human user input and (b) the communication between the computing device responsive to a human user input and the beneficiary site. The operational flow, then moves to an end operation.

In an embodiment, the exemplary operational flow 1100 may be performed at a computing device. In another embodiment, FIG. 4 may be used to illustrate an environment in which the exemplary operational flows may be implemented. For example, the exemplar), operational flow may be performed by at least one of the client machine 310, a content site illustrated as the content server 320, a beneficiary site illustrated as the third-party site 330, the search engine site 350, the influence determinator machine 360, the intermediary machine 370, and/or the page tag information processor 380 of FIG. 4. In yet another embodiment, at least a portion of the data may be outputted by a platform and/or an application running on the platform of the device performing the operational flow 1100. In a further embodiment, the operational flow may be performed by the content server using data outputted by the client machine and outputted by an application running on a platform of the content server. In another embodiment, the operational flow may be performed bad the content server using data from both the client machine and the third-party site. In a further embodiment, the operational flow may be performed by the influence determinator machine using data outputted by at least one of the client machine, the content server, the search engine site, and/or the third-party site. In another embodiment, the operational flow may be performed bad the search engine platform using data outputted by at least one of the client machine, the content server, and/or the third-party site. In an embodiment, an instance of data may be receipted directly or indirectly from a machine that gathered it. For example, if the operational flow is being performed at the influence determinator machine, the computing device data 1110 may be received by the content server, which then provides the computing device data to the influence determinator machine.

In an embodiment of the operational flow 1100, the platform of the content site and the platform of the computing device include an at least substantially common platform. For example, a platform may include an operating system architecture, such as Microsoft Windows, UNIX, LINUX, Solaris, and/or Mac OS X. By way further example, a platform may include an application and/or a family of applications. A family of applications may include Word, Excel, Outlook, Internet Explorer, Live Search, and/or Visio. Another family of applications may include the Google search engine, Gmail, Google Calendar, and/or Google Docs & Spreadsheets. A further family of applications may include a general family of applications, and/or a specialized family of applications. In another example, a platform may include a hardware platform. In a further example, a hardware platform may include a gaming platform and/or a particular chip architecture. In another example, a hardware platform may include a platform of combination of a switch, a router, and/or a sniffer.

In another embodiment of the operational flow 1100, the platform of the content site and the platform of the computing device include an at least substantially common platform. In a further embodiment, the platform of the content site and the platform of the computing device include an at least substantially common platform family.

In an embodiment of the operational flow 1100, the platform of the content site and the platform of the search engine site include an at least substantially common platform. In another embodiment, the platform of the content site and the platform of the search engine site include an at least substantially common platform family. In a further embodiment, the platform of the content site and the platform of the beneficiary site include an at least substantially common platform. In another embodiment, the platform of the content site and the platform of the beneficiary site include an at least substantially common platform family. In a further embodiment, the platform of the computing device and the platform of the search engine site include an at least substantially common platform. In another embodiment, the platform of the computing device and the platform of the search engine site include an at least substantially common platform family. In a further embodiment, the platform of the computing device and the platform of the beneficiary site include an at least substantially common platform.

In an embodiment of the operational flow 1100, the platform of the computing device and the platform of the beneficiary site include an at least substantially common platform family. In another embodiment, the platform of the search engine site and the platform of the beneficiary site include an at least substantially common platform. In a further embodiment, the platform of the search engine site and the platform of the beneficiary site include an at least substantially common platform family. In another embodiment, the process running on a platform of the content site and the process running on a platform of the computing device include an at least substantially common process. In a further embodiment, the process running on a platform of the content site and the process running on a platform of the computing device include at least substantially coordinating processes. In another embodiment, the process running on a platform of the content site and the process running on a platform of the search engine site include an at least substantially common process. In a further embodiment, the process running on a platform of the content site and the process running on a platform of the search engine site include at least substantially coordinating processes. In another embodiment, the process running on a platform of the content site and the process running on a platform of the beneficiary site include an at least substantially common process.

In an embodiment of the operational floral 1100, the process running on a platform of the content site and the process running on a platform of the beneficiary site include at least substantially coordinating processes. In another embodiment, the process running on a platform of the computing device and the process running on a platform of the search engine site include an at least substantially common process. In a further embodiment, the process running on a platform of the computing device and the process running on a platform of the search engine site include at least substantially coordinating processes. In another embodiment, the process running on a platform of the computing device and the process running on a platform of the beneficiary site include an at least substantially common process. In a further embodiment, the process running on a platform of the computing device and the process running on a platform of the beneficiary site include at least substantially coordinating processes.

In an embodiment of the operational flow 1100, the process running on a platform of the search engine site and the process running on a platform of the beneficiary site include an at least substantially common process. In another embodiment, the process running on a platform of the search engine site and the process running on a platform of the beneficiary site include at least substantially coordinating processes.

Referring now also to the context of FIG. 26, in some embodiments, flow 1100 may be performed by one or more instances of server 1084 remote from primary system 1000 but operable to cause output device(s) 1045 to receive and present results via linkage 1005. Alternatively or additionally, any included instances of device-detectable data 1021-1025 may be borne by one or more conduits 1090, holding devices 1094, integrated circuits 1048, or the like as described herein. Such data may optionally be configured for transmission by a semiconductor chip or other embodiment of integrated circuit 1048 that contains or is otherwise operatively coupled with one or more antennas 1058 (in a radio-frequency identification tag, for example).

In some variants, flow 1100 may be implemented entirely within primary system 1000, optionally as a stand-alone system. Operation 1105 may be implemented by configuring component 1071 as logic for receiving content site data gathered through a process running on a platform of a content site, and indicative of communication between the content site and a computing device responsive to a human user input, for example, such as by including special-purpose instruction sequences or special-purpose-circuit designs for this function. Output data 1021 from such a component in primary system 1000 or network 1080 malt be recorded by configuring available portions of storage device(s) 1091. Alternatively or additionally, such specific output data may be transmitted by configuring transistors, relays, or other conduits 1090 of primary system 1000 to transfer it to component 1075, for example.

Alternatively or additionally, one or more instances of component 1072 may perform operation 1105 via implementation as logic for receiving computing device data gathered through a process running on a platform of the computing device, and indicative of communication between the computing device responsive to a human user input and at least one of the content site, a search engine site, and/or a beneficiary site, for example. Implementation output data 1022 from such a component in primary system 1000 or network 1080 may be sent in some form to component 1075, for example.

Alternatively or additionally, one or more instances of component 1073 may perform operation 1105 via implementation as logic for receiving beneficiary site data gathered through a process running on a platform of the beneficiary site, and indicative of communication between the computing device responsive to a human user input and the beneficiary site, for example. Implementation output data 1023 from such a component in primary system 1000 or network 1080 may be routed to component 1075, for example.

Alternatively or additionally, one or more instances of component 1074 may perform operation 1105 via implementation as logic for receiving search engine site data gathered through a process running on a platform of the search engine site, and indicative of communication between the search engine site and the computing device responsive to a human user input, for example. Implementation output data 1024 from such a component in primary system 1000 or network 1080 may be routed (directly or indirectly) to component 1075, for example.

At some time after such data is received as described above to one or more of whichever components 1071-1074 may have been included in implementation 1060, one or more instances of component 1075 may act upon it. In some variants, one or more of optional components 1071-1074 may be omitted or ignored, for example, even in a context in which an included one or more of components 1071-1074 can respectively detect one or more of items 1110, 1140, 1160, 1170. Component 1075 may respond by performing operation 1180, for example, if configured as logic for determining a correlation between (a) the communication between the content site and the computing device responsive to a human user input; and (b) the communication between the computing device responsive to a human user input and the beneficiary site. Output 1020 from flow 1100 may (optionally) include other implementation output data 1021-1025 as described herein. Such output 1020 may, for example, be processed as described herein, recorded into available portions of storage device(s) 1091, or routed (directly or indirectly) through linkage 1005. Each portion of implementation 1060 may likewise include one or more instances of software, hardware, or the like implementing logic that may be expressed in several respective forms as described herein or otherwise understood by those skilled in the art.

Referring again now, to FIG. 5, also in reference to the context of FIG. 26, some instance of flow, 500 may likewise be implemented entirely within primary system 1000 in some variants. Operation 510 may be implemented by configuring component 1076 as logic for receiving data indicative of a person accessing at least one of a first network-available electronic content having a first-electronic-content portion or a second network-available electronic content hating a second-electronic-content portion, for example, such as by including special-purpose instruction sequences or special-purpose-circuit designs for this function. Output data 1026 from such a component in primary system 1000 or network 1080 may be recorded into available portions of storage device(s) 1091 or sent to component 1078, for example. Component 1077 may perform operation 540 via implementation as logic for receiving data indicative of an involvement between the person and a third-party, for example. Implementation output data 1027 from such a component in primary system 1000 or network 1080 may be recorded into available portions of storage device(s) 1091 or sent to component 1078, for example. Component 1077 maid perform operation 560 via implementation as logic for facilitating delivery of a benefit to an owner of the first-electronic content or an owner of the second electronic content in response to an assessed influence by the first-electronic-content portion and/or the second-electronic-content portion on the involvement between the person and the third-party. Output 1030 from flow 500 may likewise include other data 1028, 1029 as described herein. Each portion of implementation 1060 may likewise include one or more instances of software, circuitry, or the like implementing logic that may be expressed in several respective forms as described herein or otherwise understood by those skilled in the art.

In some embodiments, output device 1045 malt indicate an occurrence of flow 1100 concisely as a decision, an evaluation, an effect, an hypothesis, a probability, a notification, or some other useful technical result. For example, such “indicating” may comprise such modes as showing, signifying, acknowledging, updating, explaining, associating, or the like in relation to any past or ongoing performance of such actions upon the common item(s) as recited. Such indicating may also indicate one or more specifics about the occurrence: the parties or device(s) involved, a description of the method or performance modes used, any sequencing or other temporal aspects involved, indications of resources used, location(s) of the occurrence, implementation version indications or other update-indicative information, or any other such contextual information that may be worthwhile to provide at potential output destinations.

Concise indication may occur, for example, in a context in which at least some items of data 1021-1029 are unavailable or unimportant, or in which a recipient may understand or access portions of data 1020-1029 without receiving a preemptive explanation of how it was obtained. By distilling output 1020 at an “upstream” stage (which may comprise integrated circuit 1048, for example, in some arrangements), downstream-stage media (such as other elements of network 1080, for example) may indicate occurrences of various methods described herein more effectively. Variants of flow 1100, for example, may be enhanced by distillations described herein, especially in bandwidth-limited transmissions, security-encoded messages, long-distance transmissions, complex images, or compositions of matter bearing other such expressions.

In some variants, a local implementation comprises a service operable for accessing a remote system running a remote implementation. In some embodiments, such “accessing” may include one or more instances of establishing or permitting an interaction between the server and a local embodiment such that the local embodiment causes or uses another implementation or output of one or more herein-described functions at the server. Functioning as a web browser, remote terminal session, or other remote activation or control device, for example, interface(s) 1040 may interact with one or more primary system users via input and output devices 1043, 1045 so as to manifest an implementation in primary system 1000 via an interaction with server 1084, for example, running a secondary implementation of flow 1100. Such local implementations may comprise a visual display supporting a local internet service to the remote server, for example. Such a remote server may control or otherwise enable one or more instances of hardware or software operating the secondary implementation outside a system, network, or physical proximity of primary system 1000. For a building implementing primary system 1000, for example, “remote” devices may include those in other countries, in orbit, or in adjacent buildings. In some embodiments, “running an implementation” may include invoking one or more instances of software, hardware, firmware, or the like atypically constituted or adapted to facilitate methods or functions as described herein. For example, primary system 1000 running an implementation of flow 1100 may be a remote activation of a special-purpose computer program resident on server 1084 via an internet browser session interaction though linkage 1005, mediated by input device 1043 and output device 1045.

In some variants some or all of components 1071-1079 may be borne in various data-handling elements—e.g., in one or more instances of storable devices 1091 in memories 1092 or volatile media, passing, through linkage 1005 with network 1080 or other conduits 1090 in one or more registers or data-holding devices 1094, or the like. For example, such processing or configuration may occur in response to user data or the like received at input device 1043 or may be presented at output device 1045. Instances of input devices 1043 may (optionally) include one or more instances of cameras or other optical devices, hand-held systems or other portable systems, keypads, sensors, or the like as described herein. Output device(s) 1045 may likewise include one or more instances of image projection modules, touch screens, wrist-wearable systems or the like adapted to be worn while in use, headphones and speakers, eyewear, liquid crystal displays (LCDs), actuators, lasers, organic or other light-emitting diodes, phosphorescent elements, portions of (hybrid) input devices 1043, or the like.

A device-detectable implementation of variants described herein with reference to floor 1100, for example, may be divided into several components 1071-1079 carried by one or more instances of active modules such as signal repeaters 1081, communication satellites 1083, servers 1084, processors 1085, routers 1087, or the like. For example, in some embodiments, component 1072 may be borne by an “upstream” module (e.g., repeater 1081 or the like) while or after component 1071 is borne in a “downstream” module (e.g., another instance of repeater 1081, communication satellite 1083, server 1084, or the like). Such downstream modules may “accept” such bits or other portions of implementation 1060 or implementation 1070 sequentially, for example, such as by amplifying, relaying, storing, checking, or otherwise processing what was received actively. Sensors and other “upstream” modules may likewise “accept” raw data, such as by measuring physical phenomena or accessing one or more databases.

In some embodiments, a medium bearing data (or other such event) may be “caused” (directly or indirectly) by one or more instances of prior or contemporaneous measurements, decisions, transitions, circumstances, or other causal determinants. Any such event may likewise depend upon one or more other prior, contemporaneous, or potential determinants, in various implementations as taught herein. In other words, such events may occur “in response” to both preparatory (earlier) events and triggering (contemporaneous) events in some contexts. Output 1020 may result from more than one component of implementations 1060, 1070 or more than one operation of flow 1100, for example.

In some embodiments, such integrated circuits 1048 may comprise transistors, capacitors, amplifiers, latches, converters, or the like on a common substrate of a semiconductor material, operable to perform computational tasks or other transformations. An integrated circuit may be application-specific (“ASIC”) in that it is designed for a particular use rather than for general purpose use. An integrated circuit may likewise include one or more instances of memory circuits, processors, field-programmable gate assays (FPGA's), antennas, or other components, and may be referred to as a system-on-a-chip (“SoC”).

In some embodiments, one or more instances of integrated circuits or other processors may be configured to perform auditory pattern recognition. In FIG. 26, for example, instances of the one or more input devices 1043 may include a microphone or the like operable to provide auditory samples in data 1021-1029. Some form or portion of such output may be provided remotely, for example, to one or more instances of neural networks or other configurations of remote processors 1085 operable to perform automatic or supervised speech recognition, selective auditory data retention or transmission, or other auditory pattern recognition, upon the samples. Alternatively or additionally such sound-related data may include annotative information relating thereto such as a capture time or other temporal indications, capture location or other source information, language or other content indications, decibels or other measured quantities, pointers to related data items or other associative indications, or other data aggregations or distillations as described herein.

In some embodiments, one or more instances of integrated circuits or other processors may be configured for optical image pattern recognition. In FIG. 26, for example, instances of lenses 1049 or other input devices 1043 may include optical sensors or the like operable to provide one or more of geometric, hue, or optical intensity information in data 1021-1029. Some form or portion of such output may be provided locally, for example, to one or more instances of optical character recognition software, pattern recognition processing resources, or other configurations of integrated circuits 1048 operable to perform automatic or supervised image recognition, selective optical data retention or transmission, or the like. Alternatively or additionally such image-related data may include annotative information relating thereto such as a capture time or other temporal indications, capture location or other source information, language or other content indications, pointers to related data items or other associative indications, or other data aggregations or, distillations as described herein.

In some embodiments, one or more instances of integrated circuits or other processors may be configured to perform linguistic pattern recognition. In FIG. 43, for example, instances of input devices 1043 may include keys, pointing devices, microphones, sensors, reference data, or the like operable to provide spoken, written, or other symbolic expressions in data 1021-1029. Some form or portion of such output may be provided locally, for example, to one or more instances of translation utilities, compilers, or other configurations of integrated circuits 1048 operable to perform automatic or supervised programming or other language recognition, selective linguistic data retention or transmission, or the like. Alternatively or additionally such language-related data may include annotative information relating thereto such as a capture time or other temporal indications, capture location or other source information, language or other content indications, pointers to related data items or other associative indications, or other data classifications, aggregations, or distillations as described herein.

In some embodiments, antennas 1058 or receivers 1059 may include a device that is the receiving end of a communication channel as described herein. For example, such a receiver may gather a signal from a dedicated conduit or from the environment for subsequent processing and/or retransmission. As a further example, such antennas or other receivers may include one or more instances of wireless antennas, radio antennas, satellite antennas, broadband receivers, digital subscriber line (DSL) receivers, modem receivers, transceivers, or configurations of two or more such devices for data reception as described herein or otherwise known.

In one variant, two or more respective portions of output data 1021-1029 may be sent from server 1084 through respective channels at various times, one portion passing through repeater 1081 and another through router 1087. Such channels may each bear a respective portion of a data aggregation or extraction, a publication, a comparative analysis or decision, a record selection, digital subscriber content, statistics or other research information, a resource status or potential allocation, an evaluation, an opportunity indication, a test or computational result, or another output 1020, 1030 of interest. Such distributed media may be implemented as an expedient or efficient mode of bearing such portions of output data to a common destination such as interface 1040 or holding device 1094. Alternatively or additionally some such data may be transported by moving a medium (carried on storage device 1091, for example) so that only a small portion (a purchase or other access authorization, for example, or a contingent or supplemental module) is transferred via linkage 1005.

In some embodiments, one or more instances of signal repeaters 1081 may include a device or functional implementation that receives a signal and transmits some or all of the signal with one or more of an altered strength or frequency, or with other modulation (e.g., an optical-electrical-optical amplification device, a radio signal amplifier or format converter, a wireless signal amplifier, or the like). A repeater may convert analog to digital signals or digital to analog signals, for example, or perform no conversion. Alternatively or additionally, a repeater may reshape, retime or otherwise reorder an output for transmission. A repeater may likewise introduce a frequency offset to an output signal such that the received and transmitted frequencies are different. A repeater also may include one or more instances of a relay, a translator, a transponder, a transceiver, an active hub, a booster, a noise-attenuating filter, or the like.

In some embodiments, such communication satellite(s) 1083 mast be configured to facilitate telecommunications while in a geosynchronous orbit, a Molniya orbit, a low earth orbit, or the like. Alternatively or additionally, a communication satellite mats receive or transmit, for example, telephony signals, television signals, radio signals, broadband telecommunications signals, or the like.

In some variants, processor 1085 or any components 1071-1079 of implementations 1060, 1070 may (optionally) be configured to perform flow variants as described herein with reference to any of FIGS. 6-22. An occurrence of such a variant can be expressed as a computation, a transition, or as any other items of data 1021-1029 described herein, for example. Such output 1020, 1030 can be generated, for example, by depicted components of primary system 1000 or network 1080 including one or more features as described with reference to any of FIG. 1-4, 23, 24, or 41.

FIG. 28 illustrates an alternative embodiment of the exemplary operational flows 1100 of FIG. 27. The receiving content site data operation 1110 may include at least one additional operation. The at least one additional operation may include an operation 1112, an operation 1114, an operation 1116, and/or an operation 1118. At the operation 1112, the receiving content site data operation includes receiving content site data gathered through a process running on a platform of a content site. The content site data is indicative of communication between the content site and a computing device responsive to a human user input. The process includes a process that is at least one of bundled with, integrated into, and/or registered with the platform of the content site. At the operation 1114, the receiving content site data operation includes receiving content site data gathered through a process running on a platform of a content site. The content site data is indicative of communication between the content site and the computing device responsive to a human user input. At the operation 1116, the receiving content site data operation includes receiving content site data gathered through a process running on a platform of a content site. The content site data is indicative of communication between the content site and a computing device responsive to a human user input. The content site is operable to provide content deliverable to the person. The deliverable content including at least one of a: document; review; critique, comment; rating; aggregations of reviews, comments, and/or critiques; consumer-generated-media; blog; newsgroup; message board; and/or discussion forum. At the operation 1118, the receiving content site data operation includes receiving content site data gathered through a process running on a platform of a content site. The content data is indicative of communication between the content site and a computing device responsive to a human user input, and related to digital work deliverable to the person.

FIG. 29 illustrates another alternative embodiment of the exemplary operational flow 1100 of FIG. 27. The receiving content site data operation 1110 may include at least one additional operation. The at least one additional operation may include an operation 1122, an operation 1124, and/or an operation 1126. At the operation 1122, the receiving content site data operation includes receiving content site data gathered through a process running on a platform of a content site. The content site data is indicative of communication between the content site and a computing device responsive to a human user input, and related to at least one of a publicly available electronic content, a limited publicly available electronic content, and/or a privately available electronic content that is deliverable to the person. At the operation 1124, the receiving content site data operation includes receiving content site data gathered through a process running on a platform of a content site. The content site data is indicative of communication between the content site and a computing device responsive to a human user input, and related to an electronic content deliverable to the person that includes at least one of an electronic document, an electronic world an electronically-stored information, a Web document an email, and/or an instant message. In another embodiment, the Web document includes a Web site content, a Web page, a Weblog, and/or a blog. At the operation 1126, the receiving content site data operation includes receiving content site data gathered through a process running on a platform of a content site. The content site data indicative of communication between the content site and a computing device responsive to a human user input, and related to an electronic content deliverable to the person that includes at least one of a human perceivable content, a textual content, a visual content, an audio content, and/or a graphical content.

FIG. 30 illustrates a further alternative embodiment of the exemplary operational flow 1100 of FIG. 27. The receiving content site data operation 1110 may include at least one additional operation. The at least one additional operation may include an operation 1128, and/or an operation 1132. At the operation 1128, the receiving content site data operation includes receiving content site data gathered through a process running on a platform of a content site. The content site data indicative of communication between the content site and a computing device responsive to a human user input. The content site data is related to at least one of a transaction, history, search string, search result, and/or computing-device action associated with the computing device responsive to a human user input. At the operation 1132, the receiving content site data operation includes receiving content site data gathered through a process running on a platform of a content site, indicative of communication between the content site and a computing device responsive to a human user input. The content site data is further indicative of at least one of a program resident on the computing device, a process registered with an operating system of the computing device, a cookie present in computing device, data indicative of an affinity of the human user, and/or an information descriptive of an aspect of the computing device.

FIG. 31 illustrates a further alternative embodiment of the exemplary operational flow 1100 of FIG. 27. The receiving computing device data operation 1140 may include at least one additional operation. The at least one additional operation may include an operation 1142, and/or an operation 1144. At the operation 1142, the receiving computing device data operation includes receiving computing device data gathered through a process running on a platform of the computing device. The computing device data indicative of communication between the computing device responsive to a human user input and at least one of the content site, a search engine site, and/or a beneficiary site. The computing device data further indicative of at least one of a program resident on the computing device, a process registered with an operating system of the computing device, a cookie present in computing device, data indicative of an affinity of the human user, and/or an information descriptive of an aspect of the computing device. At the operation 1144, the receipting computing device data operation includes receiving computing device data gathered though a process running on a platform of the computing device. The computing device data indicative of communication between the computing device responsive to a human user input and at least one of the content site, a search engine site, and/or a beneficiary site. The computing device data further indicative of at least one of a program resident on the computing device, a process registered with an operating system of the computing device, a cookie present in computing device, data indicative of an affinity of the human user, and/or an information descriptive of an aspect of the computing device as provided by a process running on a platform of the computing device.

FIG. 32 illustrates an alternative embodiment of the exemplary operational flow 1100 of FIG. 27. The receiving computing device data operation 1140 may include at least one additional operation. The at least one additional operation may include an operation 1146, and/or an operation 1148. At the operation 1146, the receiving computing device data operation includes receiving computing device data gathered through a process running on a platform of the computing device, and indicative of communication between the computing device responsive to a human user input and at least one of the content site, a search engine site, and/or a beneficiary site. The communication includes communication related to the computing device responsive to a human user input receiving a digital work deliverable to the person. At the operation 1148, the receiving computing device data operation includes receiving computing device data gathered through a process running on a platform of the computing device. The computing device data indicative of communication between the computing device responsive to a human user input and at least one of the content site, a search engine site, and/or a beneficiary site. The communication includes communication related to the computing device responsive to a human user input receiving at least one of a document; review; critique; comment; rating; aggregations of reviews, comments, and/or critiques; a consumer-generated-media; blog; newsgroup; message board; and/or discussion forum deliverable to the person.

FIG. 33 illustrates another alternative embodiment of the exemplary operational flow 1100 of FIG. 27. The receiving computing device data operation 1140 malt include at least one additional operation. The at least one additional operation may include an operation 1152 and/or an operation 1154. At the operation 1152, the receiving computing device data operation includes receiving computing device data gathered through a process running on a platform of the computing device. The computing device data indicative of communication between the computing device responsive to a human user input and at least one of the content site, a search engine site, and/or a beneficiary site. The communication includes communication related to the computing device and responsive to a transaction, history, search string search result, and/or computing-device action associated with the computing device. In an alternative embodiment, the communication related to the computing device includes communication related to the computing device receiving at least one of an electronic content deliverable to the person, which includes at least one of an electronic document, an electronic work, an electronically-stored information, a Web document, an email, and/or an instant message. At the operation 1154, the receiving computing device data operation includes receiving computing device data gathered through a process running on a platform of the computing device. The computing device data indicative of communication between the computing device responsive to a human user input and at least one of the content site, a search engine site, and/or a beneficiary site. The communication includes communication related to the computing device receiving at least one of an electronic content deliverable to the person, a human perceivable content, a textual content, a visual content, an audio content, and/or a graphical content.

FIG. 34 illustrates an alternative embodiment of the exemplary operational flow 1100 of FIG. 27. The receiving computing device data operation 1140 may include at least one additional operation, such as the operation 1156. At the operation 1156, the receiving computing device data operation includes receiving computing device data gathered through a process running on a platform of the computing device. The computing device data indicative of communication between the computing device responsive to a human user input and at least one of the content site, a search engine site, and/or a beneficiary site. The communication includes communication related to the computing device receiving at least one of a transaction, history, search string, search result, and/or computing-device action associated with computing device.

FIG. 35 illustrates another alternative embodiment of the exemplary operational flow 1100 of FIG. 27. The receiving search engine site data operation 1160 may include at least one additional operation. The at least one additional operation may include an operation 1162, and/or an operation 1164. At the operation 1162, the receiving search engine site data operation includes receiving search engine site data fathered through a process running on a platform of the search engine site. The search engine site data indicative of communication between the search engine site and the computing device responsive to a human user input. The communication includes communication related to at least one of a transaction, history, search string, search result, and/or an action associated with the computing device. At the operation 1164, the receiving search engine site data operation includes receiving search engine site data gathered through a process running on a platform of the search engine site. The search engine site data indicative of communication between the search engine site and the computing device responsive to a human user input. The communication includes communication related to at least one of a program resident on the computing device, a process registered with an operating system of the computing device, a cookie present in computing device, data indicative of an affinity of the human user, and/or an information descriptive of an aspect of the computing device.

FIG. 36 illustrates a further alternative embodiment of the exemplary operational flow 1100 of FIG. 27. The receiving search engine site data operation 1160 may include at least one additional operation. The at least one additional operation may include an operation 1166. At the operation 1166, the receiving search engine site data operation includes receiving search engine site data gathered through a process running on a platform of the search engine site. The search engine site data indicative of communication between the search engine site and the computing device responsive to a human user input. The communication includes communication related to at least one of a program resident on the computing device, a process registered with an operating system of the computing device, a cookie present in computing device, data indicative of an affinity of the human user, and/or an information descriptive of an aspect of the computing device provided by a process running on a platform of the computing device.

FIG. 37 illustrates an alternative embodiment of the exemplary operational flow 1100 of FIG. 27. The receiving beneficial site data operation 1170 may include at least one additional operation. The at least one additional operation may include an operation 1172, and/or an operation 1174. At the operation 1172, the receiving beneficial site data operation includes receiving beneficiary site data gathered through a process running on a platform of the beneficiary site. The beneficiary site data indicative of at least one of communication associated with a purchase, communication associated with a vote, communication associated with a fund raising, and/or communication associated with a transaction between the computing device responsive to a human user input and the beneficiary site. At the operation 1174, the receiving beneficiary site data operation includes receiving beneficiary site data gathered through a process running on a platform of the beneficiary site. The beneficiary site data indicative of communication between the computing device responsive to a human user input and the beneficiary site. The communication between the computing device and the beneficiary site is initiated by a human action unrestricted by an electronic content of the content site. For example, the communication between the computing device and the beneficiary site is not responsive to or initiated by a clickthrough or other executable link provided bid the content site.

FIG. 38 illustrates another alternative embodiment of the exemplary operational flow 1100 of FIG. 27. The influence evaluation operation 1180 may include at least one additional operation. The at least one additional operation may include an operation 1182, an operation 1184, and/or an operation 1186. At the operation 1182, the influence evaluation operation includes at least one of estimating, approximating, and/or inferring a correlation between (a) the communication between the content site and a computing device responsive to a human user input and (b) the communication between the computing device responsive to a human user input and the beneficiary site. At the operation 1184, the influence evaluation operation includes predicting a future behavior of a person in response to a determined correlation between (a) the communication between the content site and a computing device responsive to a human user input and (b) the communication between the computing device responsive to a human user input and the beneficiary site. In an embodiment, the person includes the human user, a plurality of persons in an affinity group that includes the human user, and/or a hypothetical human. At the operation 1186, the influence evaluation operation includes determining at least one of a linear correlation, a relationship, a non-linear correlation, a fuzzy correlation, and/or a fuzzy relationship between (a) the communication between the content site and a computing device responsive to a human user input and (b) the communication between the computing device responsive to a human user input and the beneficiary site.

FIG. 39 illustrates a further alternative embodiment of the exemplary operational flow 1100 of FIG. 27. The exemplary operational flow 1100 may include at least one additional operation 1190. The at least one additional operation may include an operation 1192, an operation 1194, and/or an operation 1196. The operation 1192 assists delivery of a compensation to the holder of the content site in response to the determined degree of correlation. In an alternative embodiment, the compensation to the holder may be determined in response to the determined degree of correlation. In an embodiment, the holder of the content site malt include at least one of an owner, developer, operator, proprietor, blogger, and/or designated recipient of any benefit. The operation 1194 maintains informational data corresponding to the determined correlation. The operation 1196 provides access to an informational data corresponding to the determined correlation.

FIG. 40 illustrates an exemplary 1300 computing device 1300 operable to communicate over a network. The computing device includes a communications monitoring module 1190 and an evaluation module 1312. The communications monitoring module is operable to receive at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content site, a search engine site, and/or a beneficiary site. The search engine site data gathered through a process running on a platform of the search engine site, and indicative of communication between the search engine site and the computing device responsive to a human user input. The beneficiary site data gathered through a process ruining on a platform of the beneficiary site, and indicative of communication between the computing device responsive to a human input and the beneficiary site. The evaluation module 1312 is operable to determine a correlation of (a) the communication between the content site and a computing device responsive to a human user input, and (b) the communication between the computing device responsive to a human user input and the beneficiary site.

In an alternative embodiment, the computing device 1300 further a computer-readable media configurable by data outputted by at least one of the communications monitoring module and/or the evaluation module. The computer-readable media is illustrated as a storage media 1350. In another embodiment, the computing device further includes a retention module 1314 operable to maintain informational data corresponding to the determined correlation. In a further embodiment, the computing, device includes an output module 1316 operable to provide access to informational data corresponding to the determined correlation. In another embodiment, the computing device further includes a computing device responsive to human input, and operable to display human perceivable content and communicate with a network. In yet another embodiment, the computing device further includes a computing device operable to provide electronic content to a network. In a further embodiment, the computing device further includes a network intermediary device operable to communicate with a network. In another embodiment, the computing device further includes a computing device under a control of the third-party.

FIG. 41 illustrates an exemplary computer program product 1400. The computer program product includes a signal bearing medium 1410 bearing program instructions 1420 operable to perform an influence evaluation process in a computing device. The process of the program instructions includes receiving at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content site, a search engine site, and/or a beneficiary site. The search engine site data gathered through a process running on a platform of the search engine site, and indicative of communication between the search engine site and the computing device responsive to a human user input. The beneficiary site data gathered though a process running on a platform of the beneficiary site, and indicative of communication between the computing device responsive to a human input and the beneficiary site. The process of the program instructions 1420 also includes assessing an influence of the content site on an involvement between the computing device responsive to a human user input and the beneficiary site. In an alternative embodiment, the process of the program instructions 1420 further includes receiving data indicative of an affinity of a human user of the computing device 1422. In another embodiment, the process of the program instructions further includes outputting the influence assessment in a form usable by a process facilitating deliver-y, of a benefit to an owner of the content site 1424. In further embodiment, the process of the program instructions further includes maintaining informational data corresponding to the assessment of influence 1426. In yet another embodiment, the process of the program instructions further includes providing access to maintained informational data corresponding to the assessment of influence 1428.

In another embodiment, the computer-readable signal-bearing medium 1410 includes a computer storage medium 1432. In a further embodiment, the computer-readable signal-bearing medium includes a communication medium 1434.

FIG. 42 illustrates an exemplary device 1500. The device includes means 1510 for receiving at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content site, a search engine site, and/or a beneficiary site. The search engine site data gathered through a process running on a platform of the search engine site, and indicative of communication between the search engine site and the computing device responsive to a human user input. The beneficiary site data gathered through a process running on a platform of the beneficiary site, and indicative of communication between the computing device responsive to a human input and the beneficiary site.

The device 1510 also includes means 1512 for assessing an influence of the content site on an involvement between the computing device responsive to a human user input and the beneficiary site. In an alternative embodiment, the device further includes means 1522 for receiving data indicative of an affinity of a human user of the computing device. In another embodiment, the device further includes means 1524 for outputting the influence assessment in a form usable by a process facilitating delivery of a benefit to an owner of the content site.

With reference now to FIG. 43, shown is an example of another system that may serve as a context for introducing one or more processes, systems or other articles described herein. As shown system 1800 comprises one or more instances of writers 1801, processors 1803, controls 1805, software or other implementations 1807, invokers 1812, compilers 1814, outputs 1816, coding modules 1818, or the like with one or more media 1890 bearing expressions or outputs thereof. In some embodiments, such media may include distributed media bearing a divided or otherwise distributed implementation or output. For example, in some embodiments, such media may include two or more physically distinct solid-state memories, two or more transmission media, a combination of such transmission media with one or more data-holding media configured as a data source or destination, or the like.

In some embodiments, transmission media may be “configured” to bear an output or implementation (a) by causing a channel in a medium to convey a portion thereof or (b) by constituting, adapting, addressing, or otherwise linking to such media in some other mode that depends upon one or more atypical traits of the partial or whole output or implementation. Data-holding elements of media may likewise be “configured” to bear an output or implementation portion (a) by holding the portion in a storage or memory location or (b) by constituting, adapting, addressing, or otherwise linking to such media in some other mode that depends upon one or more atypical traits of the partial or whole output or implementation. Such atypical traits malt include a name, address, portion identifier, functional description, or the like sufficient to distinguish the output, implementation, or portion from a generic object.

In some embodiments described herein, “logic” and similar implementations can include software or other control structures operable to guide device operation. Electronic circuitry, for example, can manifest one or more paths of electrical current constructed and arranged to implement various logic functions as described herein. In some embodiments, one or more media are “configured to bear” a device-detectable implementation if such media hold or transmit a special-purpose device instruction set operable to perform a novel method as described herein. Alternatively or additionally, in some variants, an implementation may include special-purpose hardware or firmware components or general-purpose components executing or otherwise invoking special-purpose components. Specifications or other implementations may be transmitted by one or more instances of transmission media as described herein, optionally by packet transmission or otherwise by passing through distributed media at various times.

In some embodiments, one or more of the coding modules 1818 may be configured wraith circuitry for applying, imposing, or otherwise using a syntactic or other encoding constraint in forming, extracting, or otherwise handling respective portions of the device-detectable implementation or output. In encoding a software module or other message content, for example, compiler 1814 or coding module 1818 may implement one or more such constraints pursuant to public kelp or other encryption, applying error correction modes, certifying or otherwise annotating the message content, or implementing other security practices described herein or known by those skilled in the art. Alternatively or additionally, another instance of coding module 1818 may be configured to receive data (via receiver 1059, e.g.) and decode or otherwise distill the received data using one or more such encoding constraints. Compiler 1814 may, in some variants, convert one or more of components 1071-1079 from a corresponding source code form before the component(s) are transmitted across linkage 1005.

System 1800 may be implemented, for example, as one or more instances of stand-alone workstations, servers, vehicles, portable devices, removable media 1820, as components of primary system 1000 or network 1080 (of FIG. 26), or the like. Alternatively or additionally, media 1890 may include one or more instances of signal repeaters 1081, communication satellites 1083, servers 1084, processors 1085, routers 1087, portions of primary system 1000 as shown, or the like.

Media 1890 may include one or more instances of removable media 1820, tapes or other storage media 1826; parallel (transmission) media 1830; disks 1844; memories 1846; other data-handling media 1850; serial media 1860; interfaces 1870; or expressions 1889, 1899. Removable media 1820 can bear one or more device-detectable instances of instruction sequences 1822 or other implementations of flow 1100 or flow 500, for example. Alternatively or additionally, in some embodiments, removable media 1820 can bear alphanumeric data, audio data, image data, structure-descriptive values, or other content 1824 in a context that indicates an occurrence of flow 1100 or flow 500. In some circumstances, transmission media may bear respective portions of implementations as described herein serially or otherwise non-simultaneously. In some variants in which two portions 1897, 1898 constitute a partial or complete software implementation or product of a novel method described herein, portion 1897 maid follow portion 1898 successively through serial media 1863, 1865, 1867 (with transmission of portion 1897 partly overlapping in time with transmission of portion 1898 passing through medium 1863, for example).

As shown, parallel channels 1831, 1832 are respectively implemented at least in media 1837, 1838 of a bus or otherwise effectively in isolation from one another. In some embodiments, a bus may be a system of two or more signal paths—not unified by a nominally, ideal conduction path between them—configured to transfer data between or among internal or external computer components. For example, one data channel may include a power line (e.g., as medium 1865) operable for transmitting content of the device-detectable implementation as described herein between two taps or other terminals (e.g., as media 1863, 1867 comprising a source and destination).

In another such configuration, one or more media 1837 of channel 1831 may bear portion 1897 before, while or after one or more other media 1838 of parallel channel 1832 bear portion 1898. In some embodiments, such a process may occur “while” another process occurs if they coincide or otherwise overlap in time substantially (by several clock cycles, for example). In some embodiments, such a process may occur “after” an event if any instance of the process begins after any instance of the event concludes, irrespective of other instances overlapping or the like.

In a variant in which a channel through medium 1850 bears an expression 1855 partially implementing an operational flow described herein, the remainder of the implementation may be borne (earlier or later, in some instances) bad the same medium 1850 or by one or more other portions of media 1890 as shown. In some embodiments, moreover, one or more controls 1805 may configure at least some media 1890 by triggering transmissions as described above or transmissions of one or more outputs 1816 thereof.

In some embodiments, the one or more “physical media” may include one or more instances of conduits, layers, networks, static storage compositions, or other homogenous or polymorphic structures or compositions suitable for bearing signals. In some embodiments, such a “communication channel” in physical media may include a signal path between two transceivers or the like. A “remainder” of the media may include other signal paths intersecting the communication channel or other media as described herein. In some variants, another exemplary system comprises one or more physical media 1890 constructed and arranged to receive a special-purpose sequence 1882 of two or more device-detectable instructions 1884 for implementing a flow as described herein or to receive an output of executing such instructions. Physical media 1890 may (optionally) be configured by writer 1801, transmitter 1052, or the like.

In some embodiments, such a “special-purpose” instruction sequence may include any ordered set of two or more instructions directly or indirectly operable for causing multi-purpose hardware or software to perform one or more methods or functions described herein: source code, macro code, controller or other machine code, or the like. In some embodiments, an implementation may include one or more instances of special-purpose sequences 1882 of instructions 1884, patches or other implementation updates 1888, configurations 1894, special-purpose circuit designs 1893, or the like. Such “designs,” for example, may include one or more instances of a mask set definition, a connectivity layout of one or more gates or other logic elements, an application-specific integrated circuit (ASIC), a multivariate transfer function, or the like.

Segments of such implementations or their outputs may (optionally) be manifested one or more information-bearing static attributes comprising the device-detectable implementation. Such attributes may, in some embodiments, comprise a concentration or other layout attribute of magnetic or charge-bearing elements, visible or other optical elements, or other particles in or on a liquid crystal display or other solid-containing medium. Solid state data storage modules or other such static media may further comprise one or more instances of laser markings, barcodes, human-readable identifiers, or the like, such as to indicate one or more attributes of the device-detectable implementation. Alternatively or additionally such solid state or other solid-containing media may include one or more instances of semiconductor devices or other circuitry, magnetic or optical digital storage disks, dynamic or flash random access memories (RAMs), or the like. Magnetoresistive RAMs may bear larger implementation or output portions or aggregations safely and efficiently, moreover, and without any need for motors or the like for positioning the storage medium.

Segments of such implementations or their outputs may likewise be manifested in electromagnetic signals 1886, laser or other optical signals 1891, electrical signals 1892, or the like. In some embodiments, for example, such electrical or electromagnetic signals may include one or more instances of static or variable voltage levels or other analog values, radio frequency transmissions or the like. In some embodiments, the above-mentioned “optical” signals may likewise include one or more instances of time- or position-dependent, device-detectable variations in hue, intensity, or the like. Alternatively or additionally, portions of such implementations or their outputs may manifest as one or more instances of magnetic, magneto-optic, electrostatic, or other physical configurations 1828 of nonvolatile storage media 1826 or as external implementation access services 1872.

In some embodiments, physical media can be configured by being “operated to bear” or “operated upon to bear” a signal. For example, they may include physical media that generate, transmit, conduct, receive, or otherwise convey or store a device-detectable implementation or output as described herein. Such conversance or storing of a device-detectable implementation or output may be carried out in a distributed fashion at various times or locations, or such conveyance or storing of a device-detectable implementation or output may be done at one location or time. As discussed above, such physical media “operated to bear” or “operated upon to bear” may include physical media that are atypically constituted or adapted to facilitate methods or functions as described herein.

In some configurations, one or more output devices 1045 may present one or more results of computing device data gathered though a process running on a platform of the computing device, and indicative of communication between the computing device responsive to a human user input and at least one of the content site, a search engine site, and/or a beneficiary site in response to interface(s) 1040 receiving one or more invocations or outputs of an implementation of this function via linkage 1005. Such an “invocation” may, in some embodiments, comprise one or more instances of requests, hardware or software activations, user actions, or other determinants as described herein. Alternatively or additionally, in some embodiments, one or more input devices 1043 may later receive one or more invocations or results of search engine site data gathered through a process running on a platform of the search engine site, and indicative of communication between the search engine site and the computing device responsive to a human user input. In contexts like these, processor 1085 or other components of network 1080 may likewise constitute a secondary implementation having access to a primary instance of interface 1040 implementing methods like flow 1100 as described herein.

Serial media 1860 comprises a communication channel of two or more media configured to bear a transition or other output increment successively. In some embodiments, for example, serial media 1860 may include a communication line or wireless medium (e.g., as medium 1865) between two signal-bearing conduits (e.g. terminals or antennas as media 1863), 1867). Alternatively or additionally) one or more lenses 1049 or other light-transmissive media may comprise a serial medium between a light-transmissive medium and a sensor or other light receiver 1059 or transmitter 1052. In some embodiments, such “light-tansmissive”, media may (optionally) comprise metamaterials or other media operable for bearing one or more instances of microwave signals, radiowave signals, visible light signals, or the like.

In some embodiments, such a lens may be an optical element that causes light to converge or diverge along one or more signal paths. Such a light-transmissive medium may include a signal-bearing conduit, glass, or other physical medium through which an optical signal may travel. More generally, a signal-bearing conduit may be an electrical wire, a telecommunications cable, a fiber-optic cable, or a mechanical coupling or other path for the conveyance of analog or digital signals.

Alternatively or additionally, system 1800 may likewise include one or more instances of media for handling implementations or their outputs: satellite dishes or other reflectors 1057, antennas 1058 or other transducers 1875, arrays of two or more such devices configured to detect or redirect one or more incoming signals, caching elements or other data-holding elements (e.g., disks 1844, memories 1846, or other media 1890), integrated circuits 1048, or the like. In some variants, one or more media may be “configured” to bear a device-detectable implementation as described herein by being constituted or otherwise specially adapted for that type of implementation at one or more respective times, overlapping or otherwise. Such “signal-bearing” media may include those configured to bear one or more such signals at various times as well as those currently bearing them.

In some embodiments, such caching elements may comprise a circuit or device configured to store data that duplicates original values stored elsewhere or computed earlier in time. For example, a caching element may be a temporary storage area where frequently-accessed data may be held for rapid access by a computing system. A caching element likewise may be machine-readable memory (including computer-readable media such as random access memory or data disks). In some embodiments, such caching elements may likewise comprise a latching circuit or device configured to store data that has been modified from original values associated with the data (held elsewhere or computed earlier in time, for example).

In one variant, respective portions 1895, 1896 of an expression 1899 of implementation 1807 ma) be sent through respective channels at various times. Invoker 1812 may request or otherwise attempt to activate a computer program or streaming media overseas via a telephone cable or other channel 1831. Meanwhile, output 1816 may attempt to trigger a session or other partial implementation 1852, success in which may be indicated by receiving expression 1855 into a visual display or other medium 1850. Such a program or other implementation may be made complete, for example, once both of these attempts succeed.

In some embodiments, transducer(s) 1875 may comprise one or more devices that convert a signal from one form to another form. For example a transducer may be a cathode ray tube that transforms electrical signals into visual signals. Another example of a transducer comprises a microelectromechanical systems (“MEMS”) device which may be configured to convert mechanical signals into electrical signals, (or vice versa).

An embodiment includes method of reporting electronic content influence. The method includes generating a client-side influence report assessing a behavioral influence by a network-available electronic content on a person accessing the network-available electronic content. The client-side influence report may assess with respect to a matter of interest to a third party a behavioral influence by a network-available electronic content on a person accessing the network-available electronic content. The network-available electronic content including a first electronic content having a first-electronic-content portion relevant to the third party. The network content may include a second electronic content having a second-electronic-content portion relevant to the third party.

The influence report includes at least one of a single bit, a document, a dynamic report, a two-way report, and/or a one-time snapshot. The influence report may have a selected format. The influence report responsive at least in part to data collected using a process running on a platform of a client-side computing device used by the person to access the network-available electronic content. The process may be at least one of bundled with, and/or integrated into a platform of a client-side computing device.

The method also includes receiving data indicative of the matter of interest to a third party and transmitting the client-side influence report. In another embodiment, the client-side influence report is receivable by a site capable of/operable to facilitate delivery of a benefit to an owner of the first first-electronic-content portion. The client-side influence report may be receivable by a site capable of/operable to facilitate delivery of a benefit to an owner of the first first-electronic-content portion the and/or an owner of the second-electronic-content portion in response to the client-side influence report. The client-side influence report may be receivable by a computing device associated with the third party.

Another embodiment provides as influence reporting method. The method includes collecting data indicative of a user accessing electronic content over a computer network using a client-side computing device. The collecting data may include collecting at least one of raw, aggregated, and/or anonymized data. The collecting data may include collecting data indicative of at least one of client-side computing device activity. The activity may include at least one of user inputs, keystrokes, navigation commands, mouse movements, caching, sessions, and/or visits. The navigation commands may include user display screen navigation commands. The activity may include activity associated with, incidental to, and/or responsive to at least one of user mouse movements, scrolling movements, purchases, operations, visited Websites, visited blogs, page views, page visits, viewing time, repeat visits, page tags, printing a content, click stream, search strings, local search strings, interactions, scrolling, menu activity corresponding/related to browsing the Internet, cut and past, print history, browsing history, email, and/or cookies received. The activity may include activity associated with user keystrokes, logged keystrokes along with the window name they are typed, email sent, email received, logged events, logged timeline, Website activity, logged Websites visited, application usage; log of applications run, documents opened, saved documents, files opened, files viewed, cut, cut and paste, scrolling, navigating, and setting a bookmark. The data indicative of a user accessing electronic content may, include data indicative of a computing system environment, a local computing system interaction associated with the client-side computing device, a network interaction including bulk content downloaded to form a page, a turning of visibility tags on and off, and/or an interactive environment.

The accessing may include browsing, viewing, viewing a page, downloading, listening, reading and/or replying to email, encountering, and/or forwarding electronic content. The electronic content may include at least one of internally and/or externally accessible electronic content. The electronic content may include a publicly available, limited availability, and/or privately available electronic content. The electronic content may include electronic content available over a public and/or private computer network. The computer network may include the Internet, an intranet, and/or other network. The data collected using a process running on a platform of the client-side computing device. The process may include at least one of a kernel mode process, a user mode process, an application, and/or a program. The process may include at least one of a process bundled with, integrated into, and/or registered with a platform of the client-side computing device.

The method also includes generating a client-side influence report bad transforming the collected data into information indicative of extents associatable with the person accessing the electronic content over a computer network using the client-side computing device. The transforming the collected data may include at least one of an abstraction, transformation, interpretation, and/or synthesis of the collected data that includes an indication of matters potentially relevant to assessing influence of electronic content. The transforming the collected data malt include at least one of a mining, filtering, interpreting, refining, combining, and/or evaluating data. The transforming the collected data may include transforming one instance of data in view, of another instance of data. The transforming the collected data may include transforming using a recursive model. The client-side influence report may include key strokes into URLs, URLs into websites. The client side influence report may include information indicative of actions, behaviors, and/or outcomes associatable with the person. The client-side influence report may include information that includes a context and/or an affiliation, for example, a teenager browsing expensive cars is not as useful as a middle-aged person browsing expensive cars. The events associatable with the person may include at least one determined, inferred, and/or probable associatable with the person accessing the electronic content over a computer network using the client-side computing device. The client-side influence report may include information corresponding to an indication of relevancy of content to the third party, time on page, return visits, following links embedded in page, and/or visit to a Website associated with third party. The client-side influence report may include information corresponding to an involvement, such as for example, a purchase, a donation, a membership, and/or inquiry between the person and a subject of interest to a third party. The transforming the collected data may include transforming the collected data mined using a process running on a platform of the client-side computing device. The transforming the collected data may include transforming the collected data mined using at least one of a kernel mode, user mode, application, program running on a platform of the client-side computing device. The transforming the collected data may include transforming the collected data mined using a process bundled with, and/or integrated into a platform of the client-side computing device. The generating an anonymized client-side influence report may include generating an anonymized client-side influence report by transforming the influence information to at least significantly reduce a presence of information useable in identifying the person.

The method further includes transmitting the client-side influence report. The transmitting the client-side influence report may include transmitting an anonymized client-side influence report. The transmitting the client-side influence report may include transmitting an anonymized client-side influence report receivable bar a site capable of/operable to determine a degree of correlation between (1) events associatable with the person using a client-side computing device to access electronic content; and (2) an involvement between the person and a subject of interest to the third party.

A further embodiment includes influence assessment method. The method includes collecting data indicative of a client-side computing device environment associated with a person accessing electronic content over a computer network using the client-side computing device, the electronic content including a first electronic content having a first-electronic-content portion and a second electronic content having a second-electronic-content portion. The collecting data may include collecting data indicative of client-side computing device activity corresponding to a client-side computing device environment associated with a person accessing electronic content over a computer network using the client-side computing device. The person accessing electronic content may include a person browsing and/or downloading electronic content. The computer network may include a public or a private computer network. The collecting data indicative of a client-side computing environment may include at least one of collecting data indicative of time on page, return visits, following links embedded in page, visit to a Website associated with third party, dwell time, cut and paste, content forwarding. The collecting data indicative of a client-side computing environment may include at least one of user inputs, keystrokes, document navigations commands, screen navigation commands, mouse movements, caching, sessions, and/or visits. The collecting data indicative of a client-side computing environment may include collecting data indicative of an involvement between the person and a subject of interest to a third party. The collecting data indicative of a client-side computing environment may include collecting data indicative of at least one of a purchase, a donation, a membership, and/or an inquiry.

The electronic content may include electronic content including a first electronic content having a first-electronic-content portion and a second electronic content having a second-electronic-content portion. The electronic content may include electronic content including a first electronic content having a first-electronic-content portion potentially relevant to a third partly and a second electronic content having a second-electronic-content portion potentially relevant to the third party. The data collected may include data collected using a process running on a platform of the client-side computing device. The data collected may include data collected using at least one of a kernel mode, user mode, application, and/or program running on a platform of the client-side computing device. The data collected may include data collected using a process bundled with, and/or integrated into a platform of the client-side computing device. The method may include assessing an influence of the first electronic content and a second electronic content on an involvement between the person using the client-side computing device and a subject of interest to the third party.

The method includes transmitting a client-side influence report. The transmitting a client-side influence report may include transmitting an anonymized client-side influence report. The anonymized client-side influence report may be generated at least in part by transforming the collected data to at least significantly reduce a presence of data useable in identifying the person. The client-side influence may include a client-side influence report indicating an influence assessment of the electronic content on a behavior of the person. The client-side influence may include a client-side influence report indicating an influence assessment with respect to a subject of interest to the third party of the electronic content on a behavior of the person. The client-side influence may include a client-side influence report indicating an influence assessment of at least one of the first electronic content and/or a second electronic content on a behavior of the person. The client-side influence may include a client-side influence report receivable by a site capable of and/or operable to facilitate deliver of a benefit to at least one of an owner of the first Web document and/or an owner of the second Web document in response to the influence assessment. The client-side influence may include a client-side influence report receivable by a computing device associated with the third party.

An embodiment provides an influence reporting method. The method includes collecting data using a process running on a platform of a client-side computing device, the collected data indicative of the client-side computing device environment associated with a person accessing electronic content over a computer network using the client-side computing device. The collecting data may include collecting data using a kernel mode, user mode, application, and/or program running on a platform of a client-side computing device. The collecting data may include collecting data using a process running on an OS, information handling system, and/or search engine platform of a client-side computing device. The collecting data may include collecting data using a process bundled with, integrated into, and/or registered with a platform of a client-side computing device. The collected data may include raw, aggregated, and/or anonymized collected data indicative of the client-side computing device environment associated with a person accessing electronic content over the Internet, an intranet, and/or other computer network using the client-side computing device. The electronic content ma include a first electronic content having a first-electronic-content portion and a second electronic content having a second-electronic-content portion.

The method further includes generating an influence information by transforming the collected data for information corresponding to events occurring in the client-side computing device environment associated with the person accessing the electronic content over a computer network using the client-side computing device. The generating an influence information may include periodically generating an influence information. The generating an influence information may include anonymizing the influence information. The generating an influence information may include anonymizing the influence information in response to a privacy restriction indicated by the person, the privacy restriction indicated by at least one of the process, the platform, a selected privacy setting, a platform owner, the third party, another party, and/or an information broker. The generating an influence information may include anonymizing the influence information in response to a privacy restriction by at least significantly reducing a presence of data useable in identifying the person. The generating an influence information may include anonymizing the influence information in response to a privacy restriction by at least significantly reducing a presence of data useable in readily identifying the person. The generating an influence information may include anonymizing the influence information in response to a privacy restriction by at least significantly reducing a presence of data useable in identifying an attribute of the person. The generating an influence information may include anonymizing the influence information in response to a privacy restriction by at least significantly reducing a presence of data useable in identifying a password, credit card, and/or personal information associated with the person.

The method may include forming a hypothesis and/or a preliminary correlation among instances of the influence information. The method may include forming a hypothesis and/or a preliminary correlation among instances of the influence information, and massaging the information in a manner making it useful in at least one of aggregating the influence information annotating the influence information, and/or indicating a degree of correlation between at least two events corresponding to accessing electronic content.

The method further includes outputting the influence report. The method may include outputting the influence report by pushing the influence report and/or in response to a pull. The method may include outputting the influence report to the platform owner and/or a designee of the platform owner.

Another embodiment includes a content-provider-machine centric influence reporting method. The method includes generating a server-side influence report assessing a behavioral influence of an electronic content on a person accessing the electronic content, the influence report responsive at least in part to data collected using a process running on a server hosting the electronic content. The generating a server-side influence report may include includes generating a server-side influence report assessing a behavioral influence of an electronic document, streaming video, streaming audio, and/or email. The server-side influence report may include a server-side influence report assessing with respect to a matter of interest to a third party a behavioral influence of a electronic content on a person accessing the electronic content. The server-side influence report may include a server-side influence report assessing with respect to a matter of interest to a third party a behavioral influence of a electronic content on a person accessing the electronic content and on another person accessing the hosted electronic content. The electronic content may include electronic content having an electronic-content portion relevant to the third party. The electronic content may include electronic content having a first electronic-content portion relevant to the third party and having a second electronic content having a second-electronic-content portion relevant to the third party. The influence report including an influence report responsive at least in part to data collected using a process running on a server hosting the electronic content. The influence report including an influence report responsive at least in part to data collected using a process running bundled with, integrated into a server hosting the electronic content. The influence report including an influence report responsive at least in part to data collected using a process running on a platform of a server hosting the electronic content.

The method also includes transmitting the server-side influence report. The transmitted server-side influence report may include a transmitted server-side influence report receivable by a site capable of and/or operable to facilitate delivered of a benefit to an opener of the hosted electronic content in response to the content-server-side influence report. The transmitted server-side influence report may include a transmitted server-side influence report receivable by a site capable of and/or operable to facilitate delivered of a benefit to an owner of the hosted electronic content and/or an owner of the another electronic-content portion in response to the content-server-side influence report. The transmitted server-side influence report may include a transmitted server-side influence report receivable bad a computing device associated with the third part.

The method may include receiving data indicative of electronic content relevant to the third part. The method may include receiving from the third party, and/or from another party data indicative of electronic content relevant to the third party.

A further embodiment provides an influence reporting method. The method includes collecting data indicative of communication between a content site and a client-side computing device. The content site includes a content site hosted bid a server and providing a network-accessible electronic content. The content site may include a content site hosted by at least one of a file server, email server, Web server, image streaming server and providing a network-accessible electronic content. The content site may include a content site hosted by a server and providing a network-accessible electronic content potentially relevant to a third party. The data collected by the content site includes data collected by the content site using a process running on a platform of the content site, and/or the content-site server. The data collected by the content site includes data collected by the content site using a process bundled with, and/or integrated into a platform of the content site, and/or the content-site server. The data collected by the content site includes data collected by the content site using a process bundled with, and/or integrated into an OS, an information handling system, and/or a search engine associated with the content site, and/or the content-site server. The client-side computing device includes a client-side computing device used by a person to access the network-accessible electronic content.

The client-side computing device used by a person may include a first client-side computing device used by a first person and a second client-side computing device used by a second person to access the network-accessible electronic content. The data collected by the client-side computing device includes data collected by the client-side computing device using a process running on a platform of the client-side computing device. The data collected bad the client-side computing device includes data collected by the client-side computing device using a process bundled with and/or integrated into a platform of the client-side computing device. The data collected by the client-side computing device includes data collected by the client-side computing device using a process bundled with, and/or integrated into an OS, an information handling system, and/or a search engine associated with the client-side computing device.

The method also includes generating a content-site influence report by transforming the collected data for information corresponding to events associatable with the person using the client-side computing device to access the network-accessible electronic content. The method may include generating a content-provider influence report by transforming the collected data for information corresponding to events associatable with the person using the client-side computing device to access the network-accessible electronic content. The method may include generating a content-site influence report by filtering the collected data for information corresponding to events associatable with the person using the client-side computing device to access the network-accessible electronic content. The method may include generating a content-site influence report by transforming the collected data for information corresponding to access, browsing, and/or downloading events associatable with the person using the client-side computing device to access the network-accessible electronic content. The generating a content-site influence report may further include assessing an influence on the person by the electronic content regarding a matter of interest to the third party. The generating a content-site influence report may further include assessing an influence on the person by the electronic content regarding a matter of interest to the third party, the influence assessment at least partially responsive to an influence assessment tool. The generating a content-site influence report may further include assessing an influence on the person by the electronic content regarding a matter of interest to the third party, the influence assessment at least partially responsive to an influence assessment signature tool that is at least acknowledged by the third party.

The method also includes transmitting the content-provider-site influence report. The transmitting the content-provider-site influence report may include transmitting the content-provider-site influence report in combination with at least one other content-site influence report responsive to data indicative of communications between another content site and at last two other computing devices respectively used by other persons. The transmitting the content-provider-site influence report may include transmitting a content-provider-site influence report receivable by a site capable of/operable to assessing an influence of the content site on a behavior toward a third party by at least one of the first person and/or the second person.

The method may include anonymizing the content-site influence report by transforming the content-site influence report to at least significantly reduce a presence of data useable in identifying an attribute of the person.

An embodiment provides a recommender determination method. The method includes collecting data indicative of communication between a computing device hosting a content provider site and at least two respective computing devices responsive to human input. The collecting data indicative communication may include collecting data indicative of Internet, and/or network communications. The collecting data indicative communication may include collecting data indicative of communication related to a content and/or a transaction between a computing device hosting a content provider site and at least two respective computing devices. The collecting data indicative communication may include collecting data indicative of communication between a computing device hosting a content provider site and at least two respective client-side computing devices responsive to human input. The collecting data indicative communication may include collecting data indicative of communication using an application running on a platform of the computing device hosting a content provider site. The platform of the computing device hosting a content provider site may include at least one of an OS, information handling system, search engine, switch, router, and/or network fabric. The collecting data indicative communication may include collecting data indicative of network communications between a computing device hosting a content provide site and at least two respective computing devices responsive to human input.

The method also includes generating an influence information bad transforming the collected data for information corresponding to a network event initiated by a person using at least one of the two the computing devices responsive to human input. The method further includes generating an influence information by transforming the collected data for information corresponding to network events.

The method further includes generating an influence report bit transforming the influence information to at least significantly reduce a presence of data useable in identifying an attribute of the user. The generating an influence report may include generating an anonymized influence report by transforming the influence information to at least significantly reduce a presence of data useable in identifying a name, address, occupation, income, password, credit card, and/or personal information attribute of a person using at least one of the two computing devices responsive to human input. The generating an influence report may include generating an anonymized influence report that includes a hypothetical correlation among instances of the influence information. The generating an influence report may include generating an influence report that includes a massaging of the information in a manner making it useful in assessing an influence of a content provider site. The generating an influence report may include generating an influence report that includes a aggregating at least two pieces of information in a manner making it useful in assessing an influence of a content provider site.

The method also includes outputting the influence report.

Another embodiment provides an influencer assessment method performed in remote computing device. The method includes receiving a client-side influence report that includes information corresponding to events associatable with a person accessing network-available electronic content using a client-side computing device. The method also includes assessing an influence of the network-available electronic content on a behavior of the person with respect to a subject matter of interest to the third party. The method may include receiving a server-side influence report that includes information corresponding to an involvement between the person and a subject matter of interest to a third party. The method mats include receiving an influence assessment tool. The method may include in response to the assessment of influence of the network-available electronic content, facilitating a benefit to an owner of the network-available electronic content. The method may include transmitting the assessment of influence of the network-available electronic content network-available electronic content.

A further embodiment provides recommender determination method performed in a remote computing device. The method includes receiving data indicative of a person using a client-side computing device to access over a computer network an electronic document having a content. The method also includes transforming the received data for information corresponding to events associatable with the person using the client-side computing device to access the electronic document over a computer network. The method further includes determining a degree of correlation between: the information corresponding to events associatable with the client-side computing access the electronic document; and communication between the client-side computing device and the third partly site.

The method may include receiving third party-site data of communication between the person using the client-side computing device and a third-party site owned bad a third party. The method may include transforming the third-party site data for information indicative of communication between the person using the client-side computing device and a third party site. The method may include facilitating a transfer of a compensation to an owner of the electronic document. The method may include transmitting the determined degree of correlation.

An embodiment includes a recommender determination method performed in remote computing device. The method including receiving information indicative of activity related to a content provider site bad respective users of at least two client-side computing devices. The method may include receiving a network visitor behavior signature tool and using the tool in inferring a correlation between: behavior of people related to Internet activity with respect to the content provider Website; and behavior of the people with respect to a subject of interest by a beneficiary. The method further includes facilitating transfer of a compensation to the holder of the content provider site in response to a predetermined degree of correlation.

Another embodiment provides an influence assessment method. The method including receiving a content-side influence report that includes information corresponding to extents associatable with a person using a client-side computing device to obtain network-accessible electronic content, the content-side influence report at least responsive in part to data collected using a process ruling on a content server hosting the electronic content. The method may include receiving a server-side influence report that includes information corresponding to an involvement between the person and the matter of interest to a third party, the server-side influence report responsive to data collected using a process running on a platform of a server hosting a content accessed by the person using the client-side computing device. The method may include receiving an influence assessment tool. The method includes assessing with respect to a matter of interest to a third party an influence of the network-accessible electronic content on a behavior by the person accessing the network-accessible electronic contents.

A further embodiment provides influencer determination method. The method includes receiving, data indicative of visitor encounters with at least two network-accessible electronic documents that respectively include content relevant to an entity. The method also includes receiving data indicative of a behavior with respect to a matter of interest to the entity by at least two persons capable of visiting the at least two network-accessible electronic documents. The method further includes facilitating delivery of a compensation to an owner of at least one network-accessible electronic document of the at least two network-accessible electronic documents. The owner may include an author, content author, assignee, poster creator, and/or associate. The method may include facilitating delivery of a compensation to the owner may include facilitating delivery of a compensation to the owner in response to the received data indicative of a behavior with respect to a matter of interest to the entitle bad at least two persons capable of visiting the at least two network-accessible electronic documents. The facilitating deliver may include facilitating delivery of a compensation to an owner of at least one network-accessible electronic document of the at least two network-accessible electronic documents in an amount subject to the discretion of at least one of the entity, a third party, and/or a compensation determination algorithm. The facilitating delivery may include facilitating delivery of a compensation to an owner of at least one network-accessible electronic document of the at least two network-accessible electronic documents, the owner selected randomly, and/or selected in response to a compensation-recipient selection algorithm.

The foregoing detailed description has set forth various embodiments of the devices and/or processes via the use of block diagrams, flow diagrams, operation diagrams, flowcharts, illustrations, and/or examples. Insofar as such block diagrams, operation diagrams, flowcharts, illustrations, and/or examples contain one or more functions and/or operations, it will be understood that each function and/or operation within such block diagrams, operation diagrams, flowcharts, illustrations, or examples can be implemented, individually and/or collectively, by a wide range of hardware, software, firmware, or virtually any combination thereof unless otherwise indicated. A particular block diagram, operation diagram, flowchart, illustration, environment, and/or example should not be interpreted as having ants dependency or requirement relating to any one or combination of components illustrated therein. For example, in certain instances, one or more elements of an environment may be deemed not necessary and omitted. In other instances, one or more other elements may be deemed necessary and added.

Those having skill in the an will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In addition, those skilled in the art will appreciate that the mechanisms of the subject matter described herein are capable of being distributed as a program product in a variety of forms, and that an illustrative embodiment of the subject matter described herein applies equally regardless of the particular type of signal-bearing media used to actually carry out the distribution. Examples of a signal-bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

It will be understood by those within the art that, in general, terms used herein, and especially in the appended claims (e.g., bodies of the appended claims) are generally intended as “open” terms (e.g. the term “including” should be interpreted as in “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly interactable and/or tirelessly interacting components.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1.-56. (canceled)

57. An apparatus comprising:
one or more physical media configured to bear a device-detectable implementation of a method including at least
receiving data indicative of a person accessing at least one of a first network-available electronic content having a first-electronic-content portion or a second network-available electronic content having a second-electronic-content portion;
receiving data indicative of an involvement between the person and a third-party; and
facilitating delivery of a benefit to an owner of the first-electronic content or an owner of the second electronic content in response to an assessed influence by the first-electronic-content portion and/or the second-electronic-content portion on the involvement between the person and the third-party.

58. The apparatus of claim 57, in which the one or more physical media comprise:
an antenna-containing semiconductor chip.

59. The apparatus of claim 57, in which a portion of the one or more physical media comprises:
one or more signal-bearing media configured to transmit one or more instructions for receiving data indicative of a person accessing at least one of a first network-available electronic content having a first-electronic-content portion or a second network-available electronic content having a second-electronic-content portion.

60. The apparatus of claim 57, in which the one or more physical media comprise:
a portable module including at least a visual display configured to be operated while the portable module is held or worn.

61. The apparatus of claim 57, in which a portion of the one or more physical media comprises:
one or more of an image projection module or a touch screen.

62. The apparatus of claim 57, in which the one or more physical media comprise:
at least one of a repeater, a communication satellite, or another active module configured to accept first and second portions of the device-detectable implementation sequentially.

63. The apparatus of claim 57, in which a portion of the one or more physical media comprises:
one or more processors configured to perform one or more of optical image scanning or auditory pattern scanning upon the device-detectable implementation.

64. The apparatus of claim 57, in which a portion of the one or more physical media comprises:
one or more processors configured to perform speech recognition scanning upon the device-detectable implementation.

65. The apparatus of claim 57, in which a portion of the one or more physical media comprises:
a processor configured to encrypt at least some of the device-detectable output.

66. The apparatus of claim 57, in which at least one of the one or more physical media comprise:
one or more signal-bearing media configured to bear at least one of a special-purpose instruction sequence, a special-purpose-circuit design, or an information-bearing static attribute as a portion of the device-detectable implementation.

67. The apparatus of claim 57, in which at least one of the one or more physical media comprise:
one or more signal-bearing media bearing an implementation access service operated to access a remote server running another implementation as a portion of the device-detectable implementation.

68. The apparatus of claim 57, in which a first portion of the one or more physical media transmits a portion of the device-detectable implementation before a remainder of the one or more physical media transmits a remainder of the device-detectable implementation.

69. The apparatus of claim 57, in which the one or more physical media comprise:
a bus or other configuration of two or more transmission media in mutual isolation.

70. The apparatus of claim 57, in which a portion of the one or more physical media comprises:
a power line operated for transmitting content of the device-detectable implementation between at least two terminals.

71. The apparatus of claim 57, in which a first medium of the one or more physical media bears a first portion of the device-detectable implementation while a second medium of the one or more physical media bears a second portion of the device-detectable implementation.

72. The apparatus of claim 57, in which the one or more physical media are configured at least (a) by causing a communication channel in the one or more physical media to bear a first portion of the device-detectable implementation; and (b) by causing another channel of the one or more physical media to bear a second portion of the device-detectable implementation.

73. The apparatus of claim 57, in which the one or more physical media have borne the device-detectable implementation.

74. The apparatus of claim 57, in which a portion of the one or more physical media comprises:
one or more alphanumeric markings indicative of the device-detectable implementation.

75. The apparatus of claim 57, in which a portion of the one or more physical media comprises:
a magnetoresistive random access memory configured to receive the device-detectable implementation.

76. The apparatus of claim 57, further comprising at least one of a satellite dish or other signal-reflective element, a transducer, an antenna, or a receiver operated for receiving the device-detectable implementation.

77. An apparatus comprising:
one or more physical media bearing a device-detectable output indicating an occurrence of
receiving data indicative of a person accessing at least one of a first network-available electronic content having a first-electronic-content portion or a second network-available electronic content having a second-electronic-content portion;
receiving data indicative of an involvement between the person and a third-party; and
facilitating delivery of a benefit to an owner of the first-electronic content or an owner of the second electronic content in response to an assessed influence by the first-electronic-content portion and/or the second-electronic-content portion on the involvement between the person and the third-party.

78. The apparatus of claim 77, in which the one or more physical media comprise:
an antenna-containing semiconductor chip.

79. The apparatus of claim 77, in which at least one of the one or more physical media comprise:
one or more signal-bearing media transmitting a portion of the device-detectable output at least partly responsive to receiving data indicative of an involvement between the person and a third-party.

80. The apparatus of claim 77, in which the one or more physical media comprise:
a portable module including at least an auditory interface configured to be operated while the portable module is held or worn.

81. The apparatus of claim 77, in which a portion of the one or more physical media comprises:
an image projection module.

82. The apparatus of claim 77, in which the one or more physical media comprise:
an active module configured to accept first and second portions of the device-detectable output serially.

83. The apparatus of claim 77, in which a portion of the one or more physical media comprises:
one or more processors configured to perform one or more of optical image scanning or auditory pattern scanning upon the device-detectable output.

84. The apparatus of claim 77, in which a portion of the one or more physical media comprises:
one or more processors configured to perform linguistic pattern scanning upon the device-detectable output.

85. The apparatus of claim 77, in which a portion of the one or more physical media comprises:
circuitry for causing a processor to decrypt at least some of the device-detectable output.

86. The apparatus of claim 77, in which at least one of the one or more physical media comprise:
one or more signal-bearing media bearing at least an information-bearing static attribute as a portion of the device-detectable output.

87. The apparatus of claim 77, in which at least one of the one or more physical media comprise:
one or more signal-bearing media bearing at least one signal from an implementation having at least circuitry for facilitating delivery of a benefit to an owner of the first-electronic content or an owner of the second electronic content in response to an assessed influence by the first-electronic-content portion and/or the second-electronic-content portion on the involvement between the person and the third-party.

88. The apparatus of claim 77, in which a first portion of the one or more physical media transmits a portion of the device-detectable output before a remainder of the one or more physical media transmits a remainder of the device-detectable output.

89. The apparatus of claim 77, in which the one or more physical media comprise:
a lens or other light-transmissive medium.

90. The apparatus of claim 77, in which a portion of the one or more physical media comprises:
a power line operated for transmitting content of the device-detectable output between at least two terminals.

91. The apparatus of claim 77, in which a first medium of the one or more physical media bears a first portion of the device-detectable output while a second medium of the one or more physical media bears a second portion of the device-detectable output.

92. The apparatus of claim 77, in which the one or more physical media are configured at least (a) by causing a communication channel in the one or more physical media to bear a first portion of the device-detectable output; and (b) by causing a remainder of the one or more physical media to bear a remainder of the device-detectable output.

93. The apparatus of claim 77, in which the one or more physical media have borne the device-detectable output.

94. The apparatus of claim 77, in which a portion of the one or more physical media comprises:
one or more static markings indicative of the device-detectable output.

95. The apparatus of claim 77, in which a portion of the one or more physical media comprises:
a magnetoresistive random access memory configured by the device-detectable output.

96. The apparatus of claim 77, further comprising a transducer operated for transmitting the device-detectable output.
